(19) United States
(12) Patent Application Publication
(10) Pub. No.: US 2017/0064215 A1
(43) Pub. Date: Mar. 2, 2017

(54) DISPLAY APPARATUS AND CONTROL METHOD THEREOF

(71) Applicant: SAMSUNG ELECTRONICS CO., LTD., Suwon-si (KR)

(72) Inventors: Eun-joo CHO, Hwaseong-si (KR); Heui-jin KWON, Seongnam-si (KR); Young-sun KIM, Suwon-si (KR); Ye-ji PARK, Seoul (KR); Myung-kwan CHOI, Suwon-si (KR); Arum CHOI, Seongnam-si (KR)

(73) Assignee: SAMSUNG ELECTRONICS CO., LTD., Suwon-si (KR)

(21) Appl. No.: 15/248,795

(22) Filed: Aug. 26, 2016

(30) Foreign Application Priority Data
Aug. 28, 2015 (KR) 10-2015-0121795

(51) Int. Cl. H04N 5/268; H04N 5/45; H04N 21/422; H04N 21/438; H04N 21/45; H04N 5/44; H04N 21/41

(52) U.S. Cl. CPC H04N 5/268; H04N 5/4403; H04N 5/45; H04N 21/4126; H04N 21/4384; H04N 21/4532; H04N 21/4221; H04N 2005/4412

(57) ABSTRACT

A display apparatus includes a communicator configured to receive a video signal, a display configured to display a first image based on the received video signal, an input interface configured to receive a first instruction for switching content, and a processor configured to control the display to display a second image based on the received first instruction, and display, on the second image, a first user interface (UI) for switching content, in response to the input interface receiving the first instruction while the display displays the first image.

### CROSS-REFERENCE TO RELATED the APPLICATION

This application claims priority from Korean Patent Application No. 10-2015-0121795, filed on Aug. 28, 2015, in the Korean Intellectual Property Office, the disclosure of which is incorporated herein by reference in its entirety.

### BACKGROUND

Field

Apparatuses and methods consistent with exemplary embodiments relate to a display apparatus for processing content provided from input sources and displaying a content image, and a control method thereof.

Description of the Related Art

A display apparatus is provided with a display panel and displays an image based on a broadcast signal or a video signal/video data of various formats, and is achieved by a television (TV), a monitor, etc. The display panel is to display an input video signal as an image on its effective image display surface, and there are various types of display panel such as a liquid crystal display (LCD) panel, a plasma display panel, etc. in accordance with their properties to be applied to various display apparatuses.

The display panel provided in the display apparatus is classified into a light receiving structure and a self-emissive structure in accordance with how light for displaying an image is generated. The light receiving structure is a non-emissive structure at which the display panel cannot emit light by itself, and thus includes a backlight arranged in the back of the display panel and generating light for illuminating the display panel. For example, the LCD panel has the non-emissive structure. On the other hand, the display panel of the self-emissive structure emits light by itself and thus does not need the separate backlight. For example, an organic light emitting diode (OLED) has the self-emissive structure.

The display apparatus may receive data or a signal of content for displaying an image from various input sources. For example, if the display apparatus is a TV, the display apparatus may receive a video signal from a set-top box, receive a radio frequency (RF) signal through an antenna, receive a streaming data packet from a streaming server through a network, or receive reproduced data of an optical disc from a locally connected optical disc device. Like this, the display apparatus selects content from various input sources in response to a user's input and displays an image by processing the selected content. There are many user inputs applicable to the display apparatus. Among them, the user input may be a remote controller provided separately from a main body of the display apparatus.

The remote controller has a basic structure including four direction buttons for respectively inputting up, down, left and right directions, and an enter-button for inputting selection. A user presses the direction buttons to explore channels of content, and presses the enter-button to select one among the channels. Thus, the display apparatus displays a content image of the selected channel.

By the way, if a user wants to switch over to a desired channel or a desired input source through the remote controller, s/he has to go through selections on many hierarchical user interfaces (UIs). In case of using the buttons of the remote controller, such selections are inconvenient for a user because s/he has to press the direction buttons and the enter-button many times. In terms of convenience, the display apparatus may provide an environment in which a user can switch over to a desired channel or input source by less control.

### SUMMARY

Exemplary embodiments may address at least the above problems and/or disadvantages and other disadvantages not described above. Also, the exemplary embodiments are not required to overcome the disadvantages described above, and may not overcome any of the problems described above.

According to an aspect of an exemplary embodiment, there is provided a display apparatus including a communicator configured to receive a video signal, a display configured to display a first image based on the received video signal, an input interface configured to receive a first instruction for switching content, and a processor configured to control the display to display a second image based on the received first instruction, and display, on the second image, a first user interface (UI) for switching content, in response to the input interface receiving the first instruction while the display displays the first image.

The input interface may be further configured to receive a second instruction for selecting the first UI, and the processor may be further configured to control the display to display a third image in response to the input interface receiving the second instruction while the display displays the first UI.

The processor may be further configured to control the display to display, on the third image, a second UI for returning to the second image, the input interface may be further configured to receive a third instruction for selecting the second UI, and the processor may be further configured to control the display to display the first image in response to the input interface receiving the third instruction while the display displays the second UI.

The processor may be further configured to determine content of the third image, based on a content view history of a user, and display, on the second image, the first UI for switching to the determined content, in response to the input interface receiving the first instruction while the display displays the first image.

The processor may be further configured to determine, as the content of the third image, content that is highest ranked in order of a view frequency of the user for a preset period of time, among contents.

The processor may be further configured to determine, as the content of the third image, content that is displayed at a time closest to a time when the second image is displayed, among contents.

The first UI may be for switching an input source for providing content to the display apparatus.

The input interface may include a remote controller configured to control an input source for providing content to the display apparatus, based on a code set corresponding to the input source, and the processor may be further configured to selectively activate a function for transmitting the code set that is stored in the display apparatus, and control the communicator to transmit the stored code set to the remote controller in response to the input interface receiving the first instruction from the remote controller while the processor activates the function.

The processor may be further configured to control the display to display the second image based on the received first instruction, and display, on the second image, the first UI, in response to the input interface receiving the first instruction from the remote controller while the function is inactivated.

The input interface may include a mobile input device configured to control an input source for providing content to the display apparatus, based on a code set corresponding to the input source, and the processor may be further configured to pair with the mobile input device to transmit data to the mobile input device, and control the communicator to transmit the code set to the mobile input device, in response to the mobile input device being within a preset range for wireless communication with the communicator.

According to an aspect of another exemplary embodiment, there is provided a method of controlling a display apparatus, the method including receiving a video signal, displaying a first image based on the received video signal, receiving a first instruction for switching content, and displaying a second image based on the received first instruction, and displaying, on the second image, a first user interface (UI) for switching content, in response to the receiving of the first instruction during the displaying of the first image.

The method may further include receiving a second instruction for selecting the first UI, and displaying a third image in response to the receiving of the second instruction during the displaying of the first UI.

The method may further include displaying, on the third image, a second UI for returning to the second image, receiving a third instruction for selecting the second UI, and displaying the first image in response to the receiving of the third instruction during the displaying of the second UI.

The method may further include determining content of the third image, based on a content view history of a user, and the displaying the first UI may include displaying, on the second image, the first UI for switching to the determined content, in response to the receiving of the first instruction during the displaying of the first image.

The determining may include determining, as the content of the third image, content that is highest ranked in order of a view frequency of the user for a preset period of time, among contents.

The determining may include determining, as the content of the third image, content that is displayed at a time closest to a time when the second image is displayed, among contents.

The first UI may be for switching an input source for providing content to the display apparatus.

The method may further include communicating with a remote controller configured to control an input source for providing content to the display apparatus, based on a code set corresponding to the input source, selectively activating a function for transmitting the code set that is stored in the display apparatus, and transmitting the stored code set to the remote controller in response to the receiving of the first instruction from the remote controller during the activating of the function.

The method may further include displaying the second image based on the received first instruction, and displaying, on the second image, the first UI, in response to the receiving of the first instruction from the remote controller while the function is inactivated.

The method may further include communicating with a mobile input device configured to control an input source for providing content to the display apparatus, based on a code set corresponding to the input source, and pairing with the mobile input device to transmit data to the mobile input device, and transmitting the code set to the mobile input device, in response to the mobile input device being within a preset range for wireless communication with the communicator.

According to an aspect of another exemplary embodiment, there is provided a display apparatus including a display configured to display a first image of a first source, an input interface configured to receive a first instruction for switching the first image, and a processor configured to control the display to display a second image of the first source, and display, on the second image, a first user interface (UI) for switching the second image to a third image of a second source, in response to the input interface receiving the first instruction while the display displays the first image.

The input interface may be further configured to receive a second instruction for selecting the first UI, the processor may be further configured to display to display the third image, and display, on the third image, a second UI for returning to the second image, in response to the input interface receiving the second instruction while the display displays the first UI, the input interface may be further configured to receive a third instruction for selecting the second UI, and the processor may be further configured to display to display the second image in response to the input interface receiving the third instruction while the display displays the second UI.

The first source may be a lightweight application, and the second source may be a full application corresponding to the lightweight application.

### BRIEF DESCRIPTION OF THE DRAWINGS

The above and/or other aspects will be more apparent by describing exemplary embodiments with reference to the accompanying drawings, in which:

FIG. 1 illustrates a system according to a first exemplary embodiment;

FIG. 2 is a block diagram of a display apparatus according to a second exemplary embodiment;

FIG. 3 is a perspective view of a remote controller according to a third exemplary embodiment;

FIG. 4 is a perspective view of a remote controller different from that of FIG. 3;

FIG. 5 is a block diagram of the remote controller according to the third exemplary embodiment;

FIG. 6 illustrates some codes of a code set stored in the remote controller according to the third exemplary embodiment;

FIG. 7 illustrates that a display apparatus according to a fourth exemplary embodiment displays an image based on a video signal received from an image input source;

FIG. 8 illustrates user interfaces (UIs) of a hierarchical structure, to be displayed on the display apparatus according to the fourth exemplary embodiment;

FIG. 9 illustrates that the display apparatus according to the fourth exemplary embodiment displays an image switched over in response to an input for switching over to an image input source through the UIs of FIG. 8;

FIG. 10 illustrates that a display apparatus according to a fifth exemplary embodiment displays an entering point UI and a channel banner on a first content image;

FIG. 11 illustrates that the display apparatus according to the fifth exemplary embodiment displays a return entering point UI and a channel banner;

FIG. 12 illustrates that the display apparatus according to the fifth exemplary embodiment displays only a second content image;

FIG. 13 illustrates that the display apparatus according to the fifth exemplary embodiment displays an entering point UI on the second content image;

FIG. 14 illustrates that the display apparatus according to the fifth exemplary embodiment displays a third content image;

FIG. 15 illustrates an operation of when a user presses a direction button for switching a channel while a display apparatus according to a sixth exemplary embodiment displays an entering point UI;

FIG. 16 illustrates that a display apparatus according to a seventh exemplary embodiment displays a fourth content image;

FIG. 17 illustrates that the display apparatus according to the seventh exemplary embodiment displays the first content image;

FIG. 18 illustrates that the display apparatus according to the seventh exemplary embodiment performs an operation of switching a channel and an operation of displaying the entering point UI in response to a user's input;

FIG. 19 illustrates that a display apparatus according to an eighth exemplary embodiment displays guide information for a deleting object;

FIG. 20 illustrates that a display apparatus according to a ninth exemplary embodiment displays a guide window for informing that the entering point UI is not activated;

FIG. 21 illustrates that a display apparatus according to a tenth exemplary embodiment displays a guide window when a channel banner is closed;

FIG. 22 and FIG. 23 are a flowchart of changing a channel through an entering point UI in a display apparatus according to an eleventh exemplary embodiment;

FIG. 24 illustrates a list based on a user's content view history to be referred to by a display apparatus according to a twelfth exemplary embodiment;

FIG. 25 illustrates a list based on a user's content view history to be referred to by a display apparatus according to a thirteenth exemplary embodiment;

FIG. 26 is a flowchart of selecting a channel to which a display apparatus according to a fourteenth exemplary embodiment switches over for displaying the entering point UI;

FIG. 27 is a flowchart of selecting a channel to which a display apparatus according to a fifteenth exemplary embodiment switches over for displaying the entering point UI;

FIG. 28 is a block diagram of a display apparatus according to a sixteenth exemplary embodiment;

FIG. 29 illustrates that the display apparatus according to the sixteenth exemplary embodiment senses a user's gesture;

FIG. 30 illustrates a use environment of a display apparatus according to a seventeenth exemplary embodiment;

FIG. 31 is a block diagram of a remote controller according to a seventeenth exemplary embodiment;

FIG. 32 illustrates that a display apparatus according to the seventeenth exemplary embodiment displays a content image;

FIG. 33 illustrates that the display apparatus according to the seventeenth exemplary embodiment displays an entering point UI;

FIG. 34 illustrates that the entering point UI displayed on the display apparatus according to the seventeenth exemplary embodiment is clicked;

FIG. 35 illustrates that the display apparatus according to the seventeenth exemplary embodiment switches over to the second content image;

FIG. 36 illustrates that the display apparatus according to the seventeenth exemplary embodiment returns to the first content image;

FIG. 37 illustrates a signal flow while the display apparatus according to the seventeenth exemplary embodiment displays the entering point UI;

FIG. 38 illustrates a signal flow while content is switched over and displayed in the display apparatus according to the seventeenth exemplary embodiment in response to execution of the entering point UI;

FIG. 39 illustrates that a display apparatus according to an eighteenth exemplary embodiment displays the first content image;

FIG. 40 illustrates that the display apparatus according to the eighteenth exemplary embodiment displays the entering point UI;

FIG. 41 illustrates that the display apparatus according to the eighteenth exemplary embodiment switches over to the second content image;

FIG. 42 illustrates that the display apparatus according to the eighteenth exemplary embodiment returns to the first content image;

FIG. 43 illustrates a signal flow between the remote controller and the display apparatus according to the eighteenth exemplary embodiment;

FIG. 44 is a block diagram showing a principle of making a channel list based on content received in a display apparatus according to a nineteenth exemplary embodiment;

FIG. 45 illustrates a virtual channel list of the display apparatus according to the nineteenth exemplary embodiment;

FIG. 46 is a block diagram showing a structure of an application to be executed in a display apparatus according to a twentieth exemplary embodiment;

FIG. 47 illustrates that the display apparatus according to the twentieth exemplary embodiment displays an image of lightweight application (LWA);

FIG. 48 illustrates that the display apparatus according to the twentieth exemplary embodiment displays an image of full application;

FIG. 49 is a flowchart of executing an application in the display apparatus according to the twentieth exemplary embodiment;

FIG. 50 illustrates a structure of a channel list used in a display apparatus according to a twenty first exemplary embodiment;

FIG. 51 illustrates a structure of a channel list used in a display apparatus according to a twenty second exemplary embodiment;

FIG. 52 illustrates that a display apparatus according to a twenty third exemplary embodiment displays the entering point UI;

FIG. 53 illustrates that the display apparatus according to the twenty third exemplary embodiment displays a channel list on a screen thereof;

FIG. 54 illustrates that a display apparatus according to a twenty fourth exemplary embodiment displays an image on a screen thereof by a multi-link screen (MLS) mode;

FIG. 55 illustrates an example of a banner displayed when the display apparatus according to the twenty fourth exemplary embodiment switches over to a channel in which the MLS mode is not supported;

FIG. 56 illustrates that a display apparatus according to a twenty fifth exemplary embodiment displays an image on a screen thereof by a picture-in-picture (PIP) mode;

FIG. 57 illustrates an example of a banner displayed when the display apparatus according to the twenty fifth exemplary embodiment switches over to a channel in which the PIP mode is not supported;

FIG. 58 illustrates a state that a display apparatus according to a twenty sixth exemplary embodiment receives no signals from a first image input source;

FIG. 59 illustrates that the display apparatus according to the twenty sixth exemplary embodiment switches over to a second image input source; and

FIG. 60 illustrates that a display apparatus according to a twenty seventh exemplary embodiment transmits a code set to a remote controller.

### DETAILED DESCRIPTION OF EXEMPLARY EMBODIMENTS

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions may not be described in detail because they would obscure the description with unnecessary detail.

In the description of the exemplary embodiments, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding exemplary embodiments.

In the following descriptions, terms such as “include” or “have” refer to presence of features, numbers, steps, operations, elements or combination thereof, and do not exclude presence or addition of one or more other features, numbers, steps, operations, elements or combination thereof. In addition, the terms such as “unit,” “-er (-or),” and “module” described in the specification refer to an element for performing at least one function or operation, and may be implemented in hardware, software, or the combination of hardware and software.

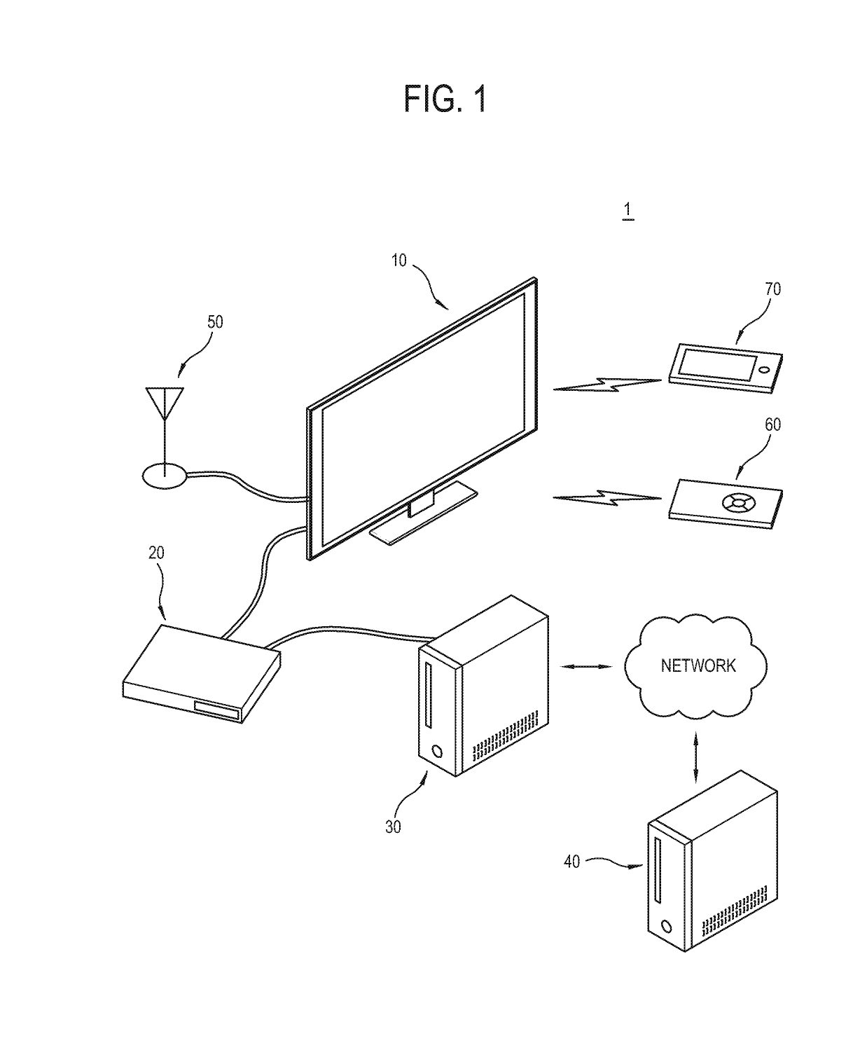

FIG. 1 illustrates a system 1 according to a first exemplary embodiment.

As shown in FIG. 1, the system 1 according to the first exemplary embodiment includes a plurality of apparatuses connected to communicate with one another to display an image. The system 1 includes the plurality of apparatuses, but there are no limits to connection methods between the apparatuses, types of the apparatuses, the number of apparatuses, etc.

The system 1 includes a display apparatus 10 for displaying an image, and a set-top box 20 for providing an image signal to the display apparatus 10. In this exemplary embodiment, the display apparatus 10 is a television (TV), but may be achieved by other electronic apparatus capable of displaying an image besides the TV.

The set-top box 20 is connected to the display apparatus 10 by a wire or wirelessly, processes an image signal received from the outside, and outputs the processed image signal to the display apparatus 10. If the video signal is a broadcast signal, the set-top box 20 may include a tuner or may not include the tuner. If the set-top box 20 does not have the tuner, the video signal is tuned by the tuner of the display apparatus 10.

The set-top box 20 may support an Internet protocol television (IPTV) service. The IPTV refers to a platform that uses an Internet protocol on a broadband network and provides a digital television (DTV) service to the display apparatus 10 of a user. Thus, the display apparatus 10 may be additionally provided with not only a video on demand (VOD) using such a platform but only Internet service such as Web surfing performed in the existing Web, voice over Internet protocol (VoIP), etc., thereby enabling a user to actively interact with a content provider.

The IPTV is a platform based on Internet protocol combining with a high-speed communication network service such as VoIP. In a platform of providing a video signal through a cable or a satellite, content and time at which a user can view the content are limited because the content provider unilaterally transmits a stream. On the other hand, the IPTV is a service based on interactive communication between a user and the content provider, and therefore a user can select and view desired content at a desired time. Further, the IPTV provides a user with additional network services using the high-speed communication network as well as the content.

In case of supporting the IPTV service, the set-top box 20 accesses a router 30 connected to the high-speed communication network, and communicates with a server 40 providing the IPTV service through the router 30. The set-top box 20 may access the router 30 by a wire. If the set-top box supports the wireless communication, the set-top box 20 wirelessly accesses an access point (AP) and accesses the router 30. Further, if both the set-top box 20 and the router 30 support the wireless communication, the set-top box 20 and the router 30 may directly connect with each other wirelessly without the AP.

The router 30 is a device for basically connecting independent networks, or a device for distinguishably connecting networks. The router 30 performs functions such as forwarding for a packet switching function to receive a data packet from one port and transmit it to another port; routing for a path setting function to assign a transmission path to a packet in a communicated network in which the routers 30 are connected to one another and control the transmission path; learning for a function of learning a logical structure of a network; load balancing for a function of uniformly distribute traffic to a plurality of output terminals from the router 30; a bypassing function of forming a bypassing path when one among links is disabled; etc.

The router 30 accesses the server 40 through the network and provides a content data packet from the server 40 to the set-top box 20. Further, the router 30 transmits a data packet from the set-top box 20 to the server 40.

The display apparatus 10 processes the content data received through various routes and displays an image based on the processed content data. There are various routes through which the display apparatus 10 receives the content data. The display apparatus 10 may receive the content data from the set-top box 20 or receive an RF signal through an RF antenna 50. Further, the display apparatus 10 may receive reproducing data of image data from an external apparatus 70 such as a mobile apparatus connected thereto for communication, and may receive content data from a memory internally provided therein or locally connected thereto. Alternatively, the display apparatus 10 may directly access the network through the router 30 and receive and reproduce web content provided by the server 40 or the like.

In this embodiment, the display apparatus 10 may receive and process content data provided based on the IPTV service from the server 40 through the set-top box 20, or selectively receive and display an RF broadcast signal received through the RF antenna 50. The display apparatus 10 selects one among various image sources, and processes content data received from the selected image source, thereby displaying a content image. The display apparatus 10 provides various user interface environments for allowing a user to select one among the image sources. As an example of the user interface environments, there is a remote controller 60.

The remote controller 60 is physically separated and remoted from a main body of the display apparatus 10, and easily gripped and carried by a user. The remote controller 60 is designed and manufactured to be paired with the display apparatus 10 in a stage that the display apparatus 10 is manufactured. In this case, the remote controller 60 may be regarded as a sub element of the display apparatus 10.

The meaning of pairing between the remote controller and the display apparatus 10 is as follows. To make the remote controller 60 control operations of the display apparatus 10 in response to a user's control, the display apparatus 10 has to recognize a control signal transmitted from the remote controller 60. Therefore, information about the operations of the display apparatus 10 is previously set corresponding to the control signal transmitted from the remote controller 60. This information is called a code set, and the code set has to be installed or stored in each of the remote controller 60 and the display apparatus 10 before the remote controller 60 controls the display apparatus 10.

However, the remote controller 60 is not necessarily designed and manufactured to be paired with the display apparatus 10 when the display apparatus 10 is manufactured. The remote controller 60 may be manufactured by a manufacturer different from the manufacturer of the display apparatus 10, and then paired with the display apparatus 10 as the code set for controlling the display apparatus 10 is installed in the remote controller 60.

Below, elements of the display apparatus 10 will be described.

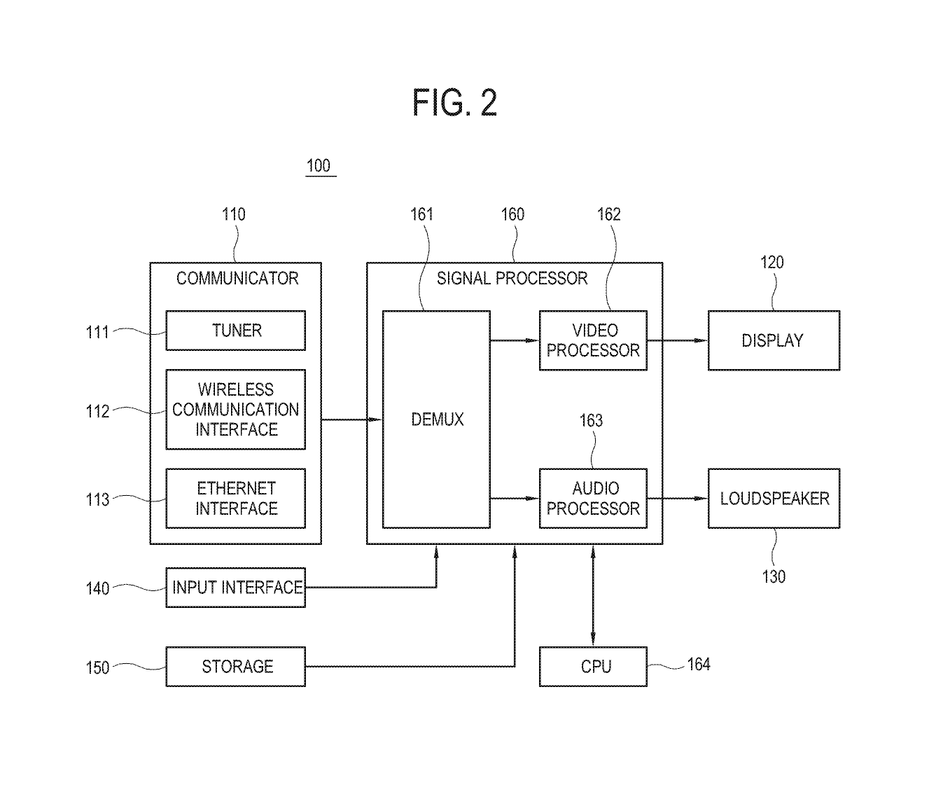

FIG. 2 is a block diagram of a display apparatus 100 according to a second exemplary embodiment. The display apparatus 100 in this embodiment is applicable to the foregoing display apparatus according to the first exemplary embodiment.

As shown in FIG. 2, the display apparatus 100 according to the second exemplary embodiment includes a communicator 110 for communicating with the exterior, a display 120 for displaying an image based on video data of a transport stream received in the communicator 110, a loudspeaker 130 for outputting a sound based on audio data of the transport stream received in the communicator 110, an input interface 140 for receiving a user's input, a storage 150 for storing data, a signal processor 160 for controlling and computing operations of the display apparatus 100, and a central processing unit (CPU) 164 for computing and controlling operations of the signal processor 160. In this exemplary embodiment, the CPU 164 is independently provided, but not limited thereto. Alternatively, the CPU 164 may be integrated with various chipsets such as the signal processor 160, and thus may be provided as a single system on chip (SoC).

The communicator 110 performs interactive communication, which receives a transport stream from various image sources or data received from the signal processor 160 to the exterior. The communicator 110 may be achieved by an assembly of communication ports or communication interfaces respectively corresponding to a plurality of communication standards, and its supportable protocols and communication targets are not limited to one kind or type. For example, the communicator 110 may include a radio frequency integrated circuit (RFIC) for receiving an RF signal, a wireless communication interface for wireless network communication, an Ethernet interface for wired network communication, a universal serial bus (USB) port for local connection with a USB memory or the like, an infrared sensor for sensing infrared if the infrared is sent from the remote controller 60 (see FIG. 1), and so on.

In this embodiment, the communicator 110 is connected to the RF antenna 50 (see FIG. 1), the set-top box (see FIG. 1) and various image sources, and receives content data from the image sources. Here, there are various ways that the communicator 110 receives content data from the image sources and selectively transmits the content data to the signal processor 160.

For example, the communicator 110 includes interfaces respectively taking charge of communication with the image sources and individually inactivated by the signal processor 160, and transmits content data received in an activated interface to the signal processor 160. Alternatively, the communicator 110 may transmit the content data from the interface designated by the signal processor 160 to the signal processor 160 while the interfaces are individually receiving the content data.

The display 120 displays an image based on a video signal processed by the signal processor 160. There are no limits to the types of the display 120. For example, the display 120 may be achieved by a non-emissive type such as a liquid crystal display (LCD) or a self-emissive type such as an organic light emitting diode (OLED) display panel. Further, the display 120 may include additional elements in addition to the display panel in accordance with the types of the display panel. For example, if the display 120 is achieved by the liquid crystal display, the display 130 includes a liquid crystal display (LCD) panel, a backlight for emitting light to the LCD panel, and a panel driver for driving the LCD panel.

The loudspeaker 130 outputs a sound based on an audio signal processed by the signal processor 160. The loudspeaker 130 vibrates air in accordance with an audio signal and changes air pressure to thereby make a sound. The loudspeaker 130 includes a loudspeaker provided corresponding to an audio signal of one channel. In this embodiment, the loudspeaker may include a plurality of loudspeakers respectively corresponding to audio signals of the plurality of channels.

There are various kinds of loudspeakers 130 in accordance with frequency bands of a sound to be output. The loudspeakers 130 include a sub-woofer corresponding to a frequency band of 20 Hz to 99 Hz, a woofer corresponding to a frequency band of 100 Hz to 299 Hz, a mid-woofer corresponding to a frequency band of 300 Hz to 499 Hz, a mid-range speaker corresponding to a frequency band of 500 Hz to 2.9 KHz, a tweeter speaker corresponding to a frequency band of 3 KHz to 6.9 KHz, and a super-tweeter speaker corresponding to a frequency band of 7 KHz to 20 KHz, in which one or more among them are selected and applied to the display apparatus 100.

The input interface 140 transmits various preset control commands or information to the signal processor 160 in accordance with a user's control or input. The input interface 140 transmits various events, which occurs by a user's control in accordance with a user's intention, to the signal processor 160. The input interface 140 may be variously achieved in accordance with information input methods. In this exemplary embodiment, the input interface 140 may refer to a user interface provided in the display apparatus 100. For example, the input interface 140 may be achieved by a button placed at an outer side of the display apparatus 100, a touch screen placed in the display 120, a microphone for receiving a user's utterance, a camera for photographing or sensing surrounding environments of the display apparatus 100, etc. The remote controller 60 (see FIG. 1) may be also regarded as one among the user interface environments. In this case, the remote controller 60 is separated from the display apparatus 100 and transmits a control signal to the display apparatus 100 through the communicator 110.

The storage 150 stores various pieces of data under process and control of the signal processor 160. The storage 150 is accessed by the signal processor 160 and performs reading, writing, editing, deleting, updating or the like with regard to data. The storage 150 is achieved by a flash-memory, a hard-disc drive or the like nonvolatile memory to preserve data regardless of supply of system power in the display apparatus 100.

The signal processor 160 performs various processes with regard to the transport stream received in the communicator 110. When the transport stream is received in the communicator 110, the signal processor 160 applies a video processing process to the video signal extracted from the transport stream, and outputs the processed video signal to the display 120, so that an image can be displayed on the display 120.

There is no limit to the kind of video processing process performed by the signal processor 160, and the video processing process may for example include demultiplexing for dividing an input transport stream into sub streams such as a video signal, an audio signal and additional data, decoding corresponding to video formats of the video signal, de-interlacing for converting video data from an interlaced type into a progressive type, scaling for adjusting a video signal to have a preset resolution, noise reduction for improving image quality, detail enhancement, frame refresh rate conversion, etc.

The signal processor 160 may perform various processes in accordance with the kind and properties of a signal or data, and therefore the process of the signal processor 160 is not limited to the video processing process. Further, the data that can be processed by the signal processor 160 is not limited to data received in the communicator 110. For example, the signal processor 160 performs an audio processing process with regard to an audio signal extracted from the transport stream, and outputs such a processed audio signal to the loudspeaker 230. In addition, if a user's speech is input to the display apparatus 100, the signal processor 160 may process the speech in accordance with a preset voice recognition process. The signal processor 160 may be achieved in the form of a system-on-chip (SoC) in which various functions corresponding to such processes are integrated, or an image processing board in which individual chip-set for independently performing the respective processes are mounted to a printed circuit board.

The display apparatus 100 may have different hardware components in accordance with the types of the display apparatus 100 and the functions supported by the display apparatus 100. For example, a hardware component to be tuned to a frequency for receiving a broadcast signal may be used if the display apparatus 100 is a TV, but may be excluded if the display apparatus 100 is a tablet PC.

Below, the signal processor 160 of when the display apparatus 100 is the TV will be described in detail.

The accompanying drawings show only basic elements of the communicator 110 and the signal processor 160, and an actual product of the display apparatus 100 includes additional elements besides the elements set forth herein.

In this exemplary embodiment, the signal processor 160 is divided into a plurality of processors 162, 163 and 164, but not limited thereto. In practice, such elements may be divided by hardware or may not be divided, or may be achieved by combination of hardware and software. Further, in this exemplary embodiment, the signal processor 160 includes a video processor 162 and an audio processor 163, but not limited thereto. Alternatively, the signal processor 160 may further include various processors in accordance with support functions.

The communicator 110 includes a tuner 111 to be tuned to a frequency to receive a broadcast stream, a wireless communication interface 112 for wireless communication with the exterior, and an Ethernet interface 113 for wired communication with the exterior.

Further, the signal processor 160 includes a DEMUX 161 for dividing the transport stream received from the signal receiver 110 into a plurality of sub signals, a video processor 162 for processing a video signal among the sub signals output from the DEMUX 161 in accordance with the video processing process and outputting the processed video signal to the display 120, an audio processor 163 for processing an audio signal among the sub signals output from the DEMUX 161 in accordance with the audio processing process and outputting the processed audio signal to the loudspeaker 130.

When a broadcast stream is received in the tuner 111, the tuner 111 is tuned to a frequency of a designated channel to receive a broadcast stream and converts the broadcast stream into a transport stream. The tuner 111 converts a high frequency of a carrier wave into an intermediate frequency band and converts it into a digital signal, thereby generating a transport stream. To this end, the tuner 111 has an analog/digital (A/D) converter. Alternatively, the A/D converter may be designed to be included in not the tuner 111 but a demodulator.

The wireless communication interface 112 performs wireless communication corresponding to various protocols. These protocols include wireless fidelity (Wi-Fi), Wi-Fi Direct, Bluetooth, Universal Plug And Play (UPNP), Near Field Communication (NFC), etc. The wireless communication interface 112 includes communicates based on protocols in accordance with support protocols.

Below, the foregoing protocols will be described schematically.

Wi-Fi refers to a protocol of supporting wireless local area network based on institute of electrical and electronics engineers (IEEE) 802.11 and personal area network (PAN)/local area network (LAN)/wide area network (WAN), etc. In an infrastructure mode, Wi-Fi provides wireless communication relayed by access points (AP) in between devices. In case of IEEE 802.11n, Wi-Fi guarantees the maximum transmission speed of 300 Mbps.

The AP is connected to a router accessing an exterior WAN, and forms a hot spot of a predetermined range within an unclosed space. The display apparatus 100 is positioned within the hot spot around the AP and wirelessly accesses the AP, thereby connecting and communicating with a network via the AP. Here, the range of the hot spot may be expanded by additionally installing a repeater or the like device for amplifying a signal. However, it is not proper for a user to use Wi-Fi for the wireless communication while s/he is moving because the hot spot has a narrow range.

Wi-Fi Direct refers to a protocol that is based on peer-to-peer (P2P) and does not use the AP in Wi-Fi. Based on Wi-Fi Direct, the display apparatus 100 may directly connect and communicate with other devices without using the AP. Wi-Fi Direct guarantees the maximum transmission speed of 250 Mbps within a distance of 200 m between the devices.

Wi-Fi Direct utilizes a technique related to Ad-hoc among Wi-Fi techniques. An ad-hoc network is a communication network established with only mobile hosts without a stationary wired network. The ad-hoc network is suitable when it is difficult to establish the wired network or when it is used for a short time after establishing the network. The ad-hoc network is quickly and inexpensively established because there is no limit to move the host and there is no need of a wired network and a base station. In the ad-hoc network, mobile nodes are used as not only hosts but also a kind of router, and multi-paths are set up with regard to other nodes or a path is dynamically set up. Wi-Fi Direct is a technique achieved to improve transmission speed and security by remedying the ad-hoc technique's shortcomings.

Wi-Fi Direct is fundamentally related to 1:1 connection, but 1:N connection is also possible. For instance, the display apparatus 100 has the following processes to connect and communicate with the mobile device or the like external device in accordance with a Wi-Fi Direct protocol. The mobile device sends a connection request message to the display apparatus 100 by a push method. If the display apparatus 100 accepts the connection request of the mobile device, a pairing is completed between the display apparatus 100 and the mobile device.

Bluetooth is a direct communication method between devices based on IEEE 802.15.1 standards. Bluetooth uses an industrial scientific and medical (ISM) frequency of 2400 to 2483.5 MHz. However, to prevent interference with other systems using higher and lower frequencies, Bluetooth employs total 79 channels of 2402 to 2480 MHz except a band as much as 2 MHz after 2400 MHz and a band as much as 3.5 MHz before 2483.5 MHz.

Because many systems use the same frequency band, electromagnetic interference is likely to occur between the systems. To prevent this, Bluetooth employs a frequency hopping technique. The frequency hopping technique is to transmit a packet (data) little by little while moving in many channels quickly in accordance with patterns. Bluetooth hops over 79 assigned channels 1600 times per second. Communication is accomplished when this hopping pattern is synchronized between Bluetooth devices. Because Bluetooth devices are connected as a master and a slave, the communication is not achieved between the two devices if the slave device is not synchronized with frequency hopping generated by the master device. Therefore, stable connection is expected without electromagnetic interferences with other systems. For reference, one master device can connect with up to seven slave devices. Here, communication between the master device and the slave device is possible, but communication between the slave devices is impossible. However, the roles of the master and the slave may be exchangeable with each other according to situations because they are not fixed.

UPNP is a protocol for connecting devices by a P2P method in accordance with digital living network alliance (DLNA). UPNP utilizes the existing protocols such as Internet protocol, tape carrier package (TCP), user datagram protocol (UDP), hypertext transfer protocol (HTTP), and extensible mark-up language (XML). UPNP is based on a wire protocol, in which information exchanged between devices is represented in the XML and communicated through the HTTP.

Wi-Fi, Bluetooth or the like protocol uses 48-bit media access control (MAC) address as a unique identifier of a communication interface, whereas UPNP uses an identifier of universally unique identifier (UUID). UUID is an identifier of 16 octets, i.e., 128 bits, and is represented by 32 lowercase hexadecimal digits. UUID is a set of 32 characters or digits, represented by four hyphens, and has a total 36-digit number of “8-4-4-4-12.”

NFC is one among radio-frequency identifications (RFID), which is a contactless short-range wireless communication protocol using a frequency band of 13.56 MHz. NFC is a technique to exchange data between devices at a near distance of about 10 cm, which is extended from ISO/IEC 14443. NFC operates based on electromagnetic induction between two adjacent loop antennas within a magnetic field.

NFC supports two modes of a passive communication mode and an active communication mode. In the passive communication mode, a starting device provides a carrier field, and a target device operates while modulating the provided fields. The target device of the passive communication mode acquires operation power from the electromagnetic field provided by the starting device, and thus the target device also serves as a transceiver. By the way, in the active communication mode, both the starting device and the target device communicate with each other by generating electric fields in itself. In the active communication mode, one device releases its own electromagnetic field until receiving data from an opponent, and activates its own electromagnetic field when transmitting data to the opponent.

The DEMUX (or demultiplexer) 161 performs a reverse operation of the multiplexer. That is, the DEMUX 161 connects one input terminal with a plurality of output terminals, and distributes a stream input to the input terminal to the respective output terminals in accordance with selection signals. For example, if there are four output terminals with respect to one input terminal, the DEMUX 161 may select each of the four output terminals by combination of selection signals having two levels of 0 and 1. In a case in which the DEMUX 161 is applied to the display apparatus 100, the DEMUX 161 divides the transport stream received from the tuner 211 into the sub signals of a video signal and an audio signal and outputs them to the respective output terminals.

The DEMUX 161 may use various methods to divide the transport stream into the sub signals. For example, the DEMUX 161 divides the transport stream into the sub signals in accordance with packet identifiers (PID) given to packets in the transport stream. The sub signals in the transport stream are independently compressed and packetized according to channels, and the same PID is given to the packets corresponding to one channel to be distinguished from the packets corresponding to another channel. The DEMUX 161 classifies the packets in the transport stream according to the PID, and extracts the sub signals having the same PID.

The video processor 162 decodes and scales the video signal output from the DEMUX 161 and outputs it to the display 120. To this end, the video processor 162 includes a decoder that returns the video signal to a state before an encoding process by performing an opposite process to the encoding process with regard to the video signal encoded by a format, and a scaler that scales the decoded video signal in accordance with the resolution of the display 120 or a separately designated resolution. If the video signal output from the DEMUX 161 is not encoded by a format, i.e., not compressed, the decoder of the video processor 162 does not process this video signal.

The audio processor 163 amplifies an audio signal output from the DEMUX 161 and outputs the amplified audio signal to the loudspeaker 130. To this end, the audio processor 163 includes a digital signal supplier for outputting a digital audio signal; a pulse width modulation (PWM) processor for outputting a PWM signal based on a digital signal output from the digital signal supplier, an amplifier for amplifying the PWM signal output from the PWM processor, and an LC filter for filtering the PWM signal amplified by the amplifier by a predetermined frequency band to thereby demodulate the PWM signal.

The CPU 164 is an element for performing central calculation to operate elements in the signal processor 160, and plays a central role in basically parsing and calculating data. The CPU 164 internally includes a processor register in which commands to be processed are stored; an arithmetic logic unit (ALU) being in charge of comparison, determination and calculation; a controller for internally controlling the CPU 164 to analyze and carry out the commands; an internal bus, a cache, etc.

The CPU 164 performs calculation for operating the elements of the signal processor 160, such as the DEMUX 161, the video processor 162 and the audio processor 163. Alternatively, some elements of the signal processor 160 may be designed to operate without the data calculation of the CPU 164 or operate by a separate microcontroller.

Below, the remote controller for allowing a user to control the operations of the display apparatus 100 will be described.

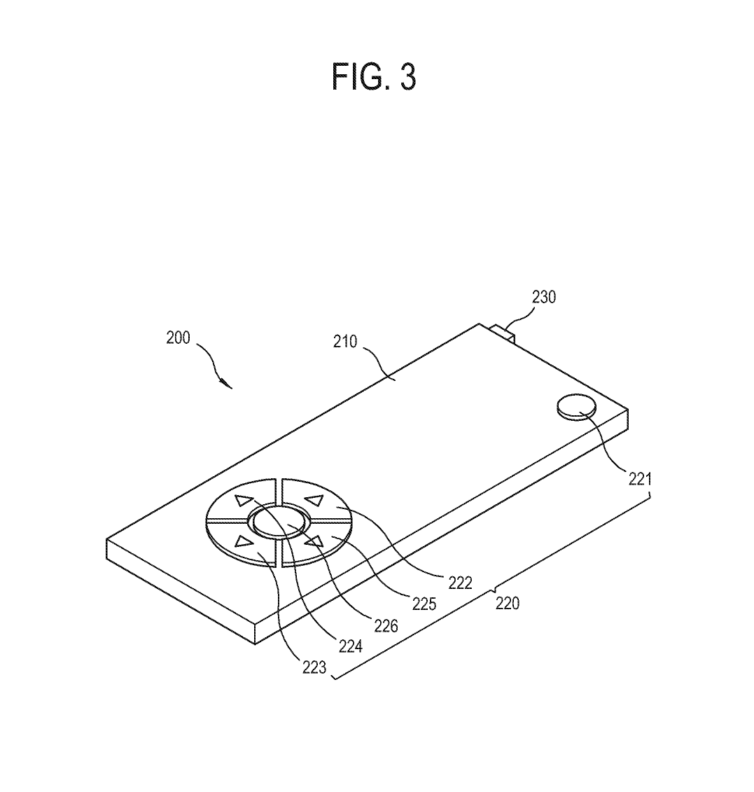

FIG. 3 is a perspective view of a remote controller 200 according to a third exemplary embodiment. In this exemplary embodiment, the remote controller 200 may be replaced by the foregoing remote controller 60 (see FIG. 1) of the first exemplary embodiment.

As shown in FIG. 3, the remote controller 200 according to the third exemplary embodiment includes a housing 210, a remote control input device 220 provided on the housing 210 and manipulated by a user, and a signal transmitter 230 provided in a front of the housing 210 and transmits a control signal corresponding to manipulation of the remote control input device 220. The remote controller 200 described in this embodiment is nothing but an example. Alternatively, the remote controller 200 may have various structures.

The remote control input device 220 is the user interface environment provided to the remote controller 20 to make an input corresponding to a user's manipulation. The user interface environment refers to all hardware devices for a user's input. For example, the user interface environment may include various input devices such as a microphone, a touch pad, a touch screen, an acceleration sensor, a motion sensor, etc. In this exemplary embodiment, the remote control input device 220 has a button structure that can be pressed by a user. Such a button structure is easy to manufacture, inexpensive and intuitively used by a user, and thus used in an input device such as the remote controller 200.

In this exemplary embodiment, the remote control input device 220 includes a power button 221 for powering on or off the remote controller 200, direction buttons 222, 223, 224 and 225 for respectively inputting up, down, left and right directions, and an enter-button 226 for inputting selection and execution. This embodiment shows a button structure of the remote control input device 220. In practice, the remote control input device 220 may include additional buttons in accordance with support functions.

The direction buttons 222, 223, 224 and 225 may be used when a user changes channels. For example, the up direction button 222 and the down direction button 223 may be used in channel search, while the left direction button 224 and the right direction button 225 may be used in volume control. Alternatively, the left direction button 224 and the right direction button 225 may be used in searching a channel.

The enter-button 226 corresponds to a clicking operation with regard to a cursor. For example, if a user presses the enter-button 226 in the state that a UI displayed by the display apparatus 100 includes a plurality of selectable objects and a cursor indicates one among the objects, the object indicated by the cursor is clicked and thus an operation designated corresponding to the object is executed. Alternatively, if a user presses the enter-button 226 while an object is highlighted, the object is clicked. In other words, the enter-button 226 is provided for inputting selection with regard to a currently searched state while the search is performed in the display apparatus 100.

The signal transmitter 230 transmits a control signal based on an input corresponding to a user's manipulation on the remote control input device 220 to the display apparatus 100 so that the display apparatus 100 can execute an operation in response to the control signal. There are no limits to the structure of the signal transmitter 230 as long as the signal transmitter 230 transmits the control signal to the display apparatus 100. In this exemplary embodiment, the signal transmitter 230 has a structure of converting a control signal into infrared and emitting the infrared.

In the foregoing exemplary embodiments, the direction buttons 222, 223, 224 and 225 are used when a user changes the channels. However, the remote controller 200 may further include an additional input element for changing the channels besides the direction buttons 222, 223, 224 and 225.

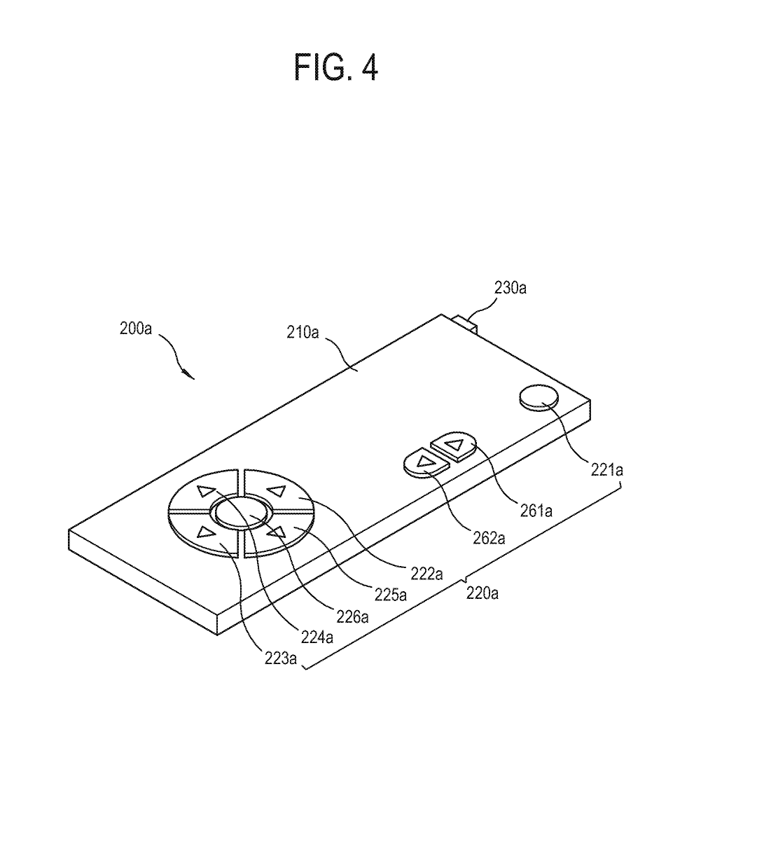

FIG. 4 is a perspective view of a remote controller 200a different from that of FIG. 3.

As shown in FIG. 4, the remote controller 200a includes a housing 210a, a remote control input device 220a provided on the housing 210a and manipulated by a user, and a signal transmitter 230a provided in a front of the housing 210a and transmitting a control signal corresponding to manipulation on the remote control input device 220a.

The remote control input device 220a includes a power button 221a for powering on or off the remote controller 200a, direction buttons 222a, 223a, 224a and 225a for respectively inputting up, down, left and right directions, and an enter-button 226a for inputting selection and execution. In addition, the remote control input device 220a may further include channel search buttons 261a and 262a provided for searching the channels.

With this structure, the direction buttons 222a, 223a, 224a and 225a are used in controlling movement of a cursor, and the channel search buttons 261a and 262a are used in searching or switching over to a channel in an up direction or a down direction.

Like this, there may be various input structures for searching the channels in accordance with models of the remote controllers 200 and 200a.

Below, the elements of the remote controller 200 will be described.

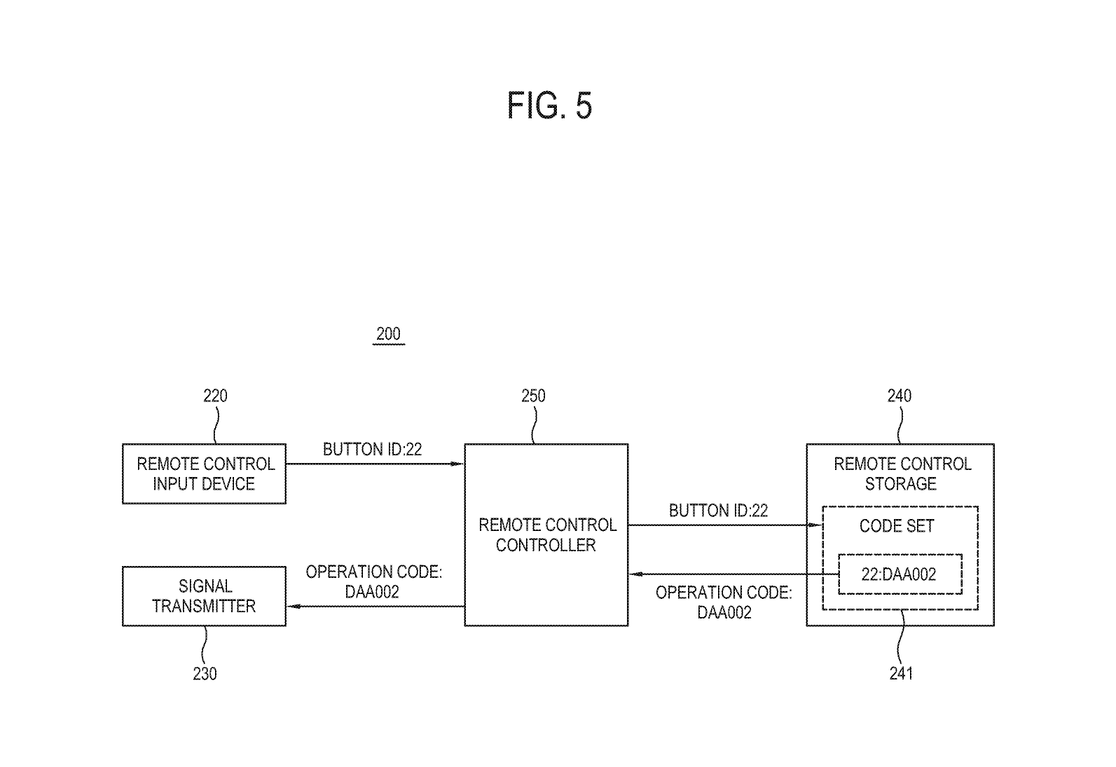

FIG. 5 is a block diagram of the remote controller 200 according to the third exemplary embodiment;

As shown in FIG. 5, the remote controller 200 includes the remote control input device 220, the signal transmitter 230, a remote control storage 240 for storing a preset code set, and a remote control controller 250 for controlling the remote controller 200.

The code set stored in the remote control storage 240 is referred to by the remote control controller 250 to generate a control signal. Each button of the remote control input device 220 is assigned with a corresponding key ID or button ID. In the code set, the button ID is mapped to an operation code to be recognized by the display apparatus.

The remote control controller 250 searches a code set 241 for a button ID, thereby deriving an operation code mapping to the corresponding button ID. Further, the remote control controller 250 generates a control signal corresponding to the derived operation code and transmits it to the display apparatus through the signal transmitter 230. Thus, the display apparatus extracts the operation code from the control signal received from the remote controller 200, and executes an operation set corresponding to the extracted operation code.

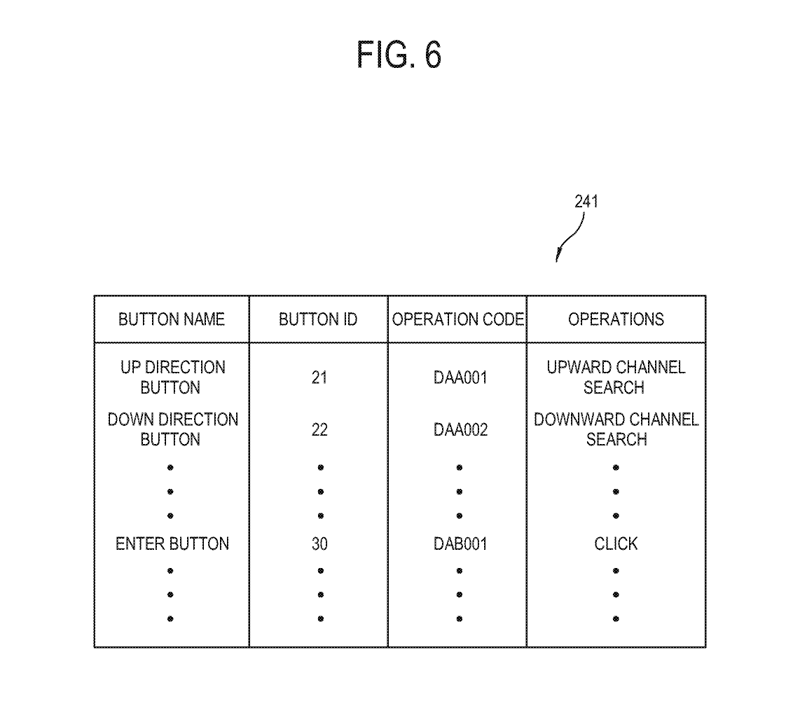

FIG. 6 illustrates some codes of the code set 241 stored in the remote controller according to the third exemplary embodiment.

As shown in FIG. 6, in the code set 241, the button IDs of the remote controller are respectively mapped to the operation codes. The button ID and the operation code comply with previously defined grammar. In accordance with standards applied to the remote controller and the display apparatus, there may be various kinds of grammar.

For example, the up direction button has a button ID of ‘21’ and a corresponding operation code of ‘DAA001’. If a user presses the up direction button, the remote control controller determines that a button having the button ID of ‘21’ is pressed and derives the operation code of ‘DAA001’ corresponding to the button ID of ‘21’ from the code set 241. The remote control controller transmits a control signal generated based on the derived operation code of ‘DAA001’ to the display apparatus. The display apparatus derives the operation code of ‘DAA001’ from the control signal received from the remote controller, and thus executes a corresponding operation of searching channels in the up direction.

For instance, if a user presses the enter-button, the remote control controller determines that a button having a button ID of ‘30’ is pressed, and derives an operation code of ‘DAB001’ corresponding to the button ID of ‘30’ from the code set 241. The remote control controller transmits a control signal generated based on the derived operation code of ‘DAB001’ to the display apparatus. The display apparatus derives the operation code of ‘DAB001’ from the control signal received from the remote controller, and thus executes a corresponding operation of clicking.

Like this, the code set 241 assigns the operation codes to the IDs of the buttons provided in the remote controller, and the remote controller generates a control signal for controlling the operations of the display apparatus based on the code set 241. If the code set 241 stored in the remote controller is switched over from the display apparatus to a different apparatus, this remote controller can control the different apparatus.

Referring back to FIG. 5, if a user presses a button of the remote control input device 220, the ID of the corresponding button is transmitted from the remote control input device 220 to the remote control controller 250. For example, if a user presses the down direction button of the remote control input device 220, a signal corresponding to ‘22’, i.e., The ID of the down direction button is transmitted to the remote control controller 250.

The remote control controller 250 searches the code set 241 of the remote control storage 240 for the operation code corresponding to the button ID. For example, the remote control controller 250 derives an operation code of ‘DAA002’ corresponding to the button ID of ‘22’ from the code set 241.

The remote control controller 250 transmits the derived operation code of ‘DAA002’ to the signal transmitter 230, and the signal transmitter 230 generates a control signal corresponding to the operation code of ‘DAA002’ and transmits the control signal to the display apparatus. Alternatively, the remote control controller 250 may generate a control signal corresponding to the derived operation code DAA002 and transmit the control signal to the signal transmitter 230, and the signal transmitter 230 transmits this control signal to the display apparatus.

The display apparatus derives the operation code of ‘DAA002’ from the control signal received from the remote controller 200, and executes a corresponding operation of searching channels in the down direction. Therefore, the remote controller 200 can control the operations of the display apparatus.

In the display apparatus with this structure, a method of switching an image input source will be described below.

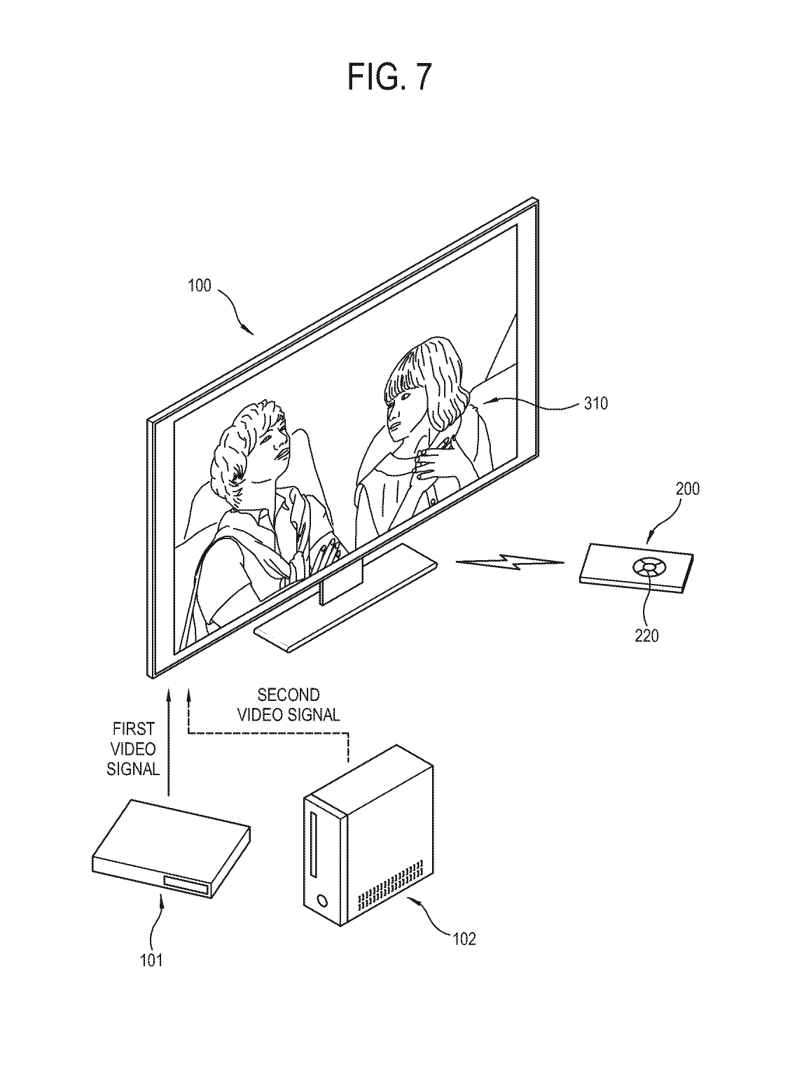

FIG. 7 illustrates that a display apparatus 100 according to a fourth exemplary embodiment displays an image based on a video signal received from an image input source 101.

As shown in FIG. 7, the display apparatus 100 is connected to a plurality of image input sources 101 and 102 and thus receives video signals from the image input sources 101 and 102, respectively. The display apparatus 100 receives a first video signal from a first image input source 101 and a second video signal from a second image input source 102.

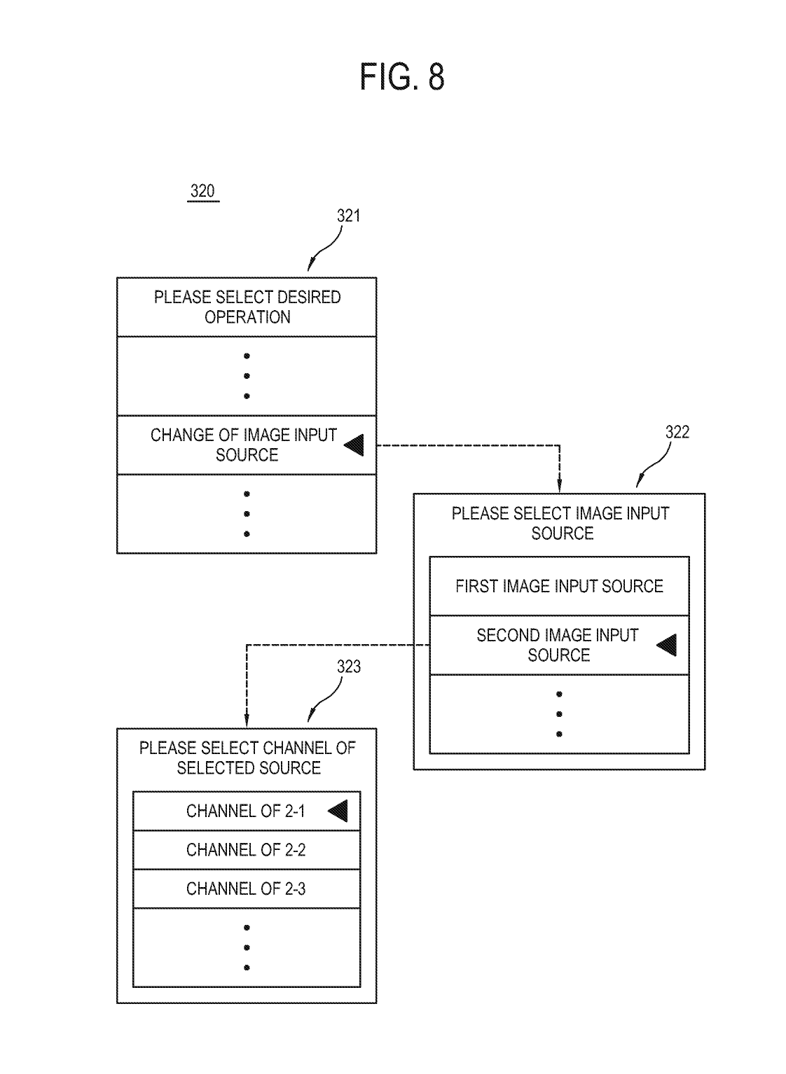

For example, the display apparatus 100 selects the first video signal received from the first image input source 101 between the plurality of image input sources 101 and 102, and displays a first image 310 based on the first video signal. In this state, if a user wants to change a source for providing a video signal to the display apparatus 100 from the first image input source 101 to the second image input source 102, the display apparatus 100 displays a UI for allowing a user to instruct this change. This UI will be described later with reference to FIG. 8.

When the display apparatus 100 displays such a UI, a user manipulates the remote control input device 220 of the second image input source 102 and instructs a desired operation.

FIG. 8 illustrates user interfaces (UIs) 320 of a hierarchical structure, to be displayed on the display apparatus 100 according to the fourth exemplary embodiment.

As shown in FIG. 8, the display apparatus 100 may display the UI 320 including a plurality of sequence UI 321, 322 and 323 to be displayed in sequence in response to a user's input.

In response to a user′ input of a preset button, the display apparatus 100 first displays a UI 321 for allowing a user to instruct an operation of selecting the image input source. Then, a user presses the direction button, selects an item for changing the image input source among instruction items involved in the UI 321, and presses the enter-button for clicking.

Next, the display apparatus 100 displays the UI 322 for allowing a user to select the image input sources currently connected to the display apparatus 100. For example, a user selects and clicks a second image input source among the image input sources shown on the UI 322.

Next, the display apparatus 100 displays a UI 323 for allowing a user to select one among a plurality of channels effective in the selected second image input source. For example, a user selects and clicks a channel of ‘2-1’ among many channels shown on the UI 323. Of course, if only one channel is effective in the second image input source, the display apparatus 100 may automatically select this channel without displaying the UI 323.

In response to a user's inputs through such a series of UIs 320, the display apparatus 100 switches over from the currently displayed image to an image corresponding to the channel of ‘2-1’ in the second image input source.

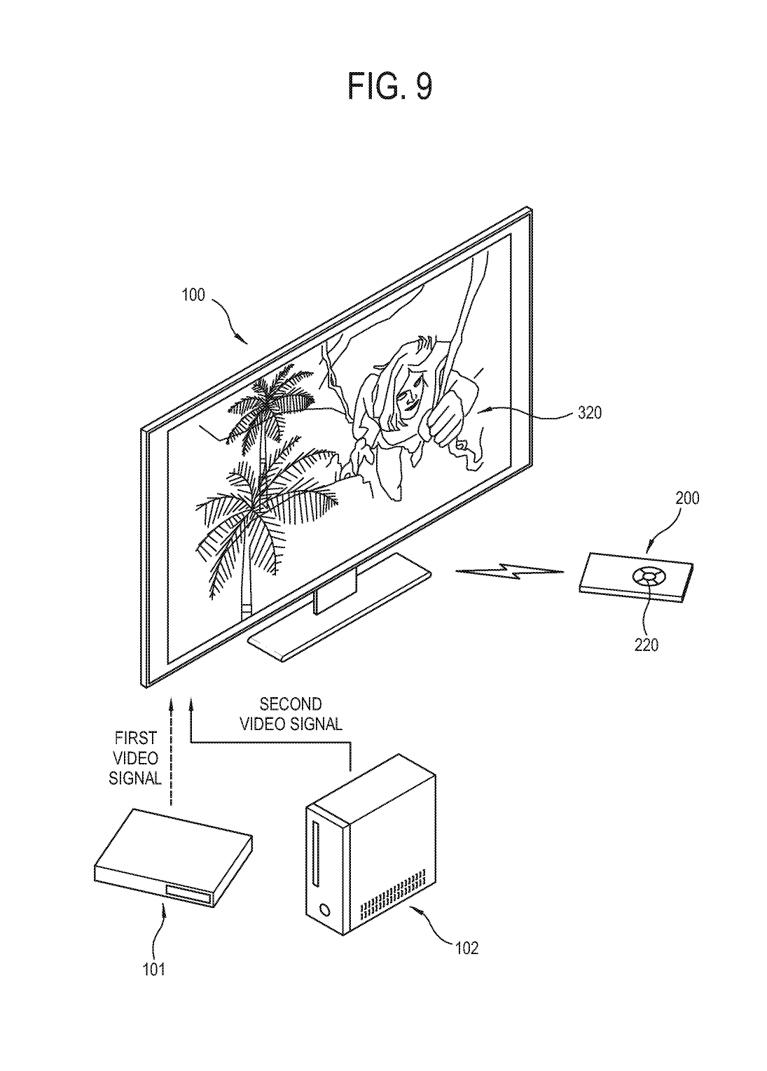

FIG. 9 illustrates that the display apparatus 100 according to the fourth exemplary embodiment displays an image switched over in response to an input for switching over to an image input source 102 through the UIs of FIG. 8.

As shown in FIG. 9, the display apparatus 100 selects a second video signal from a second image input source 102 instead of a first video signal from a first image input source 101 among a plurality of image input sources 101 and 102, and processes the selected second video signal, thereby displaying a second image 330.

Referring to a series of processes shown in FIG. 7 to FIG. 9, the display apparatus 100 according to an exemplary embodiment undergoes many hierarchical processes of the UIs 321, 322 and 323 (see FIG. 8) in response to a user's manipulation on the remote control input device 220. However, these processes are inconvenient for a user to switch over to content.

Below, a fifth exemplary embodiment for solving a user's inconvenience in the fourth exemplary embodiment will be described.

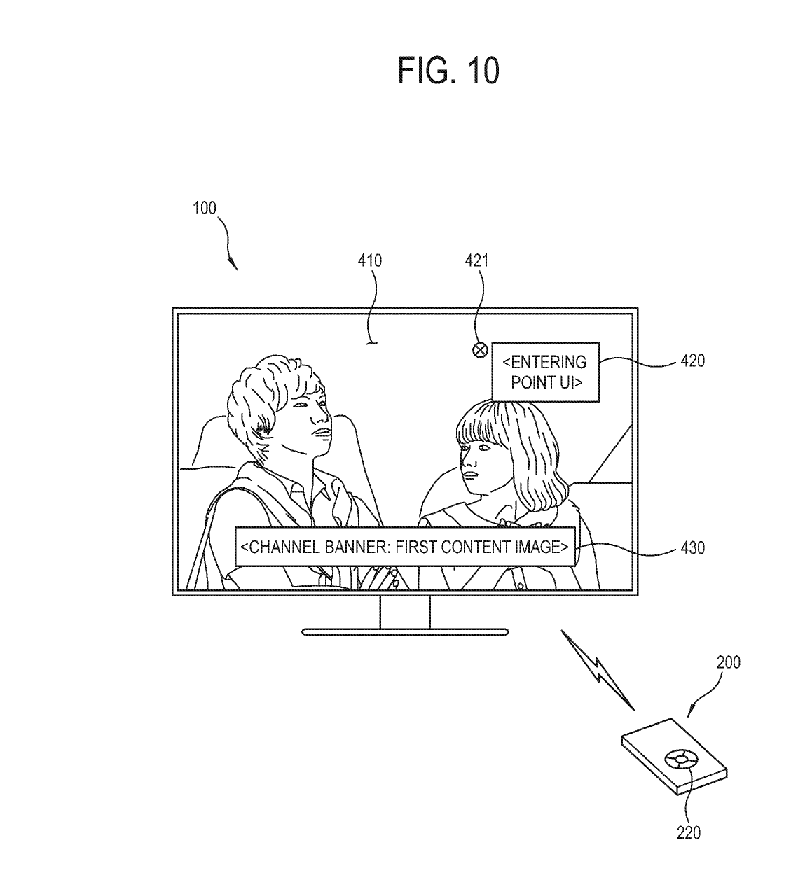

FIG. 10 to FIG. 16 illustrate processes in which the display apparatus 100 according to the fifth exemplary embodiment switches over to content of a display image. In this exemplary embodiment, the display apparatus 100 includes the same basic elements as those described in the foregoing exemplary embodiment.

FIG. 10 illustrates that a display apparatus 100 according to the fifth exemplary embodiment displays an entering point UI 420 and a channel banner 430 on a first content image 410.

As shown in FIG. 10, the display apparatus 100 according to the fifth exemplary embodiment processes first content data received from an image input source and displays the first content image 410. Here, the first content data provided by the image input source may correspond to only one channel or may correspond to a plurality of channels. If the first content data corresponds to the plurality of channels, the display apparatus 100 processes the content of one channel to display the first content image 410.

Suppose that a user wants to change content while the first content image 410 is being displayed. In this case, a user intuitively presses the direction button provided for changing the channels on the remote control input device 220 of the remote controller 200. Such a user's operation is based on a pattern of using the remote controller 200. In this exemplary embodiment, it will be described that the direction button is manipulated for channel change or channel search. However, the buttons for searching the channels may be separately provided in addition to the direction buttons for movement toward a direction, as described above with reference to FIG. 4. In this case, the channel search is performed by manipulating the corresponding buttons.

If a user presses the direction button for the channel change on the remote control input device 220 of the remote controller 200 while the first content image 410 is being displayed, the display apparatus 100 displays the entering point UI 420 and the channel banner 430 on the first content image 410. FIG. 10 illustrates that the entering point UI 420 is displayed on a right above device of the first content image 410 and the channel banner 430 is displayed long below the first content image 410 in a horizontal direction. However, there are no limits to the positions of the entering point UI 420 and the channel banner 430 as long as they are displayed on the first content image 410.

The entering point UI 420 or channel switching UI 420 is a UI provided in the display apparatus 100 and used for switching over to a channel of content determined based on a previously set criterion. That is, if a user presses the direction button for switching the content, the display apparatus 100 determines a channel of content, to which a user wants to switch over, based on a preset criterion, and displays the entering point UI 420 prepared for switching over to the determined channel. There are various criteria for determining the channel of the content to which a user wants to switch over, and details of the criterion will be described later.

The entering point UI 420 is provided for switching over from the current state to a previously set channel, content or image input source in response to a user's input of clicking the entering point UI 420. Information involved in the entering point UI 420 includes an image logo, a title, a channel number, and the like brief information of the channel to which the current state will be switched over.

In addition, the entering point UI 420 may have an object 421 for stopping display of the entering point UI 420. The object 421 may be displayed in the vicinity of the entering point UI 420 or displayed as an object within the entering point UI 420. If a user clicks the object 421, the display apparatus 100 does not display the object 421 and the entering point UI 420.

The channel banner 430 or content banner 430 is a UI showing information about the channel, content or image input source of the first content image 410 being currently displayed. The channel banner 430 provides information about the first content when the entering point UI 420 for the second content, to which the first content will be switched over, is displayed on the first content image 410 of the first content, so that a user can briefly compare the information about the second content shown on the entering point UI 420 with the information about the first content shown on the channel banner 430.

In this embodiment, the display apparatus 100 displays both the entering point UI 420 and the channel banner 430 at the same time, but not limited thereto. Alternatively, the display apparatus 100 may display only the entering point UI 420 without displaying the channel banner 430. The display apparatus 100 may allow a user to select whether to display the entering point UI 420 and the channel banner 430.

In the state that the entering point UI 420 is displayed on the first content image 410, a user chooses the entering point UI 420 and presses the enter-button on the remote control input device 220, thereby selecting the entering point UI 420. Here, the selection of the entering point UI 420 may be performed by clicking the entering point UI 420 in the state that a cursor is moved to a position within the entering point UI 420 or the entering point UI 420 is highlighted among many displayed UIs or objects. Alternatively, the display apparatus 100 may display the entering point UI 420 to be selectable, and in this case a user only has to press the enter-button to click the entering point UI 420.

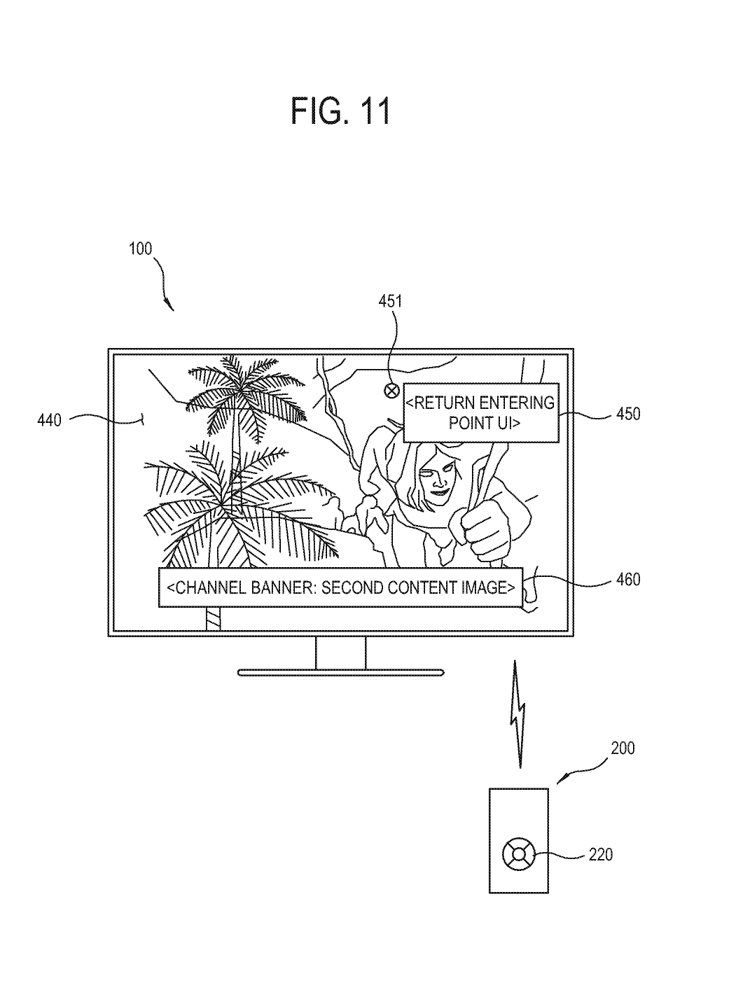

FIG. 11 illustrates that the display apparatus 100 according to the fifth exemplary embodiment displays a return entering point UI 450 and a channel banner 460. FIG. 11 follows FIG. 10.

As shown in FIG. 11, the display apparatus 100 processes the second content data of the second image input source in response to the foregoing operation of clicking the entering point UI 420 (see FIG. 10), and switches over from the currently displayed image to a second content image 440.

Further, the display apparatus 100 displays the return entering point UI 450 and the channel banner 460 on the second content image 440 while displaying the second content image 440. The return entering point UI 450 and the channel banner 460 of FIG. 11 are respectively displayed at the same positions as those of the entering point UI 420 (see FIG. 10) and the channel banner 430 (see FIG. 10). Because there are no limits to the positions of displaying the return entering point UI 450 and the channel banner 460, the return entering point UI 450 and the channel banner 460 may be displayed at different positions from those of the entering point UI 420 (see FIG. 10) and the channel banner 430 (see FIG. 10). However, if the return entering point UI 450 and the channel banner 460 are respectively displayed at the same position as those of the entering point UI 420 (see FIG. 10) and the channel banner 430 (FIG. 10), it is possible to give a guarantee of consistency and continuity to a user in terms of acquiring information from the display apparatus 100.

The return entering point UI 450 or channel returning UI 450 is similar to the entering point UI 420 (see FIG. 10) in terms of the UI prepared for switching over to a channel of content. However, the entering point UI 420 (see FIG. 10) is provided for switching over to a channel of content determined based on a criterion previously set in the display apparatus 100, whereas the return entering point UI 450 is provided for switching over to a channel of content of an image displayed prior to the currently displayed second content image 440, i.e., a channel of the first content image 410 (see FIG. 10) displayed while the entering point UI 420 (see FIG. 10) is displayed.

In other words, if the entering point UI 420 (see FIG. 10) displayed on the first content image 410 (see FIG. 10) of the first content is to switch over to the second content image 440 of the second content, the return entering point UI 450 displayed on the second content image 440 is to return to the first content image 410 (see FIG. 10). Thus, a channel corresponding to the entering point UI 420 (see FIG. 10) is determined based on the criterion previously set in the display apparatus 100, whereas a channel corresponding to the return entering point UI 450 is determined as a channel of an image displayed shortly before the currently displayed image.

The return entering point UI 450 is also provided for switching over to a designated channel, content or image input source in response to a user's input of clicking the return entering point UI 450. Information involved in the return entering point UI 450 includes an image logo, a title, a channel number and the like brief information of the channel to which the current state will be switched over.

The return entering point UI 450 may also have an object 451 for stopping display of the return entering point UI 450. The object 451 may be displayed in the vicinity of the return entering point UI 450 or displayed as an object within the entering point UI 450. If a user clicks the object 451, the display apparatus 100 does not display the object 451 and the entering point UI 450.

The channel banner 460 is a UI showing information about the channel, content or image input source of the second content image 440 being currently displayed. The channel banner 460 shows information about the image being currently displayed. The channel banner 460 provides information about the second content when the return entering point UI 450 for the first content, to which the second content will be switched over, is displayed on the second content image 440 of the second content, so that a user can briefly compare the information about the first content shown on the return entering point UI 450 with the information about the second content shown on the channel banner 460. That is, the channel banner 460 of FIG. 11 and the channel banner 430 of FIG. 10 are equal in containing the channel or content information of the image being currently displayed, but different in the channel or content information because the currently displayed images are different.

In this embodiment, the display apparatus 100 displays both the return entering point UI 450 and the channel banner 460 at the same time, but not limited thereto. Alternatively, the display apparatus 100 may display only the return entering point UI 450 without displaying the channel banner 460. The display apparatus 100 may allow a user to select whether to display the return entering point UI 450 and the channel banner 460.

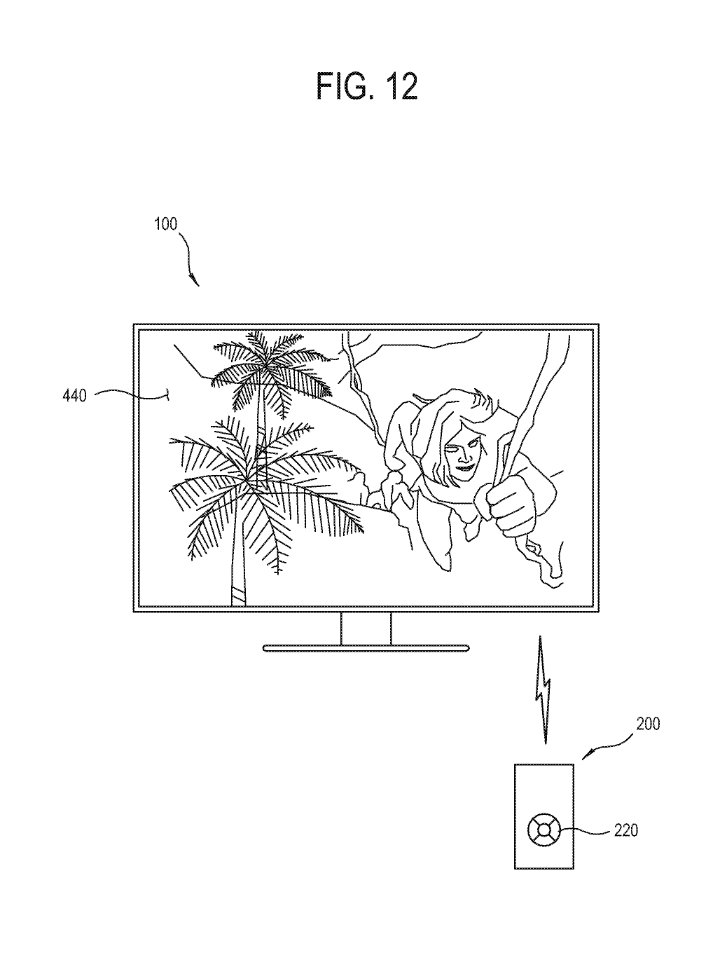

FIG. 12 illustrates that the display apparatus 100 according to the fifth exemplary embodiment displays only the second content image 440. FIG. 12 follows FIG. 11.

As shown in FIG. 12, if a user does not make any input for a preset period of time in the state that the return entering point UI 450 (see FIG. 11) is displayed, the display apparatus 100 displays only the second content image 440 without displaying the return entering point UI 450 (see FIG. 11) and the channel banner 460 (see FIG. 11). Here, the preset period of time is not limited to a numerical value, and may be for example 3 seconds. Further, the input from a user may include all the user interface environments provided by the display apparatus 100 or the remote controller 200 as well as an input using the remote control input device 220 of the remote controller 200.

In this state, if a user presses the direction button on the remote control input device 220 to change channels, the entering point UI is displayed again.

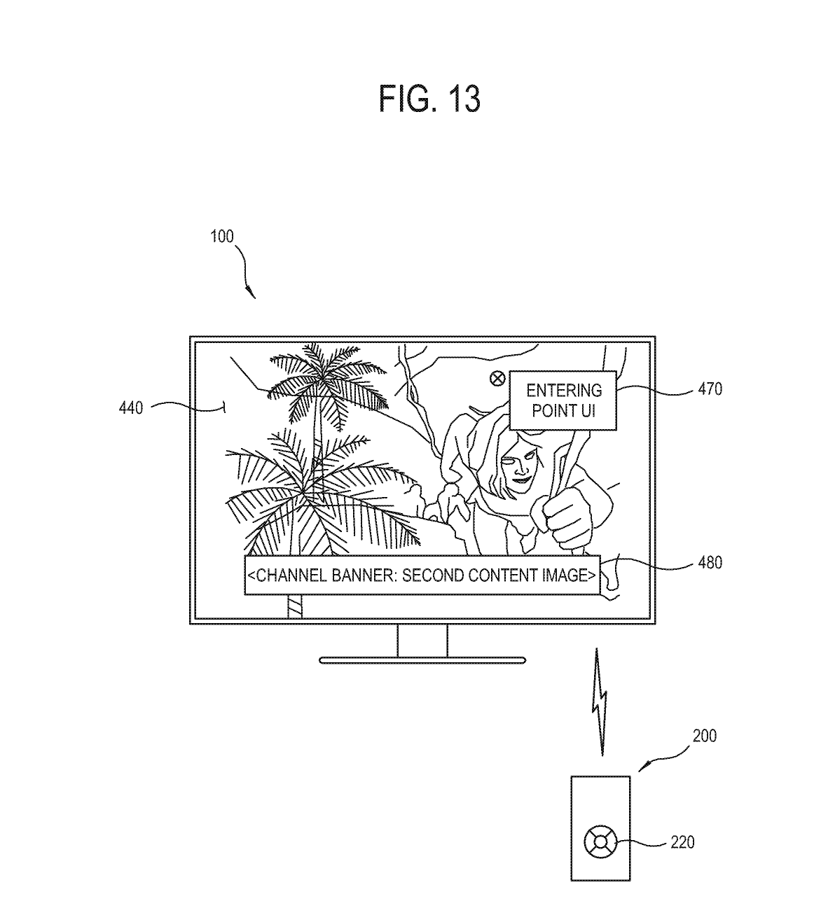

FIG. 13 illustrates that the display apparatus 100 according to the fifth exemplary embodiment displays an entering point UI 470 on the second content image 440. FIG. 13 follows FIG. 12.

As shown in FIG. 13, if a user presses the direction button for the channel change on the remote control input device 220 of the remote controller 200 while the second content image 440 is being displayed, the display apparatus 100 displays the entering point UI 470 and a channel banner 480 on the second content image 440.

In FIG. 13, the channel banner 480 contains information about the second content corresponding to the second content image 440 being currently displayed, and thus substantially the same as the channel banner 460 (see FIG. 11).

A channel, content or image input source corresponding to the entering point UI 470 in FIG. 13 is different from the foregoing channel, content or image input source corresponding to the entering point UI 420 (see FIG. 10). However, the display apparatus 100 determines the channel corresponding to the entering point UI 470 in accordance with the preset criterion, and this criterion is the same as or at least similar to the entering point UI 420 (see FIG. 10). In this regard, details will be described later.

For example if the entering point UI 470 is provided for switching over to the third content, the display apparatus 100 is switched over from a process of the second content data to a process of the third content data in response to an operation of clicking the entering point UI 470.

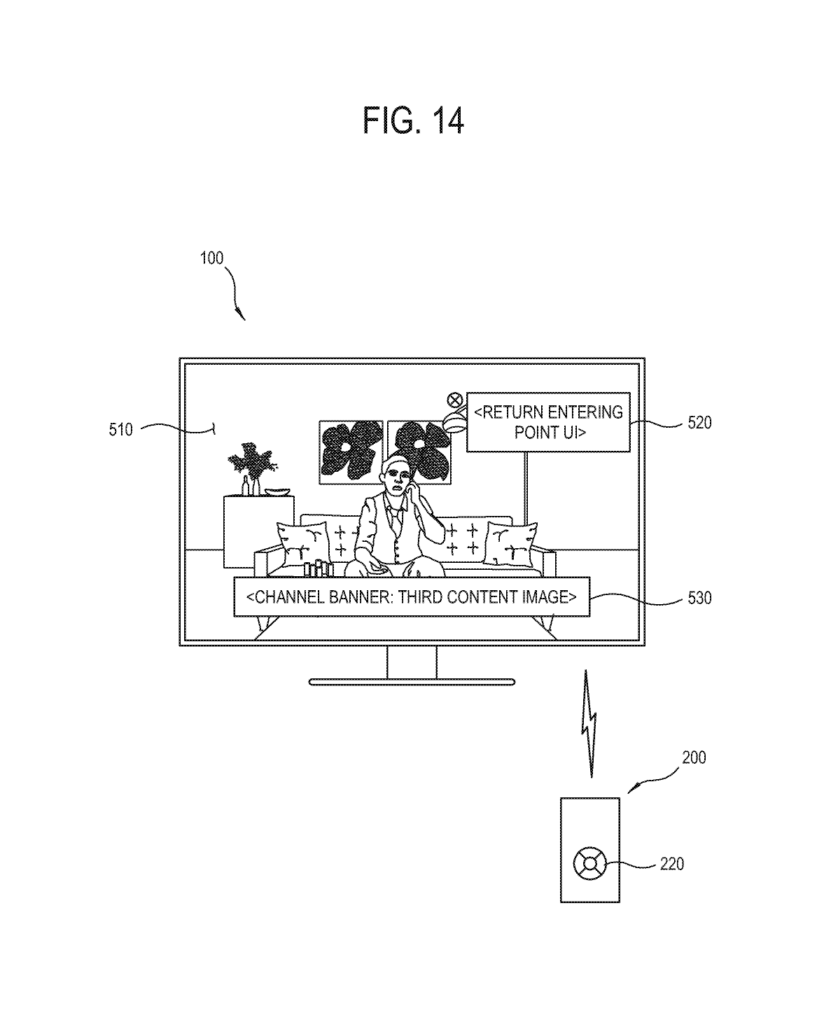

FIG. 14 illustrates that the display apparatus 100 according to the fifth exemplary embodiment displays a third content image 510. FIG. 14 follows FIG. 13.

As shown in FIG. 14, the display apparatus 100 displays a third content image 510 of a channel designated corresponding to the entering point UI 470 (see FIG. 13) in response to a user's input of clicking the entering point UI 470 (see FIG. 13). Further, the display apparatus 100 displays a return entering point UI 520 and a channel banner 530 on the third content image 510.

In FIG. 14, the channel banner 530 contains brief information related to third content of the third content image 510 being currently displayed.

The return entering point UI 520 in this embodiment basically follows the same principle as that of the return entering point UI 450 (see FIG. 11). That is, the return entering point UI 520 is provided for returning to the second content image 440 (see FIG. 13) displayed shortly before the currently displayed third content image 510. If a user clicks the return entering point UI 520, the display apparatus 100 switches over from the third content image 510 to the second content image 440 (see FIG. 13).

If a user does not make any input for a preset period of time from time when the return entering point UI 520 and the channel banner 530 are displayed, the display apparatus 100 displays only the third content image 510 without displaying the return entering point UI 520 and the channel banner 530.

Like this, if a user presses the direction button for the channel change on the remote controller 200 while viewing an image, the display apparatus 100 predicts a channel desired by him/her based on the previously set criterion or algorithm, and displays the entering point UI prepared for switching over to the predicted channel. Further, the display apparatus 100 displays an image of a channel corresponding to the entering point UI in response to a user's manipulation for selecting the entering point UI. Thus, the display apparatus 100 is convenient for a user to change a channel or an image input source by manipulating the button of the remote controller 200.

While the entering point UI is being displayed, a user may press the direction button of the remote controller 200 without clicking the entering point UI. Operations in this case will be described below.

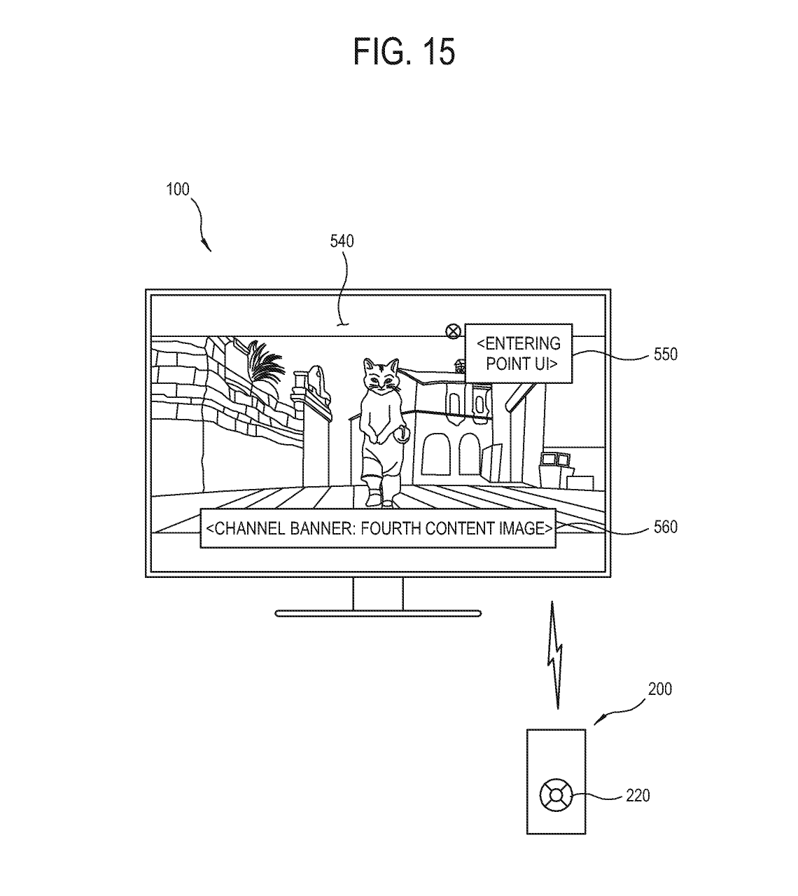

FIG. 15 illustrates an operation of when a user presses a direction button 220 for switching a channel while a display apparatus 100 according to a sixth exemplary embodiment displays an entering point UI 550. FIG. 15 follows FIG. 10.

The display apparatus 100 according to the sixth exemplary embodiment may receive a control signal corresponding to the direction button 220 for channel switching instead of a controls signal of clicking the entering point UI 550 from the remote controller 200, while the first content image 410 (see FIG. 10) and the entering point UI 420 (see FIG. 10) are being displayed.

As shown in FIG. 15, the display apparatus 100 determines a channel, content or image input source directed by the control signal in response to the control signal. For example, if the channel directed by the control signal corresponds to fourth content, the display apparatus 100 switches over from the currently displayed image to a fourth content image 540 of the fourth content. Further, the display apparatus 100 displays the entering point UI 550 and a channel banner 560 on the fourth content image 540.

The channel banner 560 contains basic information related to the fourth content of the fourth content image 540.

Here, the control signal received in the display apparatus 100 having the state of FIG. 10 is not a signal for instruction of clicking the entering point UI 550 but corresponds to the direction button 220 for changing channels, and therefore the setting and display of the entering point UI 550 are maintained as they are without change. That is, the entering point UI 550 of FIG. 15 is the same as the entering point UI 420 (see FIG. 10), and thus the channel corresponding to the entering point UI 550 is the same as the channel corresponding to the entering point UI 420 (see FIG. 10).

By the way, a channel determined as a user presses the direction button 220 for changing channels may be equal to a channel set for the entering point UI 550. An exemplary embodiment in this case will be described below.

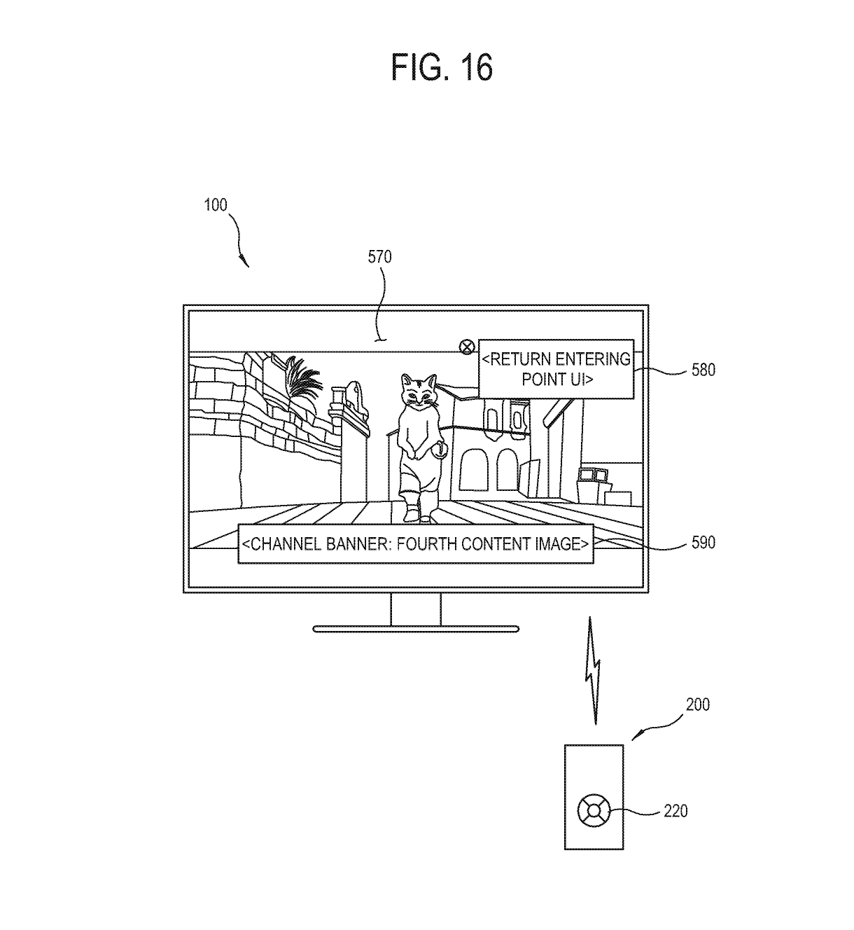

FIG. 16 illustrates that a display apparatus 100 according to a seventh exemplary embodiment displays a fourth content image 570. FIG. 16 follows FIG. 10.

The display apparatus 100 according to the seventh exemplary embodiment may receive the control signal corresponding to the direction button 220 for switching the channels instead of the control signal for the instruction of clicking the entering point UI 420 (see FIG. 10) from the remote controller 200 while the first content image 410 (see FIG. 10) and the entering point UI 420 (see FIG. 10) are being displayed.

As shown in FIG. 16, the display apparatus 100 determines the channel, content or image input source directed by the control signal in response to such a control signal. For example, if the channel directed by the control signal corresponds to the fourth content, the display apparatus 100 switches over from the currently displayed image to a fourth content image 570 of the fourth content.

Here, if the channel directed by the control signal is equal to the channel corresponding to the entering point UI 420 (see FIG. 10), a user's input of pressing the direction button for the channel change leads to the same result as clicking the entering point UI 420 (see FIG. 10).

Thus, the display apparatus 100 displays a return entering point UI 580 and a channel banner 590 on the fourth content image 570.

In the foregoing exemplary embodiments, the difference in between the entering point UI and the return entering point UI is as follows. The display apparatus displays the entering point UI in response to a user's input for instructing the channel change or channel search. Further, if the entering point UI is selected to change the channel or input source, the display apparatus switches over to the corresponding channel or input source and then displays the return entering point UI for returning to the previous channel or input source.

The channel banner 590 includes basic information related to the fourth content of the fourth content image 570.

The return entering point UI 580 is provided for returning to the first content image 410 (see FIG. 10) displayed shortly before displaying the fourth content image 570. If a user clicks the return entering point UI 580, the display apparatus 100 switches over the displayed image to the first content image 410 (see FIG. 10) corresponding to the return entering point UI 580.

In addition, the entering point UI, the return entering point UI, the channel banner, etc. described in the foregoing exemplary embodiments may be set by a user to be displayed or not displayed. To this end, the display apparatus 100 may provide an environment so that a user can set the display of the entering point UI, the return entering point UI, the channel banner, etc.

In the foregoing exemplary embodiments, if a user presses the channel search button in the state that the display apparatus displays an image at first, the display apparatus displays the entering point UI on the displayed image. Such an entering point UI may make an instruction to switch over channels within one input source or make an instruction to switch over between the input sources, and these instructions may be determined based on a preset algorithm.

Taking a user's use pattern into account, the display may perform both a first operation of switching over from the currently displayed channel to another channel within one input source and a second operation of switching over from the current input source to another input source among many input sources of providing the content data. An exemplary embodiment in this case will be described.

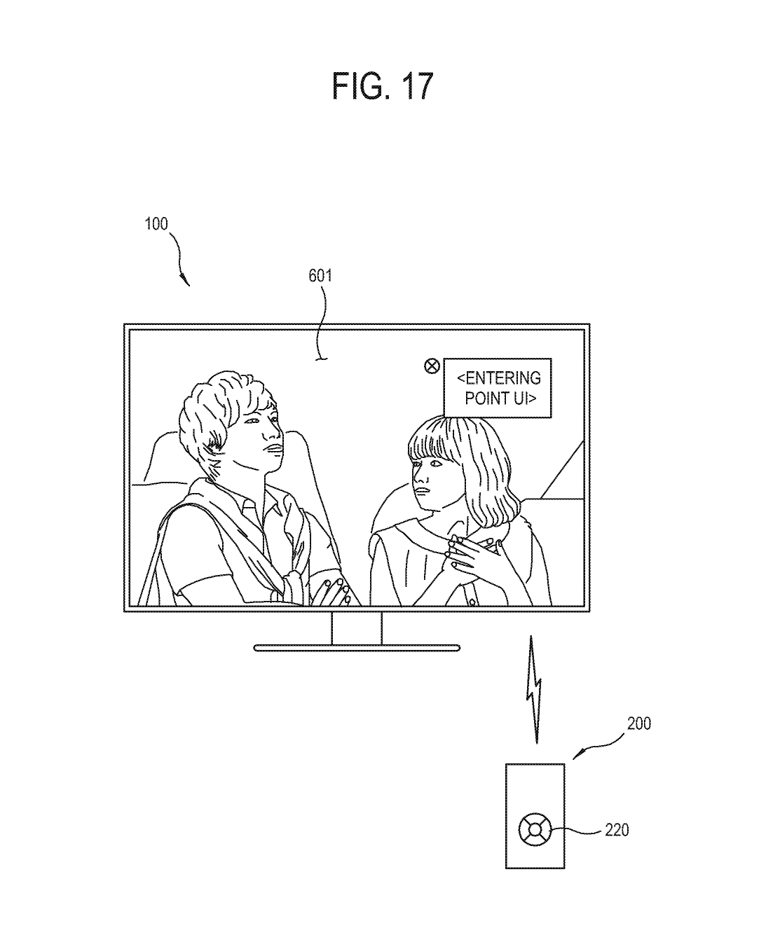

FIG. 17 illustrates that the display apparatus 100 according to the seventh exemplary embodiment displays a first content image 601.

As shown in FIG. 17, the display apparatus 100 receives the content data from the first image input source among the plurality of image input sources of providing the image content, and displays the first content image 601 of the first channel corresponding to the received content data.

Like this, a user may make an instruction for change channels by manipulating the remote control input device 220 while the display apparatus 100 is displaying the first content image 601.

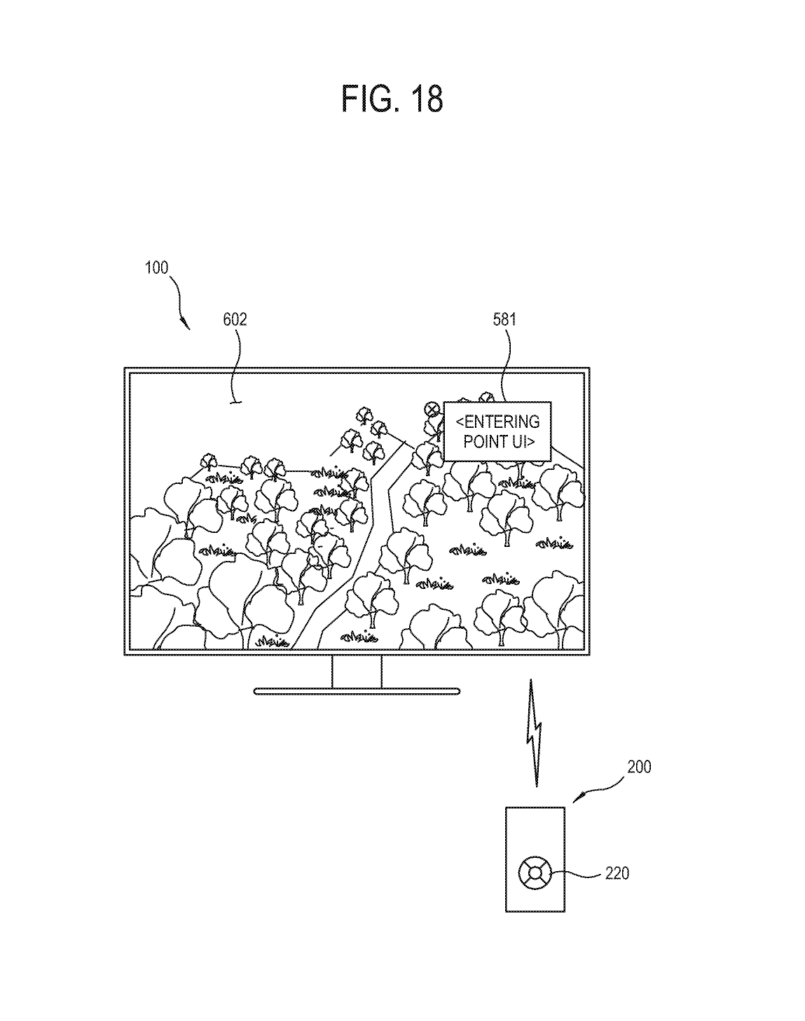

FIG. 18 illustrates that the display apparatus 100 according to the seventh exemplary embodiment performs an operation of switching a channel and an operation of displaying an entering point UI 581 in response to a user's input. FIG. 18 follows FIG. 17.

As shown in FIG. 18, the display apparatus 100 receives an instruction for channel change from the remote controller 200 while displaying the first content image 601 (see FIG. 17) from the first image input source. In response to this instruction, the display apparatus 100 performs two operations as follows.

In response to the instruction for the channel change, the display apparatus 100 performs the first operation for switching over to a second content image 602 of a channel provided by the same first image input source as that of the first content image 601 (see FIG. 17). That is, the first operation refers to channel switching within the same first image input source.

Further, in response to the instruction for the channel change, the display apparatus 100 performs the second operation for displaying the entering point UI 581 on the second content image 602 to switch over to the second image input source different from the first image input source of providing the first content image 601 (see FIG. 17). There are various methods of selecting one among many image input sources for providing content to the display apparatus 100 as the second image input source, and details of which will be described later.

In this state, if a user does not make any input for a preset period of time, the display apparatus 100 does not display the entering point UI 581 but displays only the second content image 602. On the other hand, if a user selects the entering point UI 581, the display apparatus 100 switches over to the second image input source directed by the entering point UI 581 and displays a content image of a channel provided by the second image input source.

According to an exemplary embodiment, in response to a user's instruction for channel change, the display apparatus switches over from an image of a current channel to an image of another channel within the current image input source and displays the entering point UI for switching over from the current image input source to another image input source on the switched image. Thus, it is easy for a user to switch over between the image input sources by manipulation for channel change.

When a user selects the entering point UI 581, the display apparatus 100 displays the third content image directed by the entering point UI 581, and displays the return entering point UI on the third content image. Here, an image directed by the return entering point UI may be the first content image 601 (see FIG. 17) or the second content image 602.

Between the first content image 601 (see FIG. 17) and the second content image 602 displayed prior to the third content image directed by the entering point UI 581, the second content image 602 may be selected as one corresponding to the return entering point UI in accordance with time when the entering point UI 581 is displayed, or the first content image 601 (see FIG. 17) may be selected as one corresponding to the return entering point UI in accordance with time when a user makes an input for displaying the entering point UI 581.

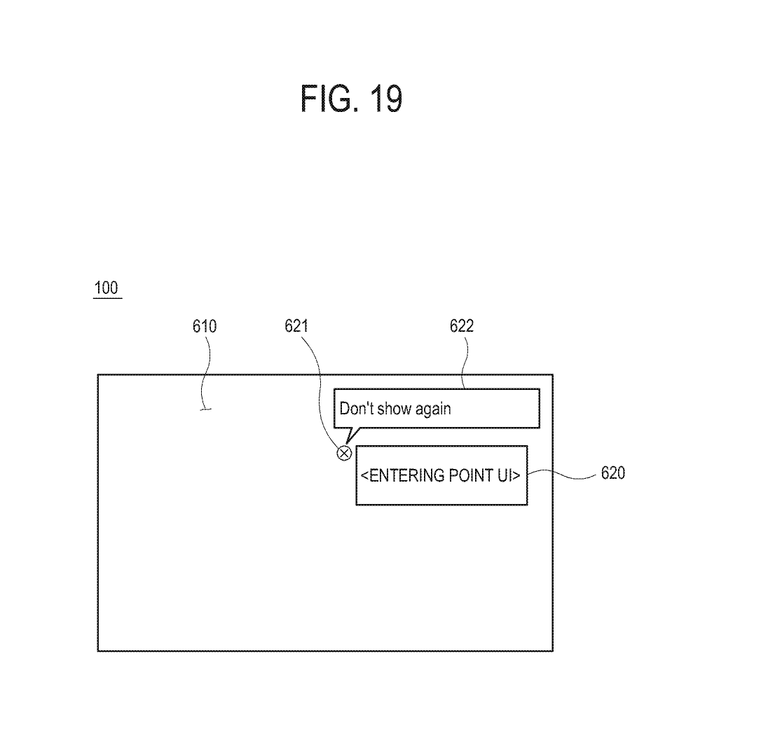

FIG. 19 illustrates that a display apparatus 100 according to an eighth exemplary embodiment displays guide information 622 for a deleting object 621.

As shown in FIG. 19, the display apparatus 100 according to the eighth exemplary embodiment displays an entering point UI 620 for switching over to a channel, content or image input source on a content image 610 in response to a user's input. At this time, the entering point UI 620 has an object 621 for making the entering point UI 620 be deleted, i.e., not be shown. If a user clicks the object 621, the display apparatus 100 deletes the entering point UI 620 and the object 621 not to be shown.

Here, the object 621 may have the guide information 622 as a UI in the form of a speech bubble for describing the function or role of the object 621. The guide information 622 briefly shows an operation performed when the object 621 is clicked. The guide information 622 may be continuously displayed while the object 621 is displayed, or may be displayed when a cursor is put on the object 621 to click the object 621. The guide information 622 is deleted together with the entering point UI 620 and the object 621 when the entering point UI 620 is deleted.

Likewise, the channel banner may have the foregoing features. That is, the channel banner may also have the object 621 and the guide information 622, and they operate based on the same principle as described above.

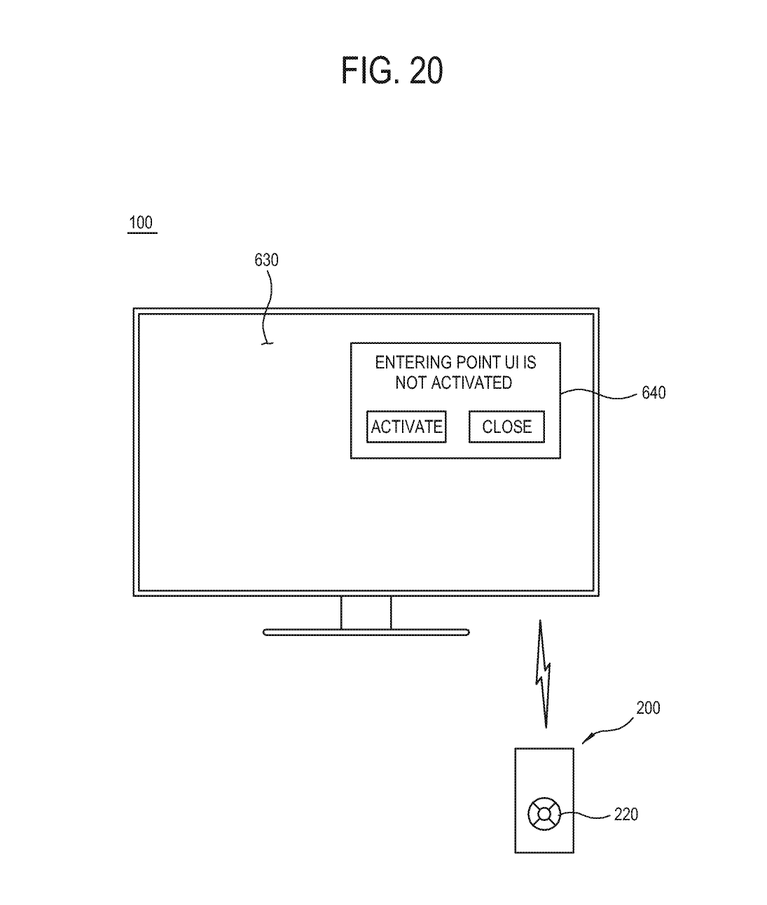

FIG. 20 illustrates that a display apparatus 100 according to a ninth exemplary embodiment displays a guide window 640 for informing that the entering point UI is not activated.

As shown in FIG. 20, the display apparatus 100 according to the ninth exemplary embodiment determines whether or not the entering point UI is activated to be displayed in settings of the display apparatus 100 if a user presses the direction button for channel switching on the remote control input device 220 of the remote controller 200 while a content image 630 is displayed.

If it is determined that the display of the entering point UI is activated, the display apparatus 100 displays the entering point UI in response to the control signal from the remote controller 200.

On the other hand, if it is determined that the display of the entering point UI is not activated, the display apparatus 100 displays the guide window 640 for informing a user that the display of the entering point UI is inactivated on the content image 630 in response to the control signal from the remote controller 200. The guide window 640 may be displayed at the same position as the entering point UI so that a user can intuitively view it, but there are no limits to the position of the guide window 640.

In terms of convenience, the guide window 640 may further include a selectable object prepared for activating the entering point UI in addition to the foregoing guide information. For example, this object may be given in the form of a UI button labelled with “activation.” If a user clicks this object in the guide window 640, the display apparatus 100 displays the entering point UI instead of the guide window 640.

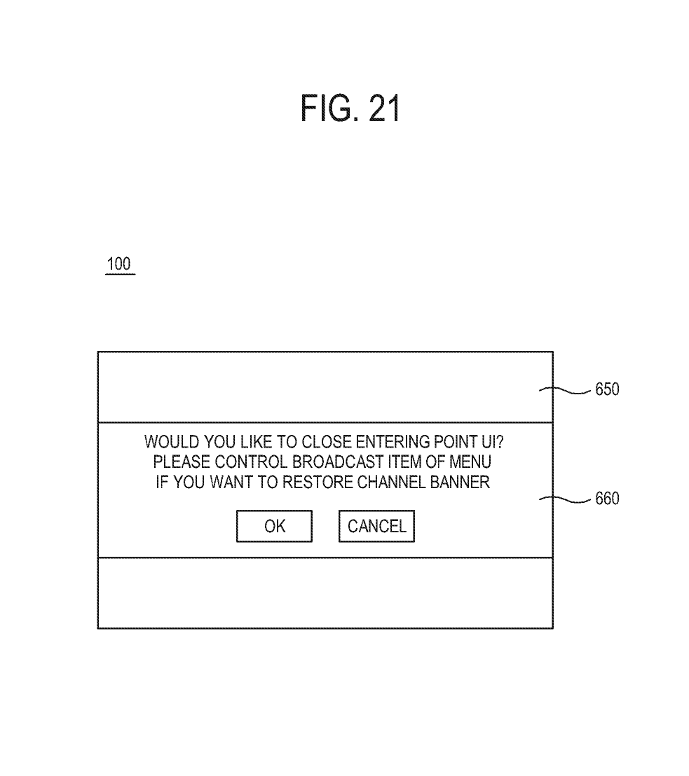

FIG. 21 illustrates that a display apparatus 100 according to a tenth exemplary embodiment displays a guide window 660 when a channel banner is closed;

As shown in FIG. 21, the display apparatus 100 according to the tenth exemplary embodiment displays the guide window 660 for confirming a user's input when a user makes an input for closing the channel banner to disappear.

The guide window 660 includes UI buttons for confirming that a user makes an input for closing the channel banner, giving a guide for recovering the channel banner, and accepting or canceling the operation of closing the channel banner. Through the guide window 660, a user may delete or cancel the channel banner of providing the content information of a currently displayed content image 650, or may be guided to recover the channel banner.

Below, processes in which the display apparatus changes a channel through the entering point UI will be described.

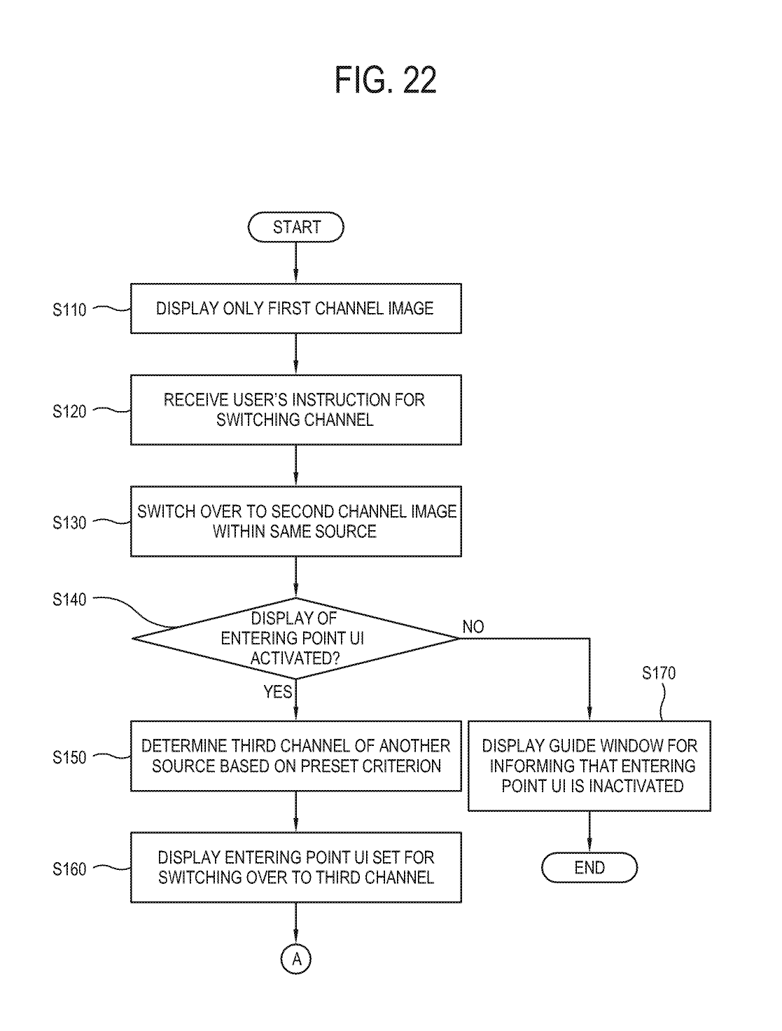

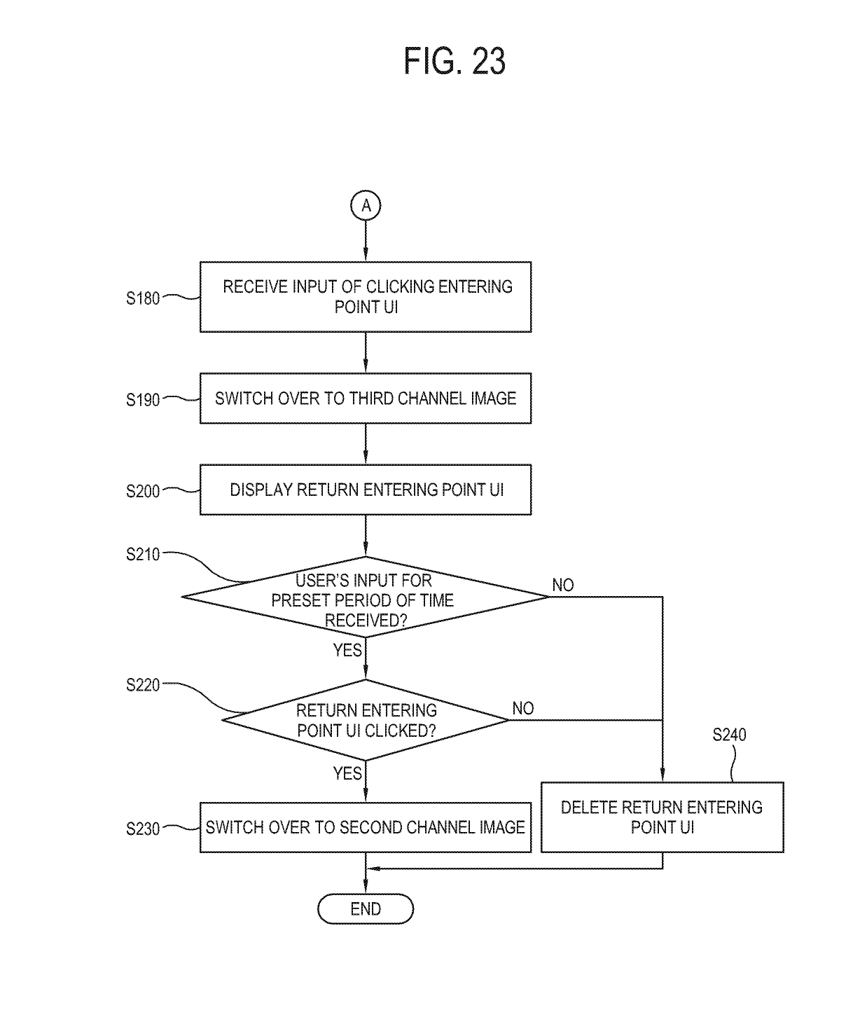

FIG. 22 and FIG. 23 are a flowchart of changing a channel through an entering point UI in a display apparatus according to an eleventh exemplary embodiment.

As shown in FIG. 22, at operation S110 the display apparatus displays a first channel image of a first channel.

At operation S120 the display apparatus receives an instruction for channel change from a user. The instruction for channel change is made when a user manipulates the direction buttons for the channel change or the buttons provided for the channel change separately from the direction button in the remote controller.

At operation S130 the display apparatus switches over from the first channel image to a second channel image of a second channel within one image input source in response to the instruction for the channel change.

At operation S140 the display apparatus determines whether the display of the entering point UI is activated.

If it is determined that the display of the entering point UI is activated, at operation S150 the display apparatus determines a third channel targeted for switching based on a preset criterion. Here, the third channel is provided from the image input source different from the image input source of the currently displayed. At operation S160 the display apparatus displays the entering point UI set to switch over to the determined third channel.

On the other hand, if it is determined that the display of the entering point UI is inactivated, at operation S170 the display apparatus displays the guide window for informing that the entering point UI is not activated.

As shown in FIG. 23, at operation S180 the display apparatus receives a user's input of clicking the entering point UI.

At operation S190 the display apparatus switches over to the third channel set corresponding to the entering point UI and displays the third channel image in response to a user's input.

At operation S200 the display apparatus displays a return entering point UI, which is set to return to the second channel of the second channel image displayed prior to the third channel image, on the third channel image.

At operation S210 the display apparatus determines whether a user's input is received for a preset period of time.

If it is determined that a user's input is received for a preset period of time, at operation S220 the display apparatus determines whether a user clicks the return entering point UI or not.

If it is determined that a user clicks the return entering point UI, at operation S230 the display apparatus switches over to the second channel set corresponding to the return entering point UI and displays the second channel image. Alternatively, the display apparatus may switch over to the first channel and display the first channel image.

If it is determined at operation S210 that a user's input is not received for the preset period of time or if it is determined at operation S220 that a user does not click the return entering point UI, at operation S240 the display apparatus deletes the return entering point UI and keeps displaying the third channel image.

In the foregoing operation S120, the display apparatus receives the instruction for the channel change from a user, and the instruction for the channel change is made when a user manipulates the direction button for the channel change on the remote controller. However, such an instruction for channel change or channel search may be made by not only manipulating the direction button but also manipulating various buttons such as numeral keys on the remote controller. That is, the display apparatus may previously store a group of channel search signals including key signals, and determines whether a key signal received from the remote controller is included in the previously stored group of channel search signals. If it is determined that the key signal received from the remote controller belongs to the previously stored group of channel search signals, the display apparatus determines that the instruction for the channel search or channel change is received from the remote controller.

In the foregoing exemplary embodiments, when the display apparatus displays the entering point UI, the channel, content or image input source directed by the entering point UI is determined based on the preset criterion or algorithm. Such a criterion may be not limited to an example but set by various methods or principles. Nevertheless, the criterion may be made based on a content view history of user who has been viewed the display apparatus because the display apparatus is not a server but an apparatus personally used by a user, thereby reflecting a user's preference more accurately.

Below, a method of determining a channel directed by an entering point UI will be described.

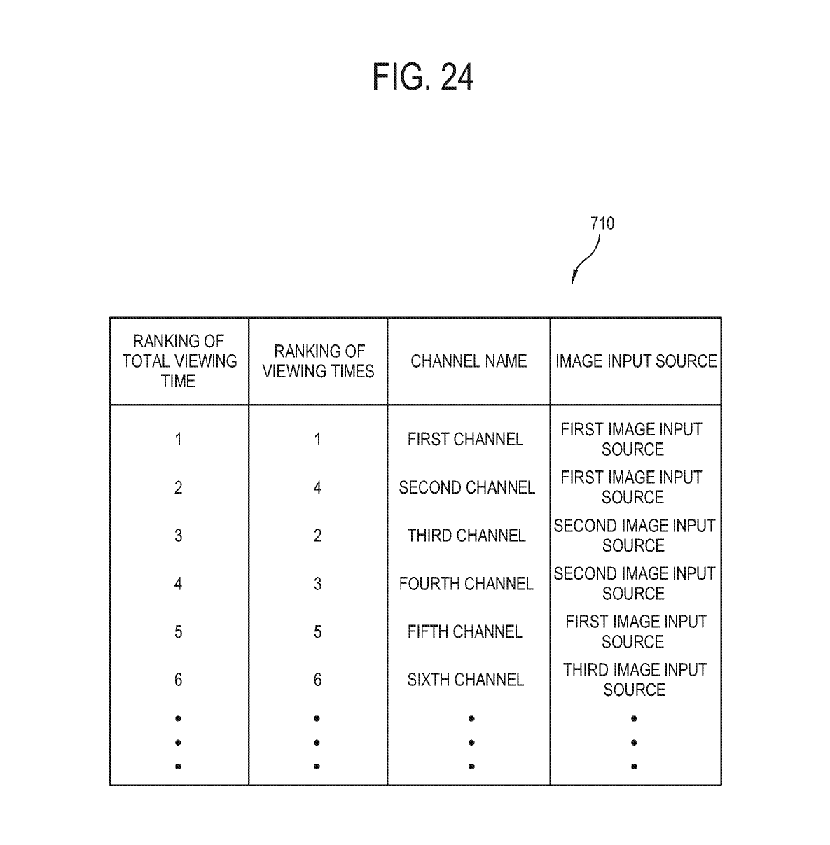

FIG. 24 illustrates a list 710 based on a user's content view history to be referred to by a display apparatus according to a twelfth exemplary embodiment;

As shown in FIG. 24, the display apparatus according to the twelfth exemplary embodiment accumulates a history of content viewed by a user for a preset period of time, and makes the content be ranked in order of view frequency. The list 710 shows an example of a ranking list of content.

In case of the view frequency of content, the content may be different in running time, and different in viewing times. For example, first content may be broadcasted once a week for 1 hour, but second content may be broadcasted four times a week for 10 minutes. If the view frequency is based on a total of viewing time for a week, the first content has a higher view frequency than the second content because the first content is totally viewed for 1 hour but the second content is totally viewed for 40 minutes. On the other hand, if the view frequency is based on a total of viewing times for a week, the second content has a higher view frequency than the first content because the first content is totally viewed once but the second content is totally viewed four times.

Like this, various criteria may be applied to the display apparatus when the display apparatus is designed. Therefore, exemplary embodiments are not limited by this criterion.

Referring to the list 710, there are a first channel, a second channel, a third channel, a fourth channel, a fifth channel and a sixth channel ranked in order of total viewing time for a preset period of time. Further, the first channel, the third channel, the fourth channel, the second channel, the fifth channel and the sixth channel are listed in order based on the total viewing time for the preset period of time. In addition, the first channel, the second channel and the fifth channel are provided from the first image input source, the third channel and the fourth channel are provided from the second image input source, and the sixth channel is provided from the third image input source.

If an event occurs to display the entering point UI, the display apparatus determines a channel targeted for switching based on the list 710 when the entering point UI is clicked. Here, the display apparatus may select different channels in accordance with the previously prepared criterions even though it refers to the same list 710.

For example, the display apparatus may select the highest ranked channel in order of total viewing time for the preset period of time, regardless of the image input sources. In this criterion, the display apparatus selects the first channel, which is highest ranked in order of the total viewing time, in the list 710, and displays the entering point UI for switching over to the first channel when a user clicks the entering point UI.

If an image of the first channel is being currently displayed, the display apparatus selects the next highest ranked second channel in order of the total viewing time in the list 710.

For instance, the display apparatus may select the highest ranked channel in order of total viewing times for a preset period of time, regardless of the image input source. In this criterion, the display apparatus selects the first channel, which is highest ranked in order of the total viewing times, in the list 710, and displays the entering point UI for switching over to the first channel when a user clicks the entering point UI.

If an image of the first channel is being currently displayed, the display apparatus selects the next highest ranked third channel in order of the total viewing times in the list 710.

For example, the display apparatus may select the highest ranked channel in order of total viewing time for a preset period of time, within an image input source different from the image input source corresponding to the currently displayed channel. If an image of the second channel is being currently displayed, the display apparatus selects the highest ranked channel in order of total viewing time among channels provided by image input sources except the first image input source providing the second channel. In the list 710, there are the third channel and the fourth channel provided by the second image input source, and the sixth channel provided by the third image input source. Among them, the third channel is highest ranked in order of total viewing time. Therefore, the display apparatus selects the third channel, and displays the entering point UI for switching over to the third channel when a user clicks the entering point UI.

For example, the display apparatus may select the highest ranked channel in order of total viewing times for a preset period of time, within an image input source different from the image input source corresponding to the currently displayed channel. If an image of the third channel is being currently displayed, the display apparatus selects the highest ranked channel in order of total viewing times among channels provided by image input sources except the second image input source providing the third channel. In the list 710, there are the first channel, the second channel and the fifth channel provided by the first image input source, and the sixth channel provided by the third image input source. Among them, the first channel is highest ranked in order of total viewing times. Therefore, the display apparatus selects the first channel, and displays the entering point UI for switching over to the third channel when a user clicks the entering point UI.

In the foregoing description, the display apparatus accumulates a history of content viewed by a user for a preset period of time and selects a channel based on the history. However, the method of using the view history is not limited to the foregoing method of using the list 710.

For example, the display apparatus selects a channel of an image displayed shortly before a channel of a currently display image, regardless of the image input sources. Alternatively, the display apparatus may select a channel, which has been displayed temporally closest to the channel of the currently displayed image, among channels of images provided by image input sources different from the channel of the currently displayed image.

For example, if the currently displayed image is the first channel, an image displayed shortly before displaying the first channel is the second channel, and an image displayed shortly before displaying the second channel is the sixth channel, it is regarded that the display apparatus sequentially displays the sixth channel, the second channel and the first channel in temporal order.

If a criterion is set to select a channel of an image displayed shortly before the channel of the currently displayed image regardless of the image input source, the display apparatus selects the second channel displayed shortly before the first channel.

On the other hand, if a criterion is set to select a channel, which has been displayed temporally closest to the channel of the currently displayed image, among channels of images provided by image input sources different from the channel of the currently displayed image, the second channel cannot be selected because it is provided by the same first image input source as the first channel. Thus, the display apparatus selects the sixth channel that is provided by the image input source different from the first image input source and temporally closest to the current time.

The foregoing exemplary embodiment is applied to the cases of channel and content, but may be also similarly applied to the image input source.

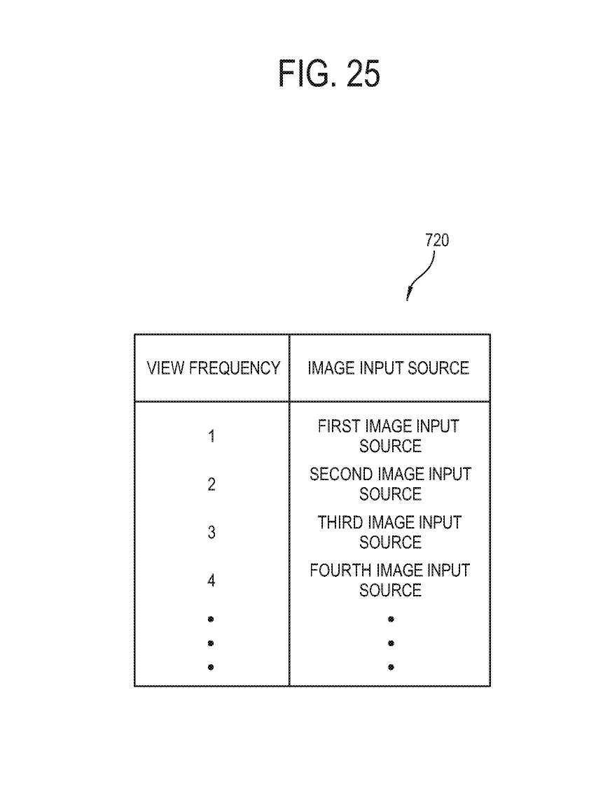

FIG. 25 illustrates a list 720 based on a user's content view history to be referred to by a display apparatus according to a thirteenth exemplary embodiment.

As shown in FIG. 25, the display apparatus according to the thirteenth exemplary embodiment accumulates a history of image input sources providing the content viewed by a user for a preset period of time, and makes the image input sources be ranked in order of view frequency. The list 720 shows an example of a ranking list of image input sources.

The view frequency in this exemplary embodiment is the same as described above, and thus repetitive descriptions thereof will be avoided. For example, the view frequency of the image input sources may be determined by various criteria such as a total of time of viewing the content provided by the image input sources, a total of times of viewing the content, etc.

In the list 720, there are a first image input source, a second image input source, a third image input source and a fourth image input source ranked in order of view frequency.

For example, the display apparatus selects the highest ranked image input source in order of view frequency, among the image input sources except the image input source of providing the currently displayed channel. If the channel of the currently displayed image belongs to the first image input source, the display apparatus selects the highest ranked second image input source in order of view frequency among the image input sources except the first image input source.

For example, the display apparatus selects the image input source having a display history temporally closed to the current time, among the image input sources except the image input source of providing the currently displayed channel. If an image provided by the third image input source has been displayed and an image provided by the first image input source is currently displayed shortly after the image of the third image input source, the display apparatus selects the third image input source and displays the corresponding entering point UI.

Thus, the display apparatus according to an exemplary embodiment may employ various criteria in selecting the channel, content or image input source corresponding to the entering point UI.

Below, a method of selecting a channel targeted for switching to display the entering point UI in the display apparatus will be described.

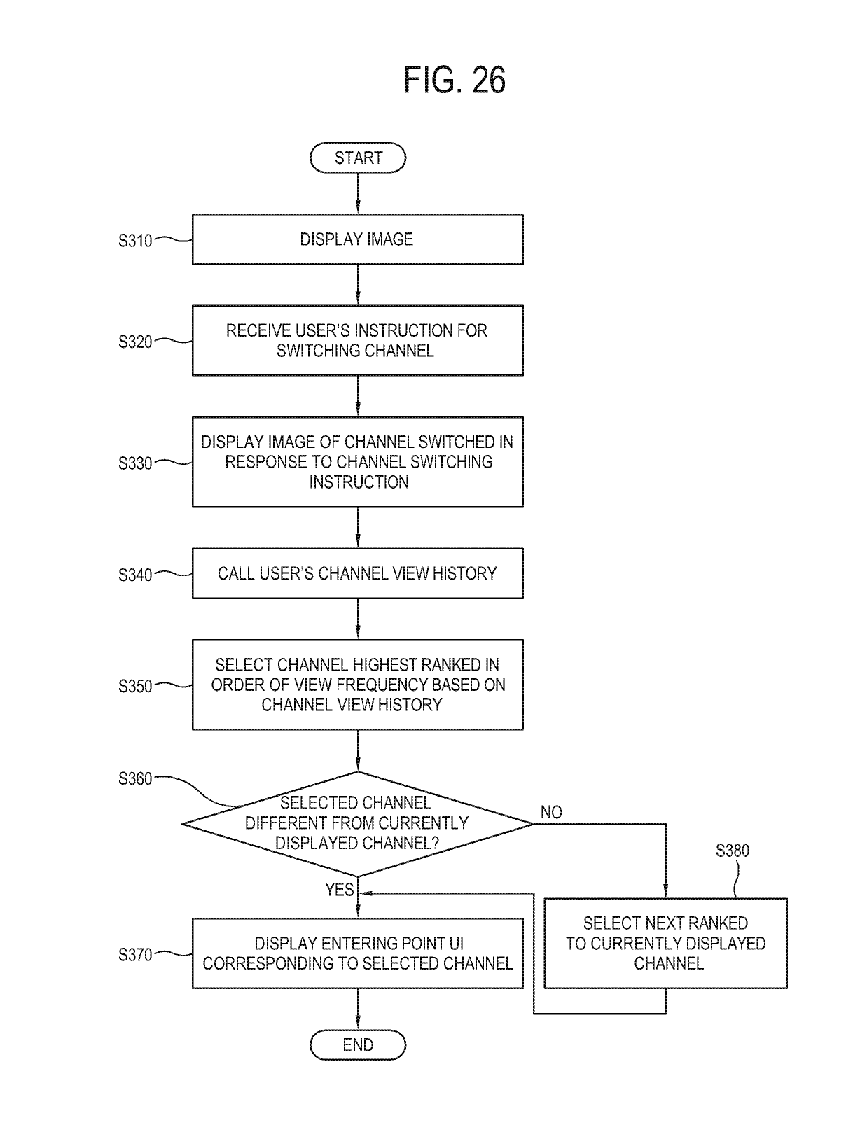

FIG. 26 is a flowchart of selecting a channel to which a display apparatus according to a fourteenth exemplary embodiment switches over for displaying the entering point.

As shown in FIG. 26, at operation S310 the display apparatus displays an image of a channel.

At operation S320 the display apparatus receives an instruction for channel switching from a user.

At operation S330 the display apparatus displays an image of a switched channel in response to the instruction for the channel switching.

At operation S340 the display apparatus calls a user's channel view history of the corresponding display apparatus.

At operation S350 the display apparatus selects the highest ranked channel in order of view frequency, based on the called channel view history.

At operation S360 the display apparatus determines whether the selected channel is different from the currently displayed channel.

If it is determined that the selected channel is different from the currently displayed channel, at operation S370 the display apparatus displays the entering point UI corresponding to the selected channel.

On the other hand, if it is determined that the selected channel is equal to the currently displayed channel, at operation S380 the display apparatus selects the next highest ranked channel to the currently displayed channel and returns to the operation S370.

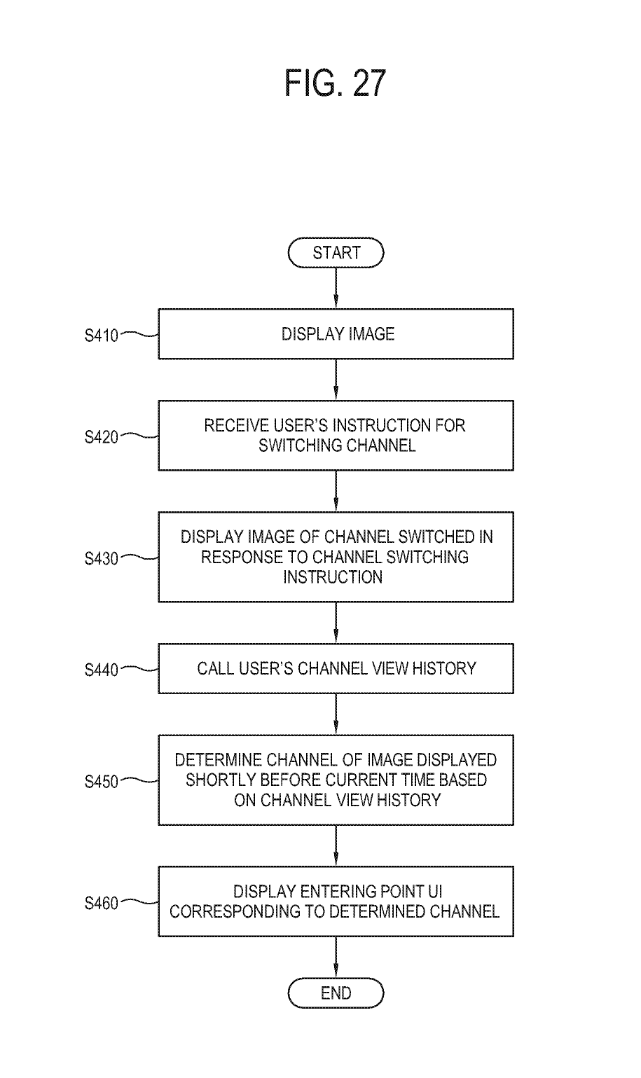

FIG. 27 is a flowchart of selecting a channel to which a display apparatus according to a fifteenth exemplary embodiment switches over for displaying the entering point UI.

As shown in FIG. 27, at operation S410 the display apparatus displays an image of a channel.

At operation S420 the display apparatus receives a channel switching instruction from a user.

At operation S430 the display apparatus displays an image of a switched channel in response to the channel switching instruction.

At operation S440 the display apparatus calls a user's channel view history of the corresponding display apparatus.

At operation S450 the display apparatus determines a channel of an image displayed shortly before the currently displayed image, based on the called channel view history.

At operation S460 the display apparatus displays the entering point UI corresponding to the determined channel.

In the foregoing exemplary embodiment, a user uses the up and down direction buttons or the left and right direction buttons provided on the remote controller as a hardware device for inputting the channel switching instruction, but there are no limits to exemplary embodiments.

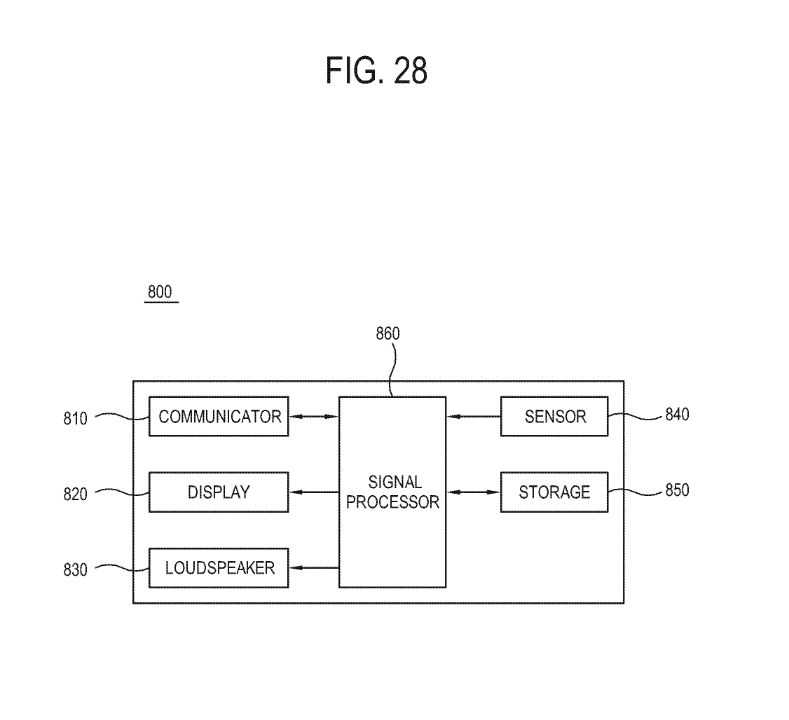

FIG. 28 is a block diagram of a display apparatus 800 according to a sixteenth exemplary embodiment;

As shown in FIG. 28, the display apparatus 800 according to the sixteenth exemplary embodiment includes a communicator 810 for communicating with an exterior, a display 820 for displaying an image based on video data of a transport stream received in the communicator 810, a loudspeaker 830 for outputting a sound based on audio data of the transport stream received in the communicator 810, a sensor 840 for sensing a user's gesture, a storage 850 for storing data, and a signal processor 860 for controlling and computing operations of the display apparatus 800. Here, the basic operations of the communicator 810, the display 820, the loudspeaker 830, the storage 850 and the signal processor 860 except the sensor 840 are the same as those of the foregoing embodiments.

The sensor 840 may be achieved by various kinds of sensors. In this exemplary embodiment, the sensor 840 is achieved by a camera. The sensor 840 photographs a user's motion or gesture for a predetermined period of time, and transmits the photographed image to the signal processor 860. Thus, the signal processor 860 analyzes the photographed image received from the sensor 840, and determines what motion or gesture a user makes in the photographed image as time goes on. To this end, various publicly known technologies may be applied to the structures and operations of the sensor 840 and the signal processor 860.

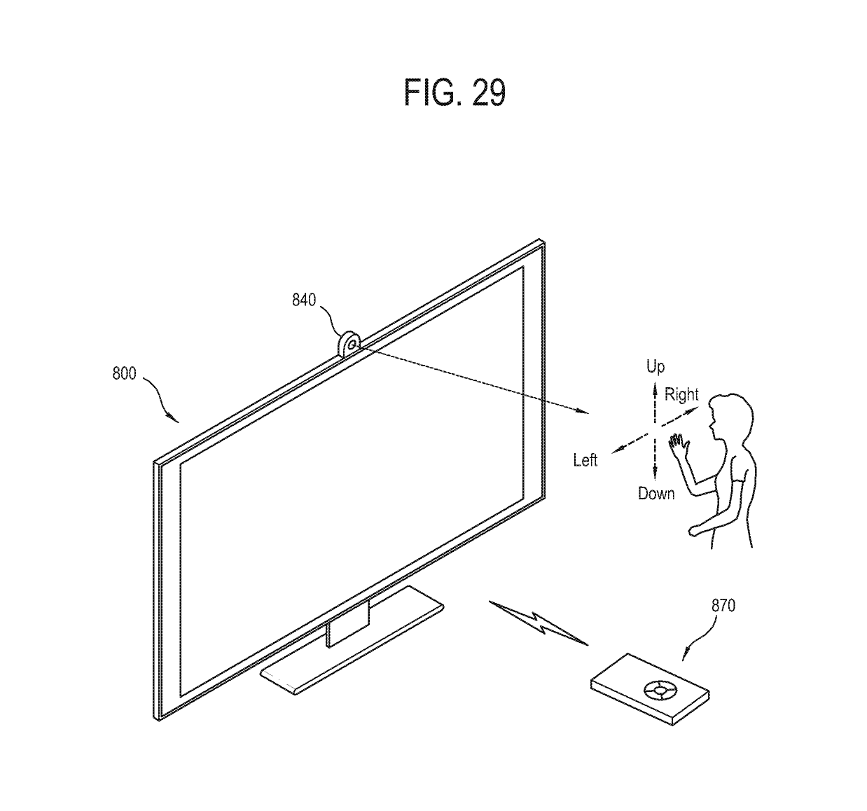

FIG. 29 illustrates that the display apparatus 800 according to the sixteenth exemplary embodiment senses a user's gesture.

As shown in FIG. 29, the sensor 840 of the display apparatus 800 senses a user in front thereof. For example, if a user makes gestures of raising his/her one hand and moving the hand in an up, down, left or right direction, the sensor 840 senses it to determine the direction of a user's gesture.

If a remote controller 870 has the up, down, left and right direction buttons and the up direction button and the down direction button among them are provided for instructing the channel search, the display apparatus 800 determines a user's gesture in the up and down directions sensed by the sensor 840 as inputs corresponding to the up and down direction buttons of the remote controller 870.

Thus, the display apparatus 800 allows a user to make an instruction for the channel search through not only the remote controller 870 but also his/her gesture.

In the foregoing exemplary embodiments, the remote controller is only for the display apparatus. However, the remote controller may be universally used for many apparatuses. If a remote controller is only for an apparatus, such a dedicated remote controller is exclusively used for an apparatus but provides an input environment, such as a button for the function that only the apparatus has, because there is no need of considering functions of other apparatuses. On the other hand, if the remote controller is provided for universal use, such a universal remote controller provides an input environment more limited than that of the dedicated remote controller, but is convenient to control many apparatuses.

Below, an exemplary embodiment of applying the universal remote controller will be described.

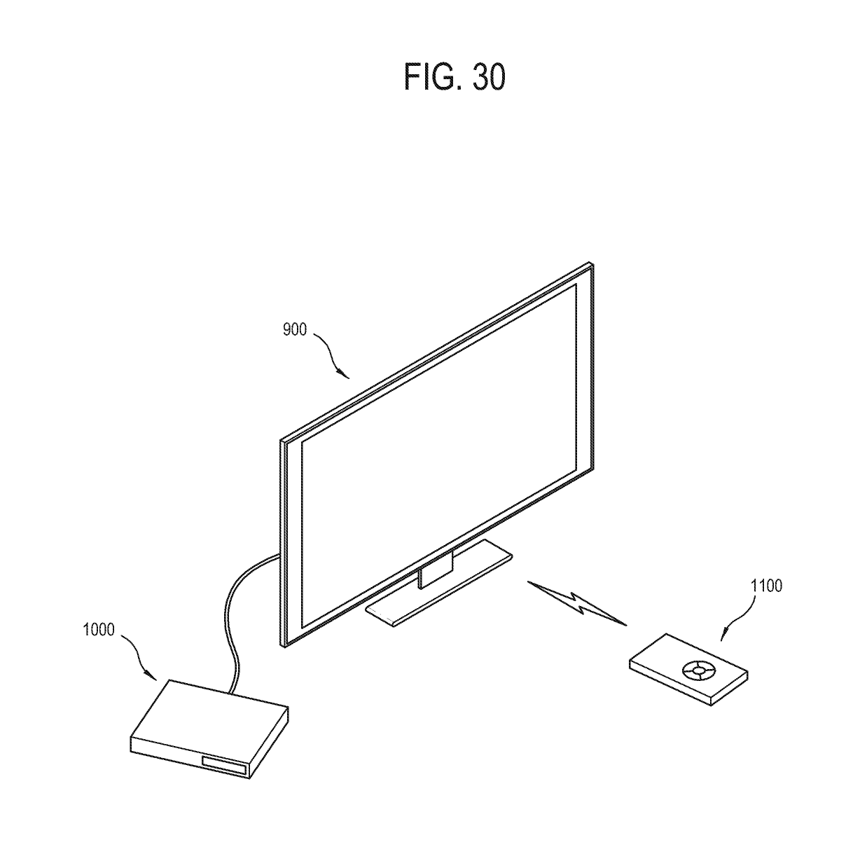

FIG. 30 illustrates a use environment of a display apparatus 900 according to a seventeenth exemplary embodiment.

As shown in FIG. 30, the display apparatus 900 according to the seventeenth exemplary embodiment is locally connected to a set-top box 1000 of providing an image signal. The basic structures and operations of the display apparatus 900 and the set-top box 1000 may be applicable are similar to those of the foregoing exemplary embodiments. The display apparatus 900 may be for example achieved by a TV, and processes content data received from the set-top box 1000, thereby displaying a content image. However, the source from which the display apparatus 900 receives the content data is not limited to only the set-top box 1000. Alternatively, the display apparatus 900 may receive content data from a separate image input source through local connection, a network or an RF antenna.

In this exemplary embodiment, the display apparatus 900 supports a function of setting a multi brand remote (MBR). The MBR set is to support not the dedicated remote controller of the display apparatus 900 but a universal remote controller 1100 or an equivalent input device. If the display apparatus 900 receives information related to the universal remote controller 1100, the display apparatus 900 provides a code set corresponding to an apparatus to the remote controller 1100 so that the remote controller 1100 can control the apparatus. The MBR set of the display apparatus 900 may be activated or inactivated by a user.

A user can control the display apparatus 900 or the set-top box 1000 by manipulating the remote controller 1100. However, if the code set for controlling the operations of the display apparatus 900 or the set-top box 1000 is not first stored in the remote controller 1100, it is difficult for the remote controller 1100 to control operations of the corresponding apparatuses. To control the operations of the display apparatus 900 or the set-top box 1000, the remote controller 1100 has to receive and store the code set from the exterior. Thus, the remote controller 1100 receives a code set for a target apparatus to be controlled from the display apparatus 900, in which the MBR set is activated.

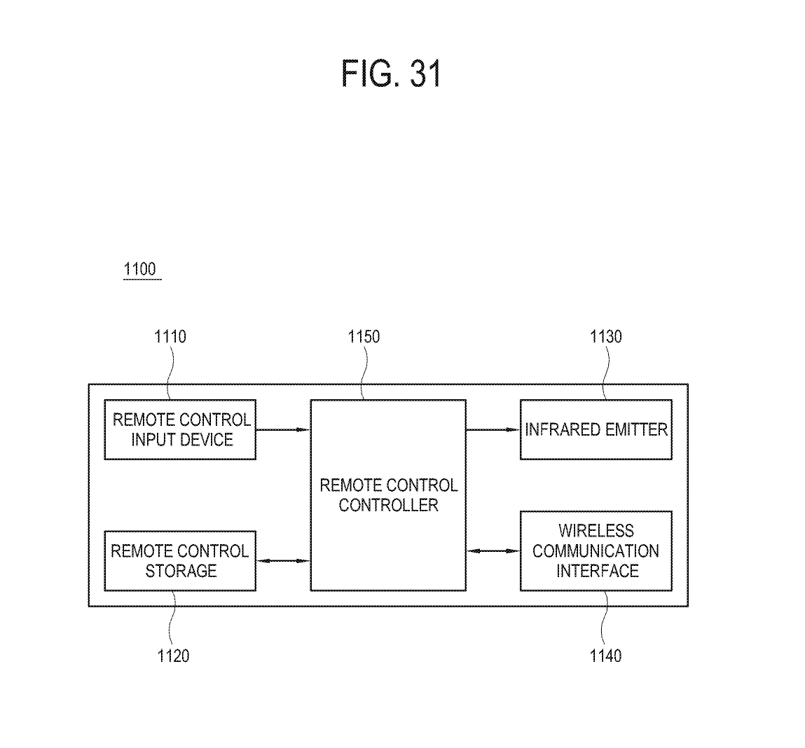

FIG. 31 is a block diagram of the remote controller 1100 according to a seventeenth exemplary embodiment;

As shown in FIG. 31, the remote controller 1100 includes a remote control input device 1110, a remote control storage 1120, an infrared emitter 1130, a wireless communication interface 1140, and a remote control controller 1150 for controlling the remote controller 1100.

The remote control input device 1110 includes a plurality of buttons to be manipulated by a user. For example, the remote control input device 1110 includes the up, down, left and right direction buttons and the enter-button, and may include additional buttons corresponding to supported functions.

The remote control storage 1120 stores a code set if the code set is received from the exterior through the wireless communication interface 1140. The remote control storage 1120 provides the code set when an input is made on the remote control input device 1110, so that the remote control controller 1150 can determine an operation code corresponding to the input.

The infrared emitter 1130 emits an infrared ray corresponding to a control signal generated by the remote control controller 1150. The infrared emitter 1130 does not receive information or a signal from the exterior, that is, supports unidirectional communication for transmitting the control signal to the exterior.

The wireless communication interface 1140 is provided to support bidirectional communication, that is, receives data from the exterior or transmits data from the exterior. The wireless communication interface 1140 may be for example achieved by a Bluetooth interface. The wireless communication interface 1140 can receive data from the exterior, and the wireless communication interface 1140 can transmit more data to the exterior than that of the infrared emitter 1130.

Of course, the wireless communication interface 1140 replaces the infrared emitter 1130 to transmit the control signal. In this case, the remote controller 1100 may exclude the infrared emitter 1130. Nevertheless, the infrared emitter 1130 is used in transmitting a control signal in the form of an infrared ray corresponding to the manipulation of the remote control input device 1110 because the infrared emitter 1130 has a relatively uncomplicated structure and consumes low power, and the wireless communication interface 1140 is used in transmitting and receiving data other than the control signal. The wireless communication interface 1140 may be activated or inactivated by the remote control controller 1150. For example, if the wireless communication interface 1140 is not in use, it is inactivated to reduce power consumption.

If a code set of an apparatus is received in the wireless communication interface 1140, the remote control controller 1150 stores the corresponding code set in the remote control storage 1120. In this case, the remote controller 1100 can control this apparatus with the stored code set in the future. Alternatively, the remote controller 1100 may receive a new code set from the display apparatus 900 whenever the code set is used, without storing the code set in the remote control storage 1120. In event this case, the remote controller 1100 temporarily stores the code set in a buffer or the like while using the code set, and deletes the code set when the code set is not in use. If a plurality of code sets is stored in the remote control storage 1120, the remote control controller 1150 selectively calls one among them. Here, the code set is selected by a user.

When a button of the remote control input device 1110 is manipulated, the remote control controller 1150 searches the code set for the operation code corresponding to the button ID of the button. The remote control controller 1150 generates a control signal corresponding to the searched operation code, and outputs it through the infrared emitter 1130. Thus, the remote controller 1100 can control the operations of the apparatus corresponding to the stored code set.

With this structure, a method of displaying the entering point UI in the display apparatus 900 will be described below.

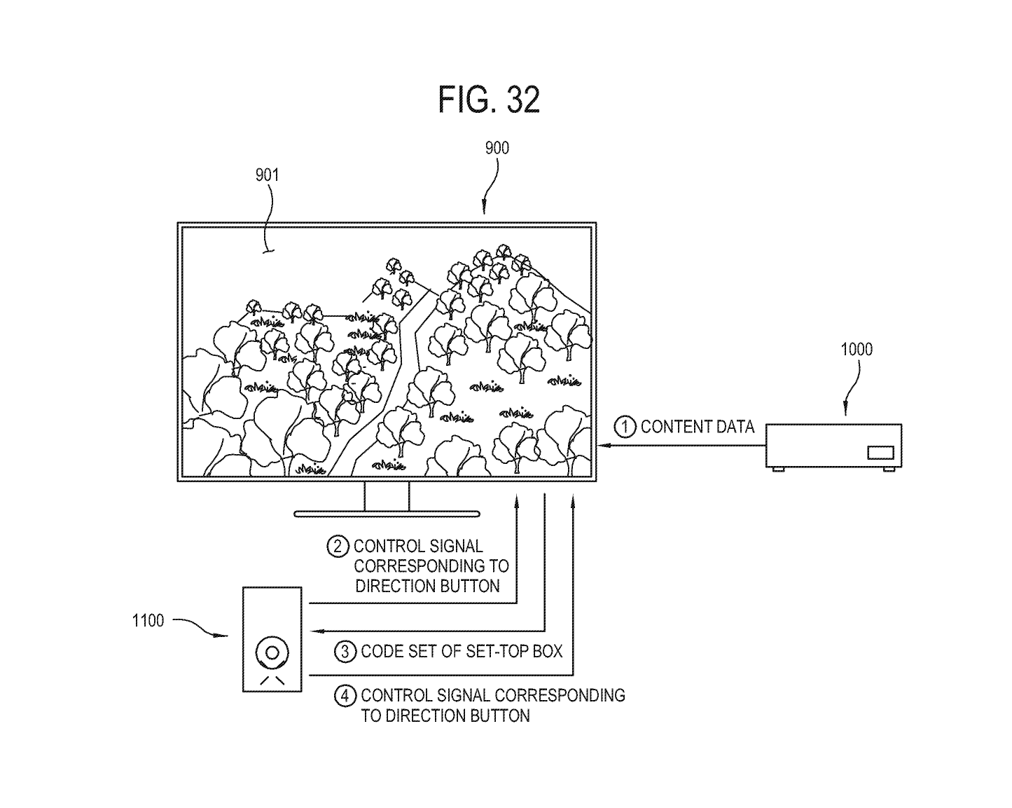

FIG. 32 illustrates that the display apparatus 900 according to the seventeenth exemplary embodiment displays a content image 901.

As shown in FIG. 32, the display apparatus 900 receives content data from the set-top box 1000, and processes the content data to display a content image 901. At this time, the remote controller 1100 does not store any code set.

Under such a condition, suppose that a user presses the direction button of the remote controller 1100 to search channels. In this case, a user may press a direction button by intuitively aiming the remote controller 1100 at the display apparatus 900. The remote controller 1100 can transmit an infrared signal corresponding to a button ID of the direction button pressed by a user to the display apparatus 900 even though it cannot derive an operation code corresponding to the direction button pressed by a user because the remote controller 1100 does not store any code set at this time.

Based on communication standards of a control signal using an infrared ray, the display apparatus 900 is provided to recognize button IDs of buttons if the buttons are fundamentally used in usual apparatuses like the direction button or the enter-button.

The display apparatus 900 determines that the direction button of the remote controller 1100 is pressed, based on the infrared signal received from the remote controller 1100. Here, the direction button pressed by a user is for searching channels, and it is thus determined that a user wants to search channels. Further, the display apparatus 900 may determine that the remote controller 1100 controls the set-top box 1000 to change channels because the content data according to channels is received from the set-top box 1000.

The display apparatus 900 determines whether the MBR set is activated or not. If it is determined that the MBR set is activated, the display apparatus 900 performs the following operations. The display apparatus 900 transmits the code set for the set-top box 1000 to the remote controller 1100 in response to a user's manipulation of pressing the direction button for the channel search on the remote controller 1100. The remote controller 1100 receives and stores the corresponding code set through the wireless communication interface 1140 (see FIG. 31).

Operations of the display apparatus 900 in the case in which the MBR set is not activated will be described later in a separate embodiment.

The display apparatus 900 previously acquires and stores the code set for the set-top box 1000, and thus transmits the code set to the remote controller 1100. The display apparatus 900 may store the code sets for various apparatuses such as the set-top box 1000 when it is manufactured, or may receive and store the code sets from the server.

After the remote controller 1100 stores the code set for the set-top box 1000, the remote controller 1100 can send a control signal to the set-top box 1000. In this state, if a user presses the direction button of the remote controller 1100, the remote controller 1100 transmits a control signal for the channel search corresponding to the direction button to the set-top box 1000.

At this time, the set-top box 1000 provides content data to be displayed as the content image 901 on the display apparatus 900. The set-top box 1000 receives the control signal corresponding to the direction button from the remote controller 1100.

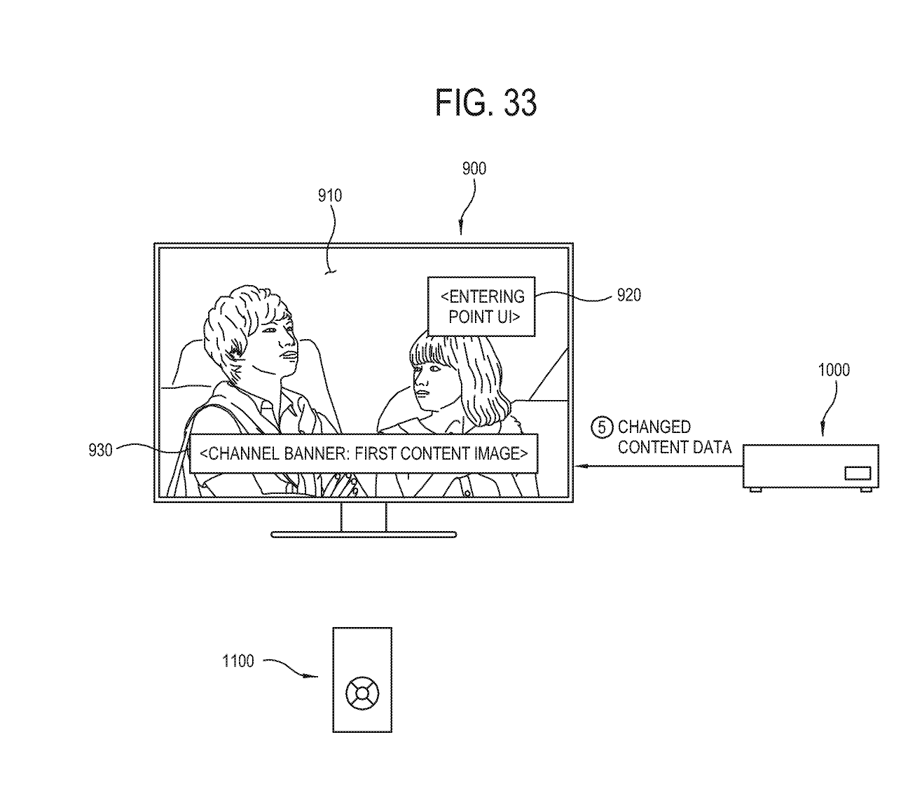

FIG. 33 illustrates that the display apparatus 900 according to the seventeenth exemplary embodiment displays an entering point UI 920. FIG. 33 follows FIG. 32.

As shown in FIG. 33, the set-top box 1000 provides changed content data to the display apparatus 900 in response to the control signal corresponding to the direction button from the remote controller 1100, so that the display apparatus 900 can switch over from the content image 901 (see FIG. 32) to a first content image 910. At this time, the display apparatus 900 displays a channel banner 930 containing information related to the first content image 910 and the entering point UI 920 for switching over to different content on the first content image 910. The descriptions about the entering point UI 920 and the channel banner 930 in this embodiment will be replaced by the descriptions about those in the foregoing exemplary embodiments.

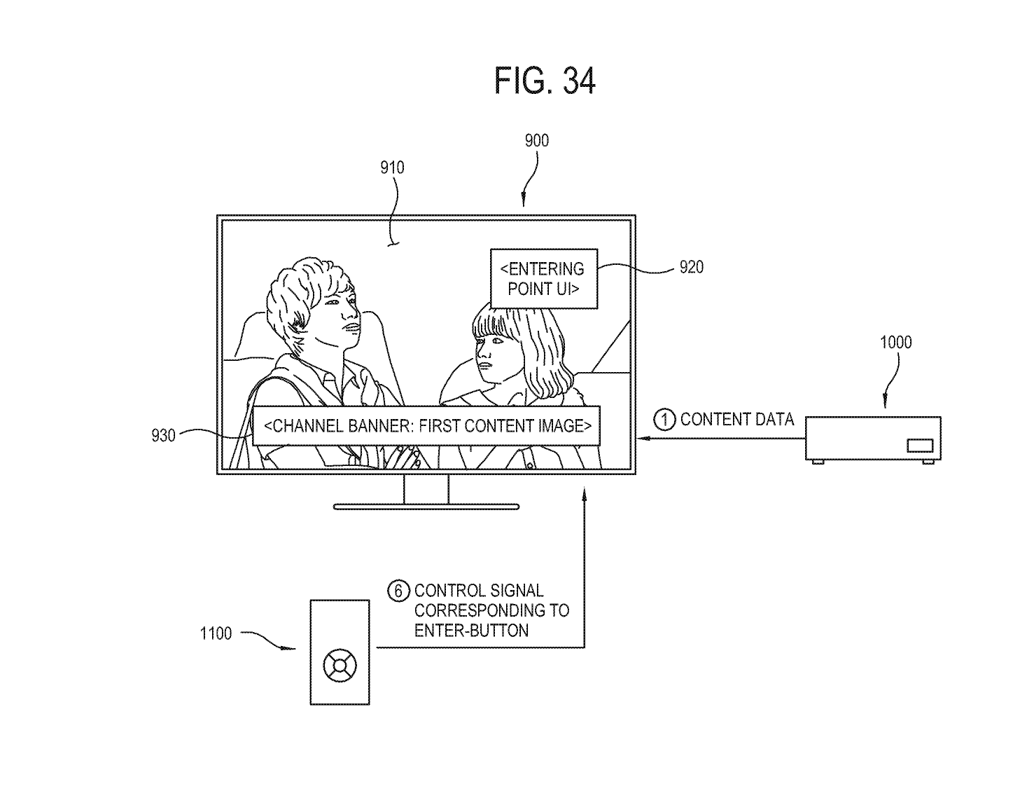

FIG. 34 illustrates that the entering point UI 920 displayed on the display apparatus 900 according to the seventeenth exemplary embodiment is clicked. FIG. 34 follows FIG. 33.

As shown in FIG. 34, a user may press the enter-button on the remote controller 1100 to select the entering point UI 920 while the display apparatus 900 is displaying the entering point UI 920. The remote controller 1100 transmits a control signal corresponding to the enter-button to the display apparatus 900.

When the MBR set is activated in the display apparatus 900, the display apparatus 900 does not transmit the code set to the remote controller 1100 even though the MBR set is activated, because the control signal corresponding to the enter-button is received while the entering point UI 920 is being displayed.

Instead, the display apparatus 900 determines that the control signal received from the remote controller 1100 corresponds to the enter-button, and switches over from the currently displayed first content image 910 to an image of content directed by the entering point UI 920 in response to an instruction of the control signal.

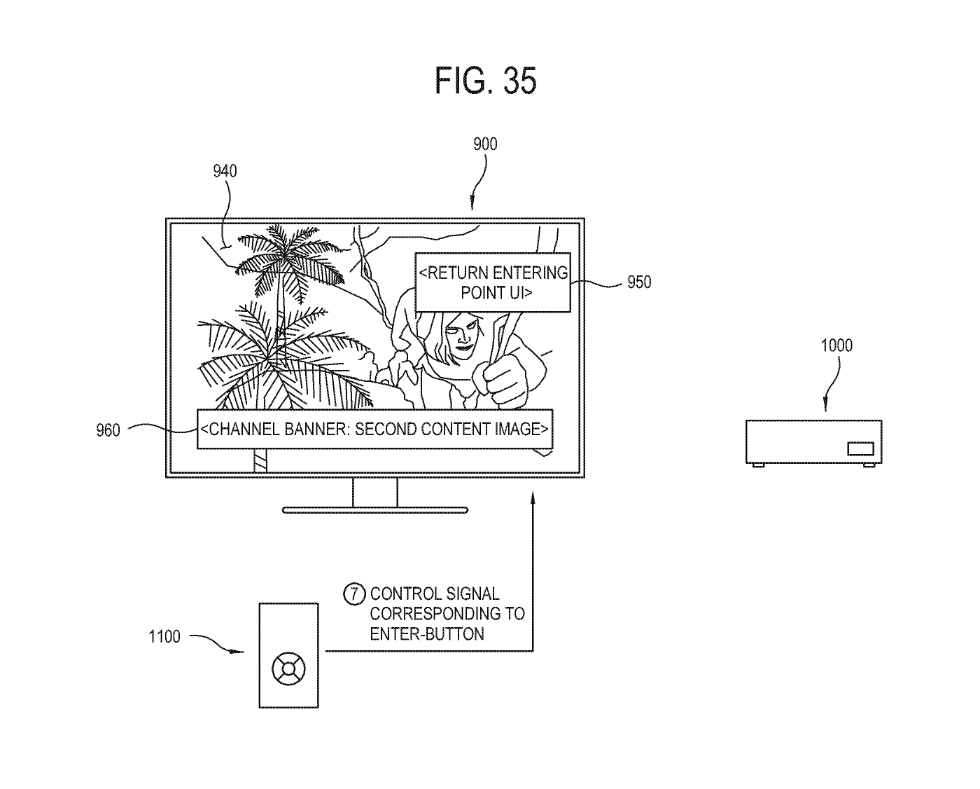

FIG. 35 illustrates that the display apparatus 900 according to the seventeenth exemplary embodiment switches over to the second content image. FIG. 35 follows FIG. 34.

As shown in FIG. 35, the display apparatus 900 determines the content assigned corresponding to the entering point UI 920 (see FIG. 34) and processes this content to thereby switch over from the first content image 910 (see FIG. 34) to a second content image 940, in response to the control signal corresponding to the enter-button from the remote controller 1100. If an image input source providing content corresponding to the second content image 940 is not the set-top box 1000, the display apparatus 900 receives content data for the second content image 940 from the corresponding image input source instead of receiving the content data from the set-top box 1000.

The display apparatus 900 displays a return entering point UI 950 and a channel banner 960 on the second content image 940. The return entering point UI 950 is a UI for switching over to the content of the first content image 910 (see FIG. 34) to return to the first content image 910 (see FIG. 34) displayed shortly before the currently displayed second content image 940. The channel banner 960 has information related to the second content image 940.

In this state, if there are no inputs from the remote controller 1100 for a preset period of time, the display apparatus 900 stops displaying the return entering point UI 950 and the channel banner 960 and displays only the second content image 940.

The display apparatus 900 may receive the control signal corresponding to the enter-button from the remote controller 1100 if a user presses the enter-button of the remote controller 1100 while the return entering point UI 950 is being displayed.

The display apparatus 900 determines that the control signal received from the remote controller 1100 corresponds to the enter-button, and switches over from the currently displayed second content image 940 to the first content image of the return entering point UI 950 in response to an instruction of the control signal.

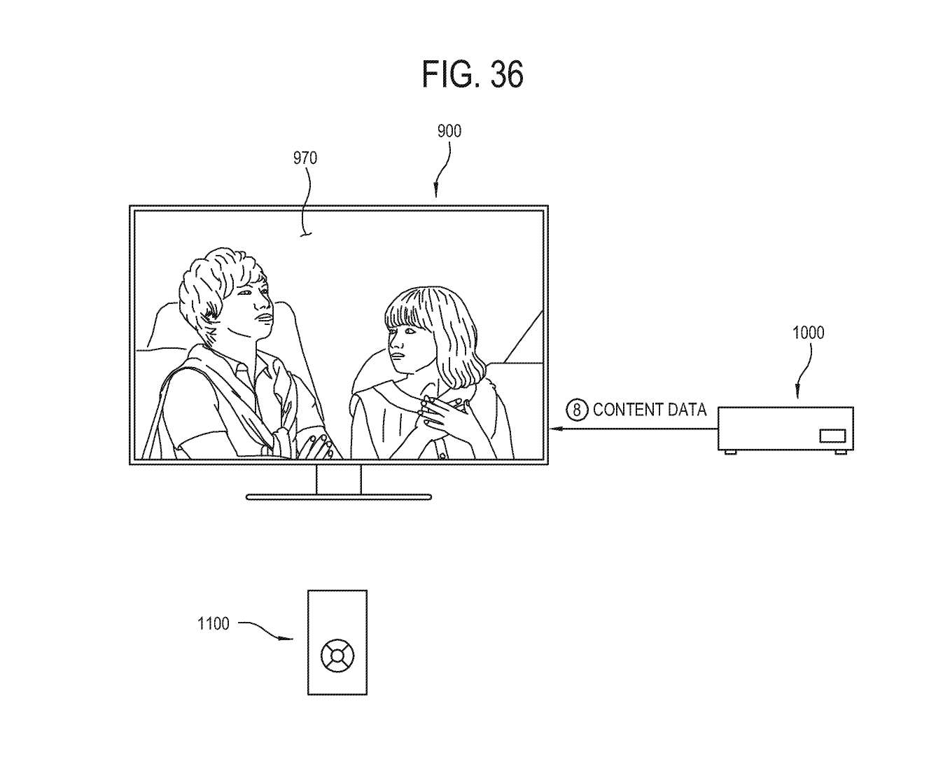

FIG. 36 illustrates that the display apparatus 900 according to the seventeenth exemplary embodiment returns to a first content image 970. FIG. 36 follows FIG. 35.

As shown in FIG. 36, the display apparatus 900 executes an operation corresponding to the return entering point UI 950 (see FIG. 35) in response to a control signal corresponding to the enter-button from the remote controller 1100. That is, the display apparatus 900 receives the content data of the first content image 970 from the set-top box 1000 to switch over from the second content image 940 (see FIG. 35) to the first content image 970. Further, the display apparatus 900 displays the first content image 970.

Like this, the display apparatus 900 according to this exemplary embodiment allows a user to use the universal remote controller 1100 to switch the content through the entering point UI.

Below, processes performed in the display apparatus 900, the set-top box 1000 and the remote controller 1100 according to an exemplary embodiment will be described.

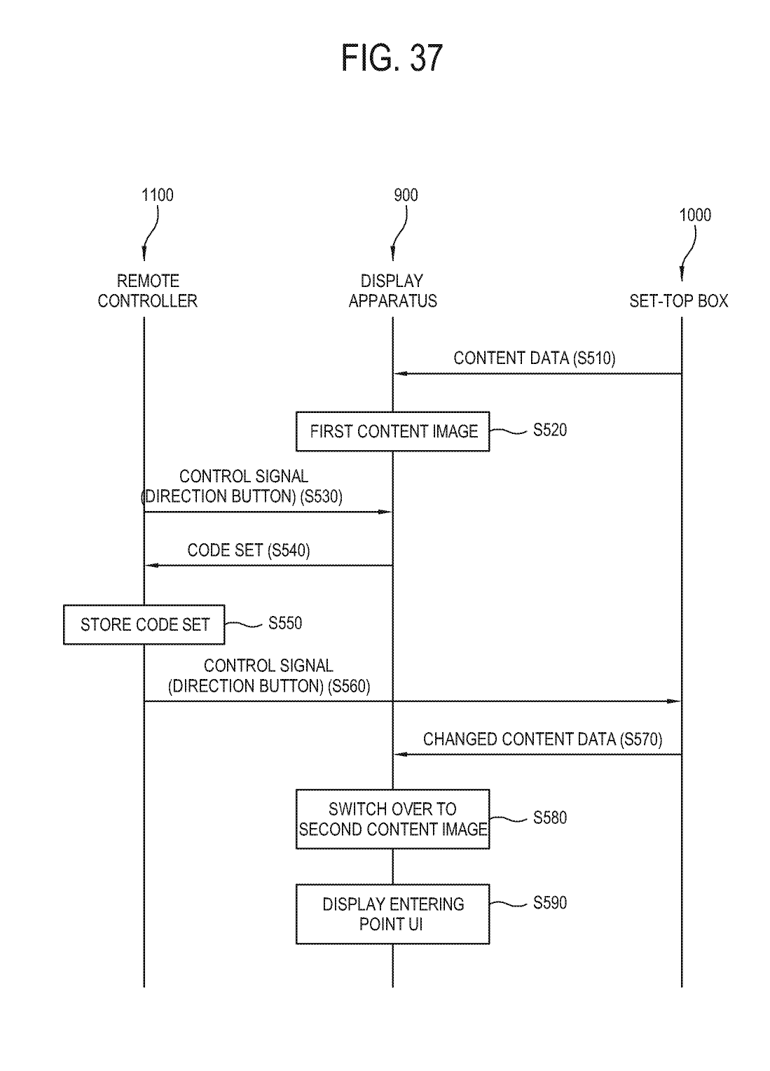

FIG. 37 illustrates a signal flow while the display apparatus 900 according to the seventeenth exemplary embodiment displays the entering point UI. In this exemplary embodiment, the MBR set is being activated in the display apparatus 900.

As shown in FIG. 37, at operation S510 the set-top box 1000 transmits content data to the display apparatus 900. At operation S520 the display apparatus 900 processes the content data and displays a first content image.

At operation S530 the remote controller 1100 transmits a control signal corresponding to the direction button to the display apparatus 900. At operation S540 the display apparatus 900 gives the code set for controlling the set-top box 1000 to the remote controller 1100 in response to the control signal. At operation S550 the remote controller 1100 stores the code set received from the display apparatus 900.

At operation S560 the remote controller 1100 sends the set-top box 1000 the control signal corresponding to the direction button.

At operation S570 the set-top box 1000 sends the display apparatus 900 the content data changed in response to the control signal. At operation S580 the display apparatus 900 displays a second content image based on the received content data. Further, at operation S590 the display apparatus 900 displays the entering point UI on the second content image.

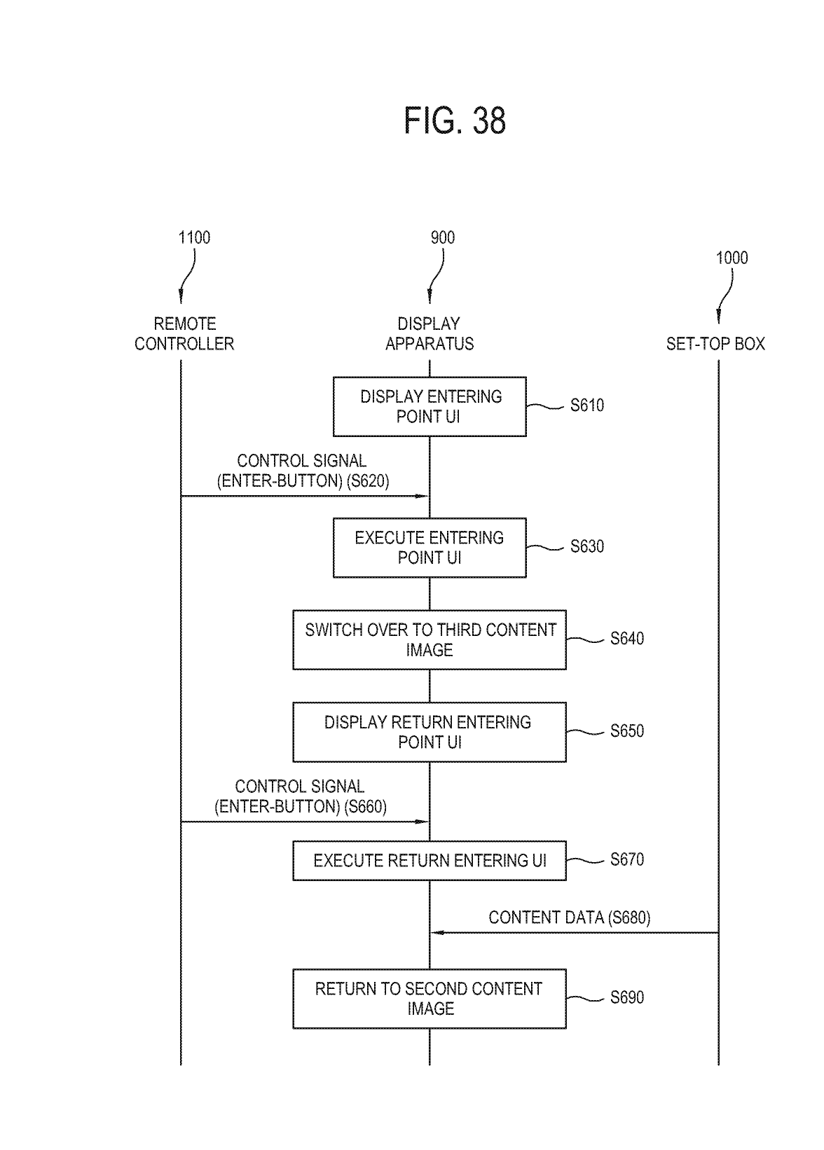

FIG. 38 illustrates a signal flow while content is switched over and displayed in the display apparatus 900 according to the seventeenth exemplary embodiment in response to execution of the entering point UI. FIG. 38 follows FIG. 37.

As shown in FIG. 38, at operation S610 the display apparatus 900 displays the entering point UI.

At operation S620 the remote controller 1100 sends the display apparatus 900 the control signal corresponding to the enter-button. At operation S630 the display apparatus 900 executes the entering point UI in response to the control signal.

At operation S640 the display apparatus 900 switches over from the second content image to a third content image directed by the entering point UI.

At operation S650 the display apparatus 900 displays the return entering point UI for returning to the second content image.

At operation S660 if the remote controller 1100 sends the display apparatus 900 the control signal corresponding to the enter-button, at operation S670 the display apparatus 900 executes the return entering point UI.

At operation S680 the display apparatus 900 receives the content data of the second content image from the set-top box 1000. At operation S690 the display apparatus 900 returns from the third content image to the second content image.

The foregoing exemplary embodiments are related to the case in which the MBR set is activated in the display apparatus 900. Below, embodiments of when the MBR set is not activated in the display apparatus 900 will be described.

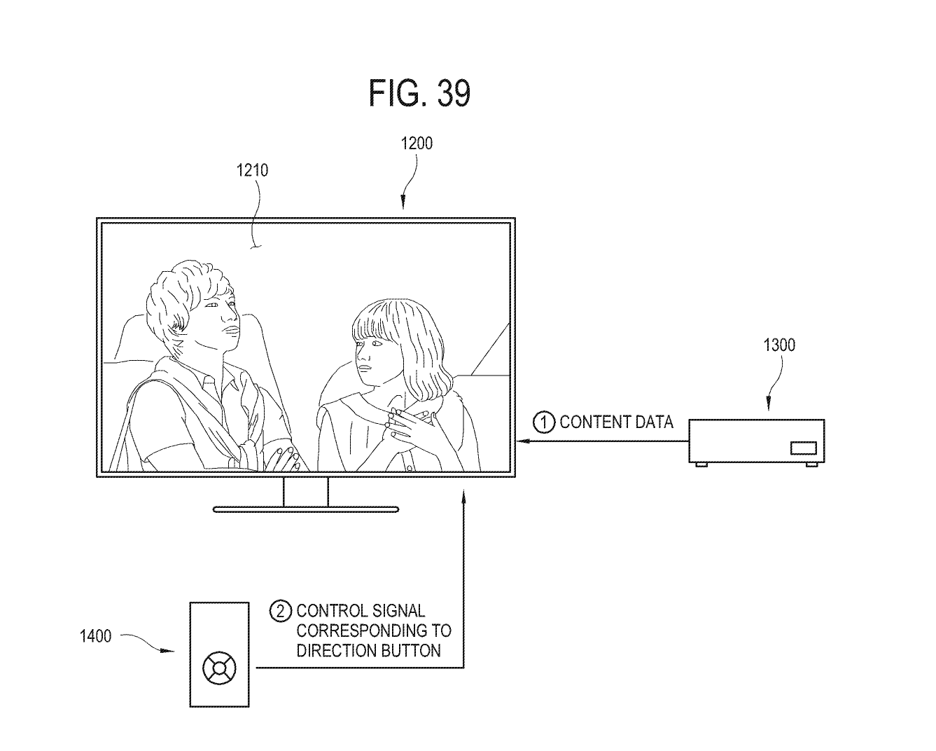

FIG. 39 illustrates that a display apparatus 1200 according to an eighteenth exemplary embodiment displays a first content image 1210.

As shown in FIG. 39, the display apparatus 1200 receives content data from a set-top box 1300 and processes the content data to display the first content image 1210. At this time, a remote controller 1400 does not store any code set.

Under such a condition, a user presses the direction button of the remote controller 1100 to search channels. The remote controller 1400 can transmit an infrared signal corresponding to a button ID of the direction button pressed by a user to the display apparatus 1200 even though it cannot derive an operation code corresponding to the direction button pressed by a user because the remote controller 1400 does not store any code set at this time.

Based on communication standards of a control signal using an infrared ray, the display apparatus 1200 is provided to recognize button IDs of buttons if the buttons are fundamentally used in usual apparatuses like the direction button or the enter-button.

The display apparatus 1200 determines whether the MBR set is activated or not. If it is determined that the MBR set is not activated, the display apparatus 1200 does not send the code set of the set-top box 1300 to the remote controller 1400.

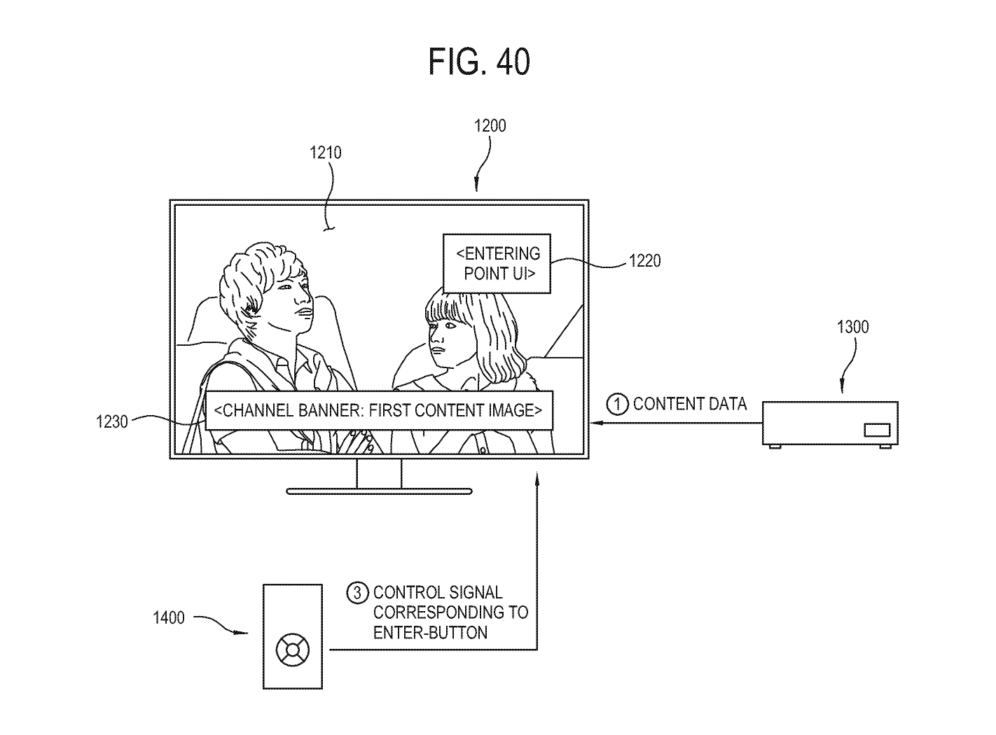

FIG. 40 illustrates that the display apparatus 1200 according to the eighteenth exemplary embodiment displays an entering point UI 1220. FIG. 40 follows FIG. 39.

As shown in FIG. 40, the display apparatus 1200 displays the entering point UI 1220 and a channel banner 1230 on the first content image 1210 in response to the control signal corresponding to the direction button from the remote controller 1400. The descriptions about the entering point UI 1220 and the channel banner 1230 in this embodiment will be replaced by the descriptions about those in the foregoing exemplary embodiments.

As mentioned above, the remote controller 1400 cannot control operations of the set-top box 1300 because it does not receive the code set of the set-top box 1300 from the display apparatus 1200. However, the display apparatus 1200 displays the entering point UI 1220 in response to the control signal because it can recognize the control signal corresponding to the direction button of the remote controller 1400.

If there are no user's inputs for a preset period of time while the entering point UI 1220 is displayed, the display apparatus 1200 displays only the first content image 1210 by deleting the entering point UI 1220 and the channel banner 1230.

On the other hand, if a user presses the enter-button of the remote controller 1400 while the entering point UI 1220 is being displayed, the display apparatus 1200 receives a control signal corresponding to the enter-button from the remote controller 1400. The display apparatus 1200 checks that the MBR set is inactivated, and does not send the remote controller 1400 the code set. The display apparatus 1200 just executes the entering point UI 1220 in response to the control signal.

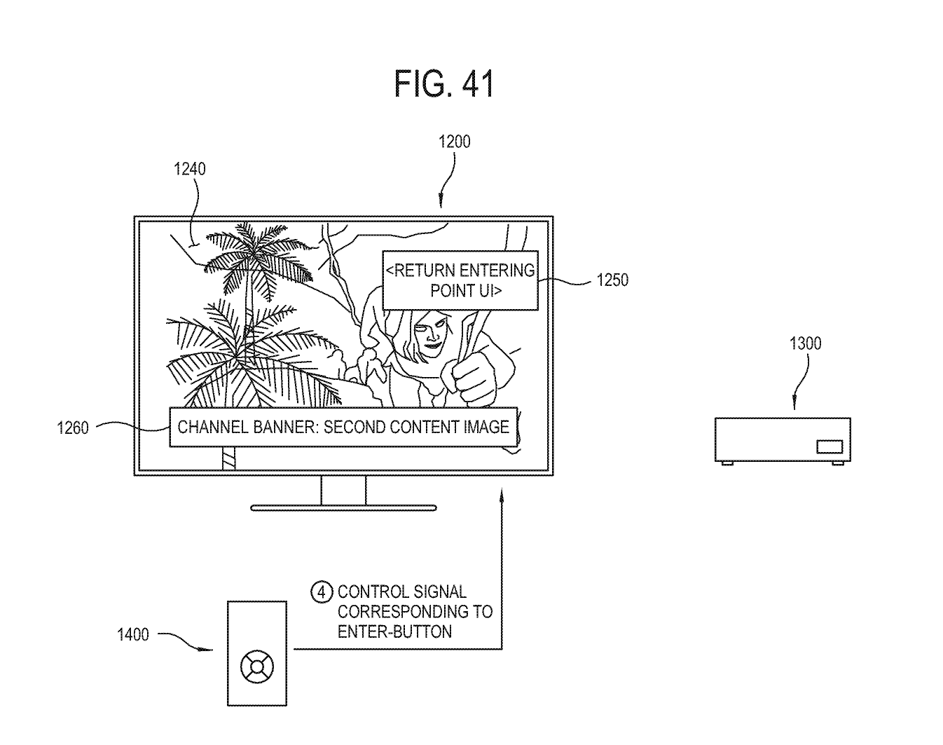

FIG. 41 illustrates that the display apparatus 1200 according to the eighteenth exemplary embodiment switches over to a second content image 1240. FIG. 41 follows FIG. 40.

As shown in FIG. 41, the display apparatus 1200 determines the content assigned corresponding to the entering point UI 1220 (see FIG. 40) and processes this content to thereby switch over from the first content image 1210 (see FIG. 40) to a second content image 1240, in response to the control signal corresponding to the enter-button from the remote controller 1400. If an image input source providing content corresponding to the second content image 1240 is not the set-top box 1300, the display apparatus 1200 receives content data for the second content image 1240 from the corresponding image input source instead of receiving the content data from the set-top box 1300.

The display apparatus 1200 displays a return entering point UI 1250 and a channel banner 1260 on the second content image 1240. The return entering point UI 1250 is provided for switching over to the content of the first content image 1210 (see FIG. 40) to return to the first content image 1210 (see FIG. 40) displayed shortly before the currently displayed second content image 1240.

In this state, if there are no inputs from the remote controller 1400 for a preset period of time, the display apparatus 1200 stops displaying the return entering point UI 1250 and the channel banner 1260 and displays only the second content image 1240.

The display apparatus 1200 may receive the control signal corresponding to the enter-button from the remote controller 1400 if a user presses the enter-button of the remote controller 1400 while the return entering point UI 1250 is being displayed.

In response to this control signal, the display apparatus 1200 determines whether the MBR set is activated or not. Because the MBR set is not activated, the display apparatus 1200 does not transmit the code set to the remote controller 1400. However, the display apparatus can recognize the control signal corresponding to the enter-button and thus execute the return entering point UI 1250.

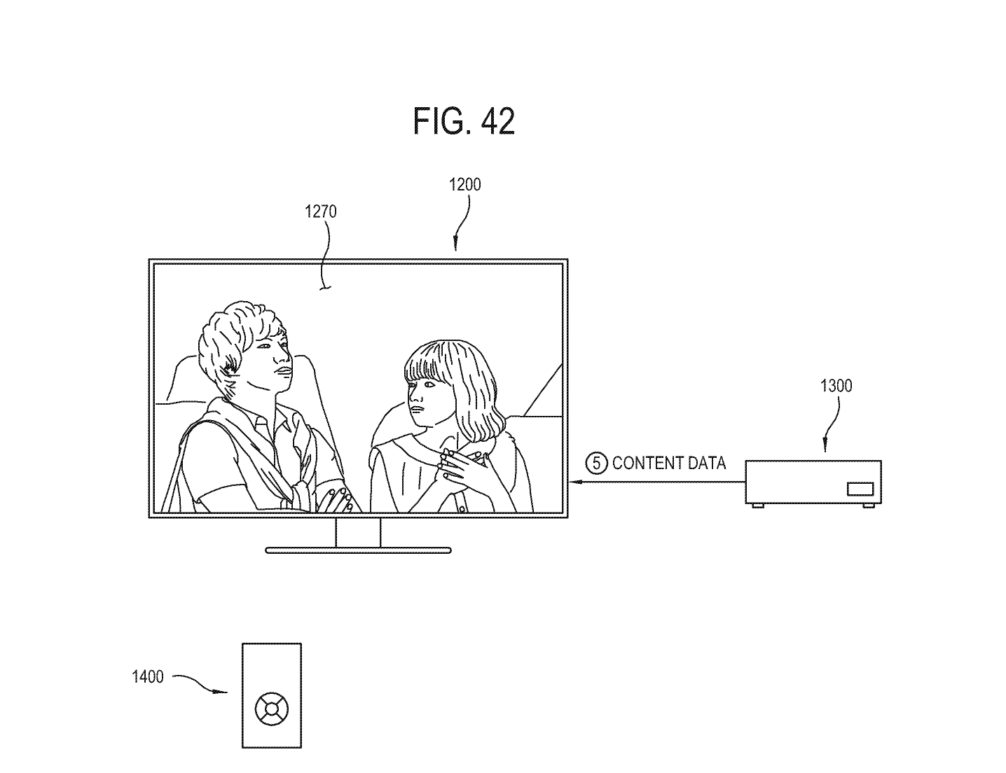

FIG. 42 illustrates that the display apparatus 1200 according to the eighteenth exemplary embodiment returns to a first content image 1270. FIG. 42 follows FIG. 41.

As shown in FIG. 42, the display apparatus 1200 executes an operation corresponding to the return entering point UI 1250 (see FIG. 41) in response to a control signal corresponding to the enter-button from the remote controller 1400. That is, the display apparatus 1200 receives the content data of the first content image 1270 from the set-top box 1000 to switch over from the second content image 1240 (see FIG. 41) to the first content image 1270. Further, the display apparatus 1200 displays the first content image 1270.

Like this, the display apparatus 1200 according to this exemplary embodiment allows a user to use the universal remote controller 1400 to switch the content through the entering point UI.

Below, processes performed in the display apparatus 1200, the set-top box 1300 and the remote controller 1400 according to an exemplary embodiment will be described.

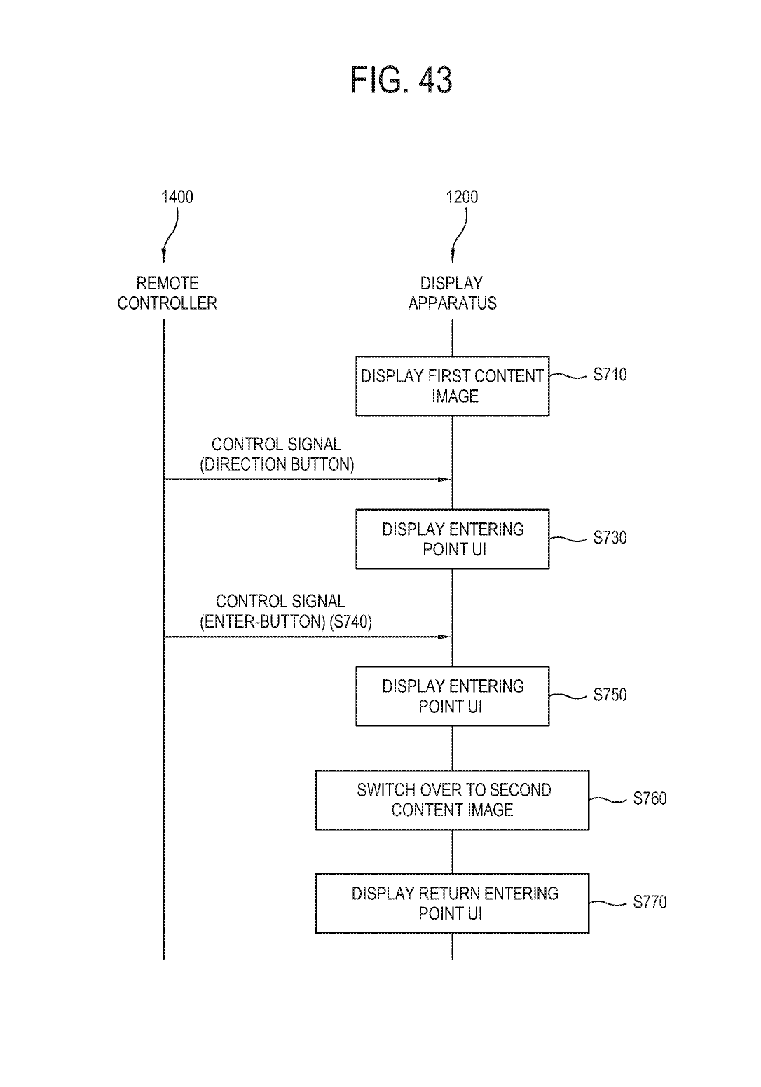

FIG. 43 illustrates a signal flow between the remote controller 1400 and the display apparatus 1200 according to the eighteenth exemplary embodiment. In this exemplary embodiment, the MBR set is being not activated in the display apparatus 1200.

As shown in FIG. 43, at operation S710 the display apparatus 1200 displays the first content image.

At operation S720 the remote controller 1400 transmits a control signal corresponding to the direction button to the display apparatus 1200. At operation S730 the display apparatus 1200 displays the entering point UI in response to the control signal.

At operation S740 the remote controller 1400 sends the display apparatus 1200 the control signal corresponding to the enter-button. At operation S750 the display apparatus 1200 executes the entering point UI in response to the control signal.

At operation S760 the display apparatus 1200 switches over from the first content image to the second content image directed by the entering point UI.

At operation S770 the display apparatus 1200 displays the return entering point UI for returning to the first content image.

As described in the foregoing exemplary embodiments, the plurality of image input sources may each provide the content data to the display apparatus, and the content data provided by each image input source may include a plurality of channels respectively corresponding to individual pieces of the content. Therefore, it may be not easy for a user who uses the display apparatus to distinguish among many image input sources and further distinguish among a plurality of channels within each image input source.

For example, the display apparatus may receive a broadcast signal, in which channels are assigned corresponding to frequencies, from a transmitter of a broadcasting station through a radio frequency (RF) antenna or a cable. In addition, the display apparatus may receive various kinds of content such as a streaming service based on Internet protocol, a web service, a game service, a social network service, etc.

The pieces of content based on Internet protocol are not respectively assigned with channel numbers. As an example of these pieces of content, there are IP streaming, an application, a web page, etc. Therefore, it is difficult to make these pieces of contents into a channel list on the contrary to the channels of the broadcast signal, and it is also not easy for a user to manage them. Accordingly, a service in which the channel numbers are assigned to the pieces of content provided based on Internet protocol is used so that a user can have access to content and directly view the content as if s/he deals with an electronic program guide (EPG), a channel list, channel up/down, a channel number input, etc. for broadcast channels, and this service will be called a virtual channel service.

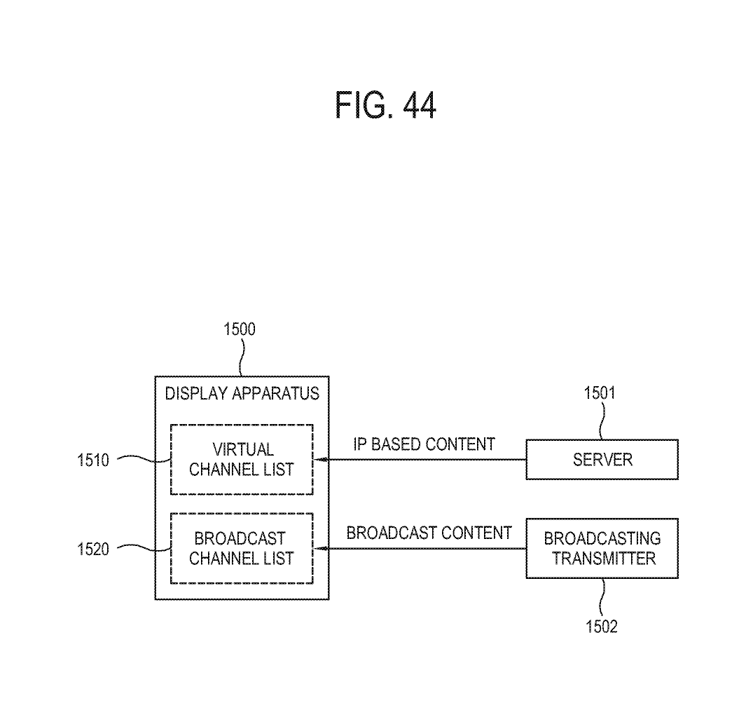

FIG. 44 is a block diagram showing a principle of making a channel list based on content received in a display apparatus 1500 according to a nineteenth exemplary embodiment.

As shown in FIG. 44, the display apparatus 1500 according to the nineteenth exemplary embodiment can receive IP based content from at least one server 1501, and also receive broadcast content from a broadcasting transmitter 1502 of a broadcasting station. The IP based content is provided to the display apparatus 1500 in the form of a data packet through IP-based broadband network communication. The broadcasting content may be provided to the display apparatus 1500 in the form of a data packet or an analog signal in which frequencies are respectively assigned to channels.

The virtual channel service virtually assigns a channel number to content received based on an Internet protocol under an environment of the content received in the display apparatus 1500, and makes and manages a list of the assigned content. Therefore, a virtual channel list 1510 is analogous to a broadcast channel list 1520.

The broadcast channel list 1520 may be extracted from the broadcast signal transmitted from the broadcasting transmitter 1502 or may be provided as the EPG from a separate server. However, the virtual channel list 1510 may be made in each display apparatus 1500 because the display apparatuses 1500 are different in the environment of receiving the content from one another in the case of the IP based content. Alternatively, a separate management server may receive information, which is related to an environment for receiving the IP based content, from the display apparatus 1500, and provide the virtual channel service customized for the display apparatus 1500.

The display apparatus 1500 may selectively use one among the virtual channel list 1510 and the broadcast channel list 1520. Here, content directed by the channel number of the virtual channel list 1510 is different from content directed by the channel number of the broadcast channel list 1520. Therefore, the display apparatus 1500 selects either of a mode for using the virtual channel list 1510 or a mode for using the broadcast channel list 1520, and uses only the list corresponding to the selected mode while it operates in the selected mode.

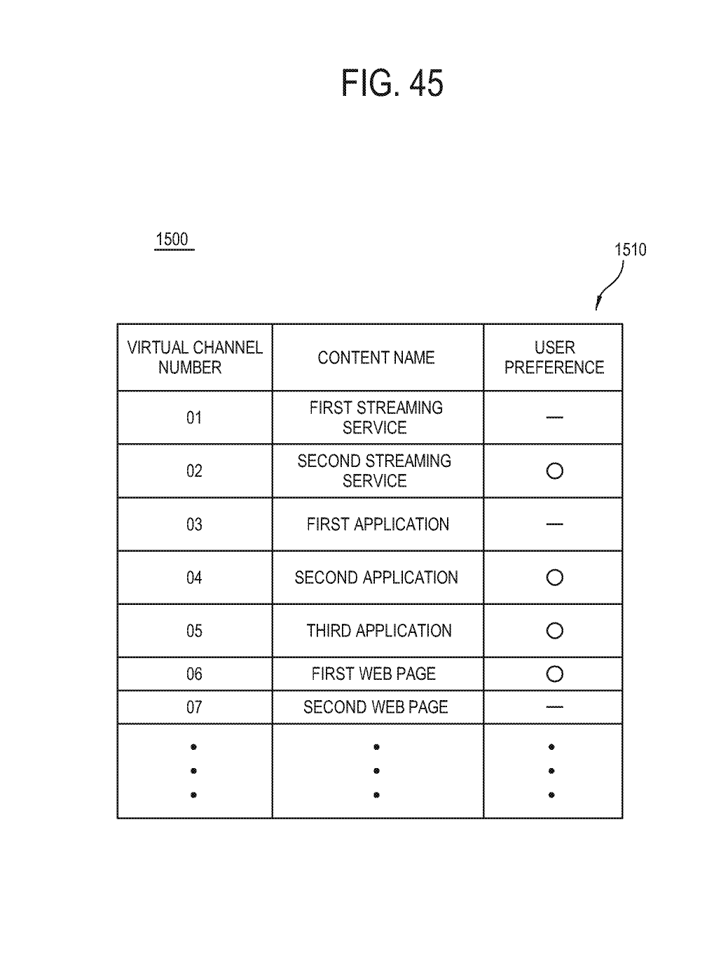

FIG. 45 illustrates a virtual channel list of the display apparatus 1500 according to the nineteenth exemplary embodiment.

As shown in FIG. 45, the display apparatus 1500 makes the virtual channel list 1510 by respectively assigning the channel numbers to many kinds of IP based content. Of course, the content directed by the channel number of the virtual channel list 1510 is different from the content directed by the channel number of the broadcast channel list 1520 (see FIG. 44).

When the channel numbers are assigned to content, the display apparatus 1500 may give priority to content in accordance with the kinds or attributes of content. For example, the display apparatus 1500 may assign the channel numbers in order of an IP streaming service, an application and a website. That is, if many streaming services, applications and webpages are provided to the display apparatus 1500, the display apparatus 1500 may assign a channel number to the streaming services, then assigns a channel number to the applications, and lastly assigns a channel number to the webpage.

For example, the display apparatus 1500 respectively assigns virtual channel numbers of ‘1’ and ‘2’ to a first streaming service and a second streaming service. Then, the display apparatus 1500 respectively assigns the next virtual channel numbers of ‘3’, ‘4’ and ‘5’ to a first application, a second application and a third application. Last, the display apparatus 1500 respectively assigns the next virtual channel numbers of ‘6’ and ‘7’ to a first webpage and a second webpage.

Like the broadcast channel list 1520 (see FIG. 44), the virtual channel list 1510 is prevented from being discretionally modified by a user. However, the display apparatus 1500 may allow a user to make an additional list in which a user's favorite content is separately managed among the pieces of contents corresponding to the channels of the virtual channel list 1510. For example, if a user prefers the content corresponding to the channel numbers of ‘2’, ‘4’, ‘5’ and ‘6’ in the virtual channel list 1510, the display apparatus 1500 may make a favorite channel list including only these channels and provide it to a user. By the way, the virtual channels may not belong to modifiable channels in some European countries or the like area where a user is allowed to discretionally modify the channel number and order.

Below, some operations of the display apparatus 1500 will be described in connection with the virtual channel service.

If system power is turned off on the way of the virtual channel service, the display apparatus 1500 executes the virtual channel service when the system power is turned on next.

If the virtual channel is scheduled for view, it is possible with regard to only a real-time streaming (RTS) type channel or program.

The display apparatus 1500 may support or not support a picture-in-picture (PIP) function and a multi-link screen (MLS) function with regard to the virtual channel service. Both the PIP function and the MLS function are to display two or more content images at the same time. The PIP function refers to that a main image is displayed on a full screen and a sub image is displayed small within the main image. The MLS function refers to that the full screen is divided into two or more regions and images are respectively displayed on the divided regions.

If the virtual channel service does not support the PIP function and the MLS function, the display apparatus 1500 may display a message for informing that the view of the virtual channel is not allowed when it enters a PIP mode or an MLS mode. For example, if the display apparatus 1500 enters the MLS mode while displaying the virtual channel, a banner of informing that the MLS mode is not supported is displayed. Alternatively, if the display apparatus 1500 is tuned to a virtual channel after entering the MLS mode while displaying an RF channel, the display apparatus 1500 displays the banner of informing that the MLS mode is not supported at time when it is tuned to the virtual channel.

By the way, if a user clicks a channel assigned to the application within the virtual channel list 1510, the display apparatus 1500 executes the application of the corresponding channel. Here, the application may be divided into a full app. and a lightweight App. (LWA).

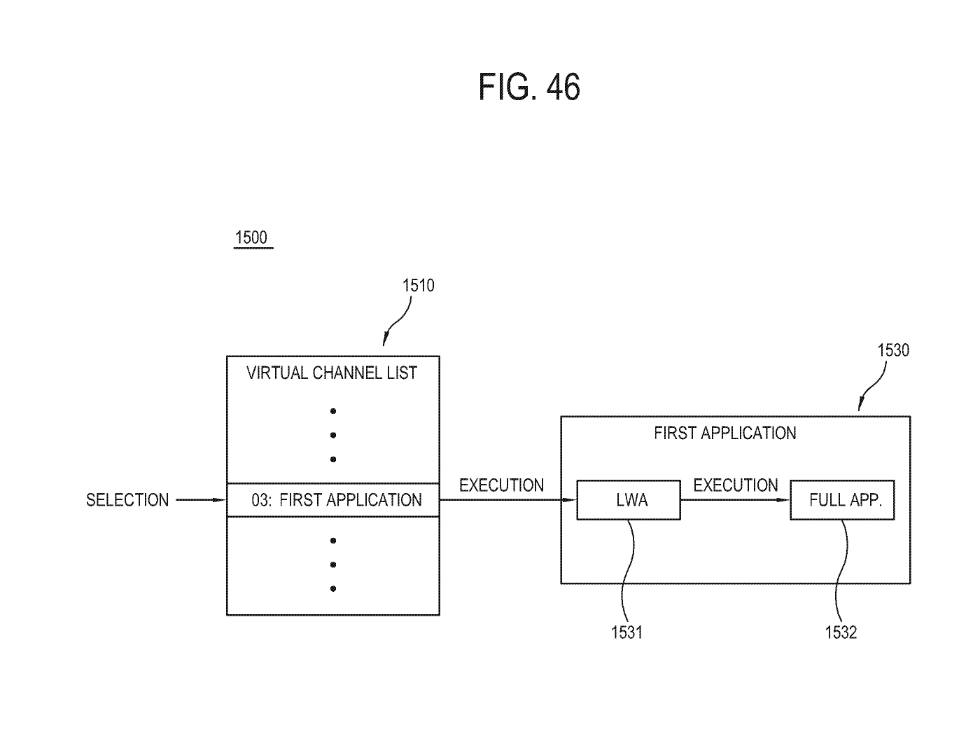

FIG. 46 is a block diagram showing a structure of an application to be executed in a display apparatus 1500 according to a twentieth exemplary embodiment.

As shown in FIG. 46, the display apparatus 1500 displays the virtual channel list 1510 so that a user can select a virtual channel. Suppose that a user selects a channel of ‘3’ in the virtual channel list 1510.

If the channel of ‘3’ is selected in the virtual channel list 1510, the display apparatus 1500 executes a first application 1530 to which the channel of ‘3’ is assigned. Here, the first application 1530 is divided into two sub applications, i.e., an LWA 1531 and a full app. 1532.

The full app. 1532 includes all functions provided by the first application 1530, and is not limited when it is used. That is, the full app. 1532 is provided to execute all the functions/operations of the first application 1530 desired by a user, and thus substantially means the first application 1530 itself.

On the contrary to the full app. 1532, the LWA 1531 includes only limited some functions among the functions of the first application 1530. Therefore, the LWA 1531 consumes fewer resources of the system than the full app. 1532 and less burdened when it is executed. The LWA 1531 is an application first executed when a channel is selected in the virtual channel list 1510.

The LWA 1531 may have some attributes as follows. However, these are nothing but examples, and there are no limits to the attributes of the LWA 1531.

The LWA 1531 may be hidden not to be exposed to a user in an application panel and an App. store. The full app. 1532 is not hidden, and the LWA 1531 is hidden in only the virtual channel service.

The LWA 1531 itself cannot be discretionally deleted by a user, and does not need a user's separate action to be installed in the display apparatus 1500. For example, if a user installs the first application 1530 in the display apparatus 1500, the LWA 1531 together with the full app. 1532 is automatically installed without a user's instruction. Likewise, if a user deletes the first application 1530 from the display apparatus 1500, both the full app. 1532 and the LWA 1531 are deleted.

Further, the LWA 1531 may be executed regardless of whether the full app. 1532 is installed or not. In this case, if a user makes an instruction for switching over to the full app. 1532 while the LWA 1531 is being executed, the display apparatus 1500 provides the full app. 1532 to be downloaded and installed.

The reason why not the full app. 1532 but the LWA 1531 is first executed when the channel is selected is as follows. A user uses the direction button, the numeral button or like of the remote controller to search the virtual channel list 1510 for the virtual channel. In this case, the content of each channel has to be quickly executed and displayed so that a user can select a desired channel through successive channel switching.

By the way, if the full app. 1532 is executed to select a channel in such a channel searching process, the system is burdened with executing and switching the full app. 1532 and execution time is delayed while the channels are successively searched. This causes the channel search environment to be uncomfortable to a user. On the other hand, if the LWA 1531 is executed in the channel searching process, the system is less burdened with executing the application and the time of executing the application becomes shortened, thereby providing a comfortable channel search environment to a user.

According to this exemplary embodiment, when the first application 1530 is selected in the virtual channel list 1510 or executed by the other methods, the LWA 1531 is first executed.

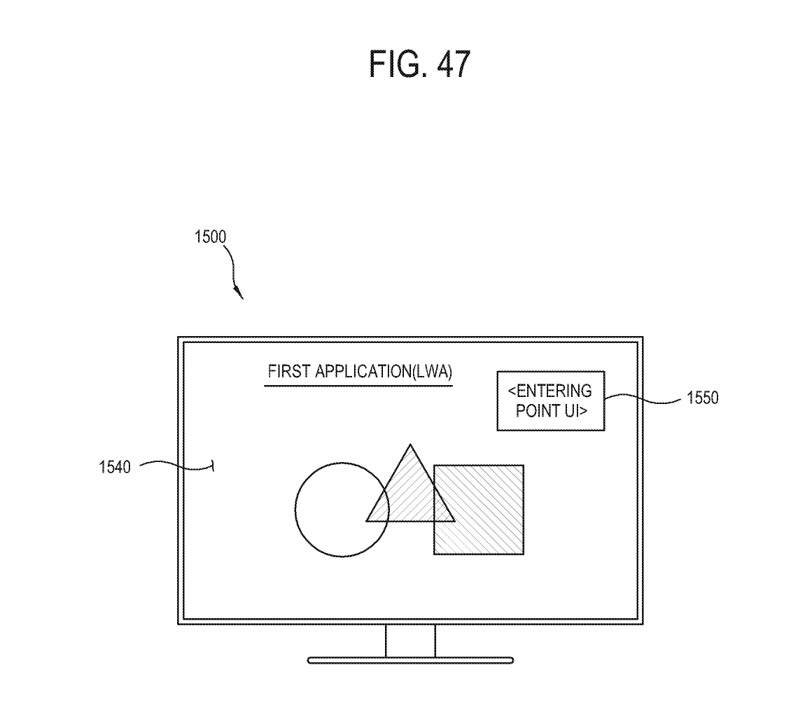

FIG. 47 illustrates that the display apparatus 1500 according to the twentieth exemplary embodiment displays an image 1540 of a lightweight application (LWA).

As shown in FIG. 47, if a user executes a first application, the display apparatus 1500 executes an LWA between the full app. and the LWA of the first application and displays the LWA image 1540. At this time, the display apparatus 1500 displays an entering point UI 1550 for executing the full app. on the LWA images 1540.

If a user inputs an instruction for searching a different channel instead of the first application, the display apparatus 1500 displays an image corresponding to the different channel. In this process, because the LWA having the limited functions is executed instead of the full app. of the first application, the system of the display apparatus 1500 is less burdened and the time to be taken in executing the first application is more shorted than those of the full app.

If a user wants to directly execute the first application, s/he clicks the entering point UI 1550 displayed on the LWA images 1540. Then, the display apparatus 1500 terminates the LWA, and executes the full app. of the first application designated corresponding to the entering point UI 1550. However, if the display apparatus 1500 supports multitasking, the display apparatus 1500 may execute the full app. without terminating the LWA.

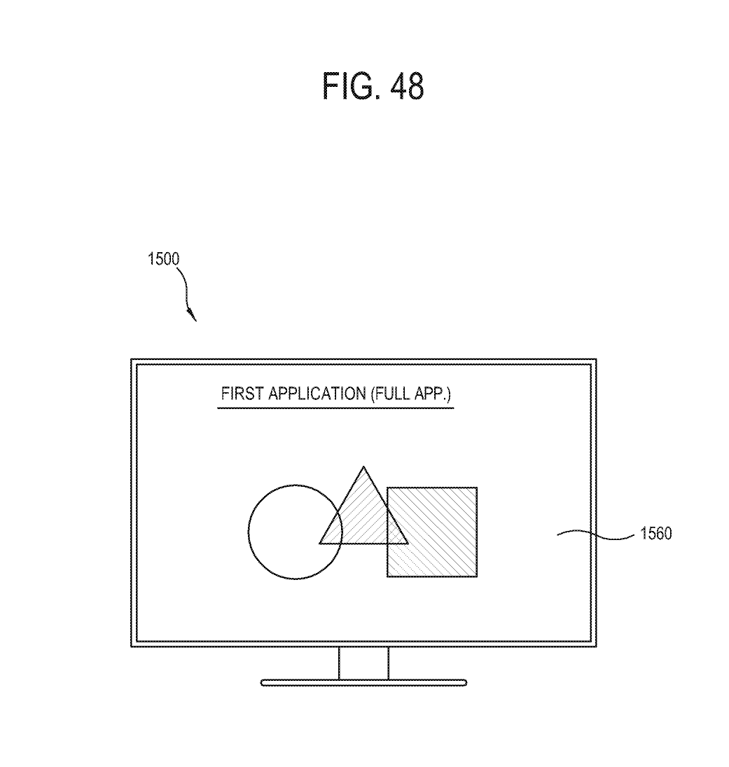

FIG. 48 illustrates that the display apparatus 1500 according to the twentieth exemplary embodiment displays an image 1560 of the full app.

As shown in FIG. 48, the display apparatus 1500 executes the full app. of the first application and displays the full app. image 1560 in response to execution of the entering point UI 1550 (see FIG. 47). Like this, the display apparatus 1500 first executes not the full app. but the LWA when the first application is executed, thereby reducing the burden on the channel search. Further, the display apparatus 1500 provides an UI for switching over to the full app. when the LWA is executed, so that a user can easily make an instruction for executing the full app. of the first application.

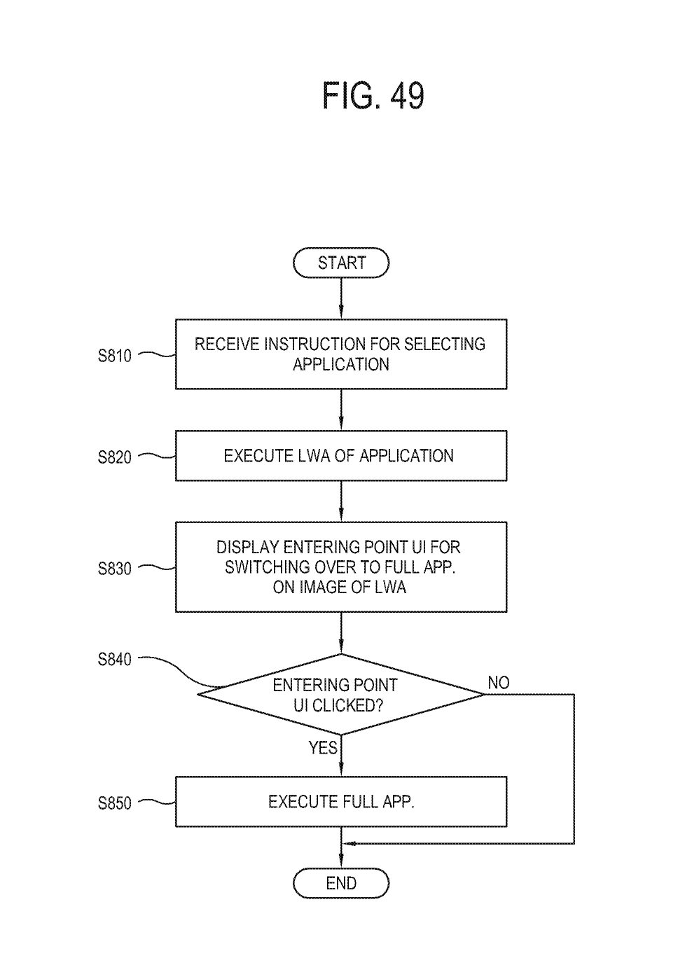

FIG. 49 is a flowchart of executing an application in the display apparatus according to the twentieth exemplary embodiment.

As shown in FIG. 49, at operation S810 the display apparatus receives an instruction for selecting an application in the virtual channel list.

At operation S820 the display apparatus executes an LWA of the selected application.

At operation S830 the display apparatus displays the entering point UI for switching over to a full app. of the application on an LWA image.

At operation S840 the display apparatus determines whether the entering point UI is clicked.

If it is determined that the entering point UI is clicked, at operation S850 the display apparatus switches over from the LWA to the full app.

In the foregoing exemplary embodiment, the virtual channel list and the broadcast channel list are individually provided, and the display apparatus operates in a mode of selecting and using one among the two lists. In this case, there is no problem in selecting a channel because only one list is used even though a channel number is overlapped between the virtual channel list and the broadcast channel list.

However, if both the virtual channel list and the broadcast channel list are used together, there is a problem that a channel number is overlapped between the two lists. Below, an exemplary embodiment for solving this problem will be described.

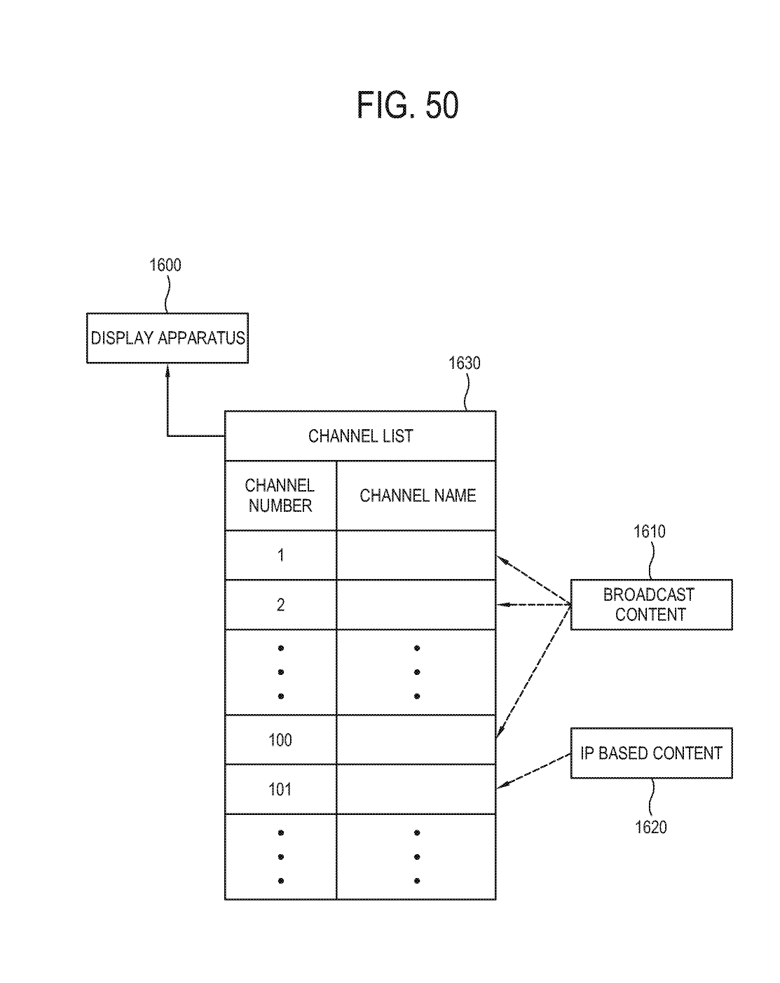

FIG. 50 illustrates a structure of a channel list 1630 used in a display apparatus 1600 according to a twenty first exemplary embodiment.

As shown in FIG. 50, the display apparatus 1600 according to the twenty first exemplary embodiment uses the channel list 1630 containing valid IP based content 1620 and broadcasting content 1610. The channel list 1630 may be generated by the display apparatus 1600, or generated by a separated server and provided to the display apparatus 1600.

The channel list 1630 includes both the IP based content 1620 and the broadcasting content 1610, in which channel numbers are assigned to content 1610 and 1620 without overlapped channel numbers. In the channel list 1630, channel numbers are first assigned to the broadcasting content 1610, and then channel numbers, which follow the last channel number among the channel numbers assigned to the broadcasting content 1610, are assigned to the IP based content 1620.

For example, if the broadcasting content 1610 is assigned with the channel numbers from ‘1’ to ‘100’, the IP based content 1620 is assigned with the channel numbers after the last channel number of ‘100’ assigned to the broadcasting content 1610. In this exemplary embodiment, the IP based content 1620 is assigned with channel numbers starting from ‘101’ following the channel number of ‘100,’ but not limited thereto. Alternatively, the IP based content 1620 may be assigned with more posterior channel numbers. In other words, a plurality of preliminary channel numbers between the last channel number of the broadcasting content 1610 and the first channel number of the IP based content 1620 may be reserved for increase in the number of channels with regard to the broadcasting content 1610.

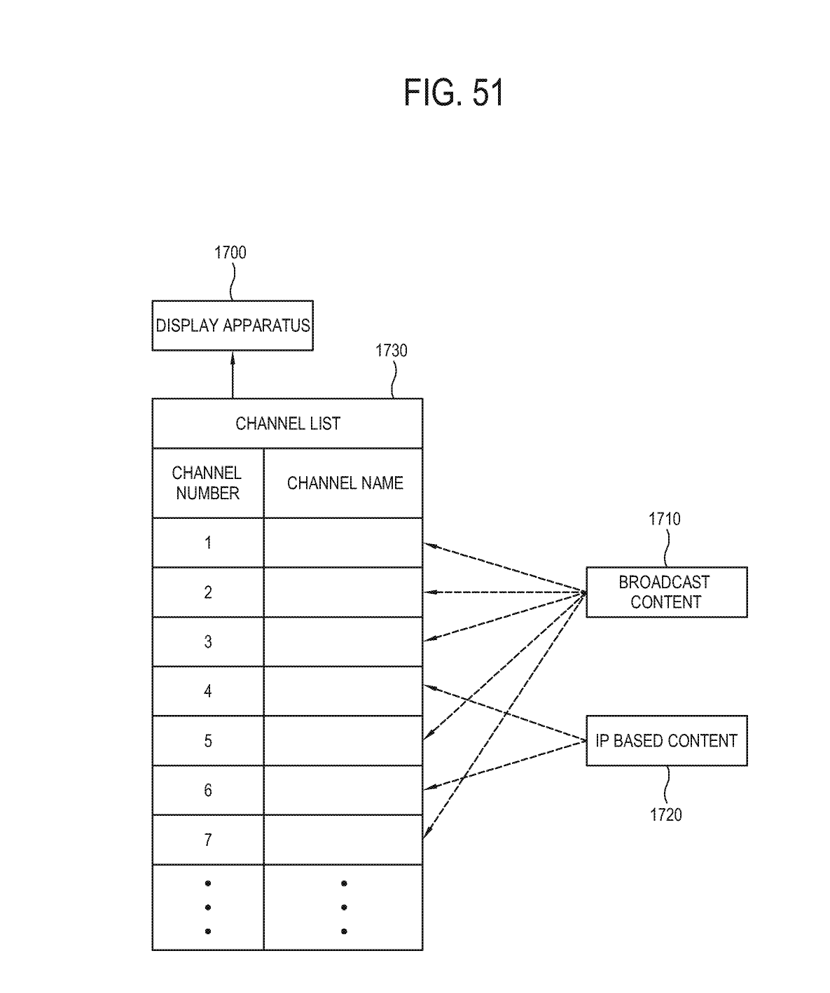

FIG. 51 illustrates a structure of a channel list 1730 used in a display apparatus 1700 according to a twenty second exemplary embodiment.

As shown in FIG. 51, the display apparatus 1700 according to the twenty second exemplary embodiment uses a channel list 1730 containing valid IP based content 1720 and broadcasting content 1710. This channel list 1730 is different from the channel list 1630 (see FIG. 50) in assigning channel numbers.

The channel list 1730 includes both the IP based content 1720 and the broadcasting content 1710, in which channel numbers are assigned to content 1710 and 1720 without overlapped channel numbers. In the channel list 1730, channel numbers are first assigned to the broadcasting content 1710, and then channel numbers, which are not assigned to the broadcasting content 1710, are sequentially assigned to the IP based content 1620.

For example, if the broadcasting content 1710 is assigned with channel numbers of ‘1’, ‘2’, ‘3’, ‘5’ and ‘7’, channel numbers of ‘4’ and ‘6’ are unoccupied. Thus, the IP based content 1720 may be assigned with the channel numbers of ‘4’ and ‘6’. After the channel numbers are assigned in this way, the IP based content 1720 is arranged in between pieces of the broadcasting content 1710 on the channel list 1730.

As mentioned above, it is possible to include the broadcasting content and the IP based content in one channel list without overlapped channel numbers.

Below, some examples of utilizing the entering point UI will be described.

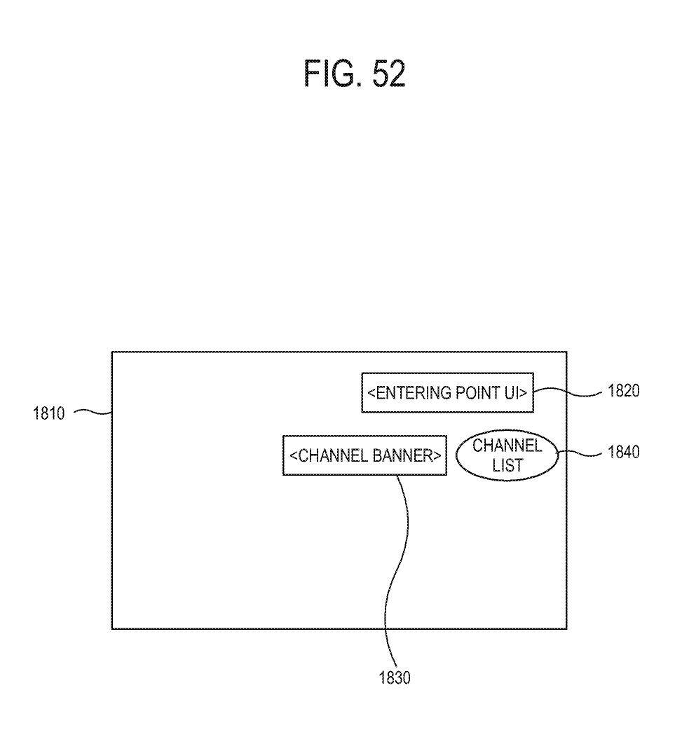

FIG. 52 illustrates that a display apparatus according to a twenty third exemplary embodiment displays an entering point UI 1820 on a screen 1810.

As shown in FIG. 52, the display apparatus according to the twenty third exemplary embodiment may display the entering point UI 1820, a channel banner 1830, and a channel list object 1840 on the screen 1810. The sample principles as those of the foregoing exemplary embodiments are applied to the entering point UI 1820 and the channel banner 1830.

The channel list object 1840 is set to display a channel list on the screen 1810. Here, the channel list may be the foregoing broadcast channel list, the foregoing virtual channel list, or a combination list thereof.

When a user clicks the channel list object 1840, the display apparatus processes a previously stored channel list on the screen 1810.

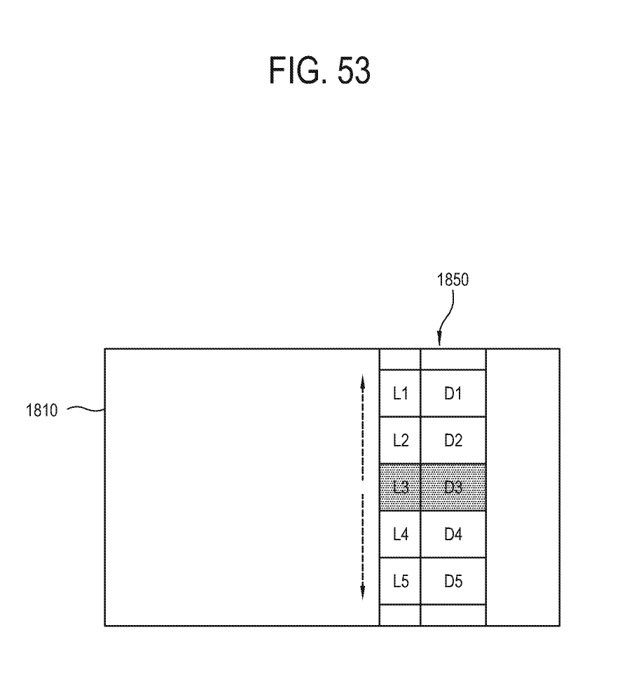

FIG. 53 illustrates that the display apparatus according to the twenty third exemplary embodiment displays a channel list 1850 on the screen 1810 thereof. FIG. 53 follows FIG. 52.

As shown in FIG. 53, the display apparatus displays the channel list 1850 on the screen 1810 when the channel list object 1840 (see FIG. 52) is clicked. In the channel list 1850, channels are listed in a vertical direction, and thus a channel arranged at the center of the screen 1810 is changed in response to a user's instruction for moving up and down. When a user presses the enter-button, the channel arranged at the center of the screen 1810 in the channel list 1850 is clicked, and an image of the clicked channel is displayed on the screen 1810. The respective channel include logo areas L1, L2, L3, L4 and L5 where corresponding logos thereof are displayed, and description areas D1, D2, D3, D4 and D5 where titles and brief descriptions of the corresponding channels are displayed.

The logos of the channels are displayed on the logo areas L1, L2, L3, L4 and L5, and the channel numbers, titles, descriptions, subtitles, etc. are displayed on the description areas D1, D2, D3, D4 and D5. If a channel has no logo, its logo area L1, L2, L3, L4, L5 may display the channel number or a default thumbnail image.

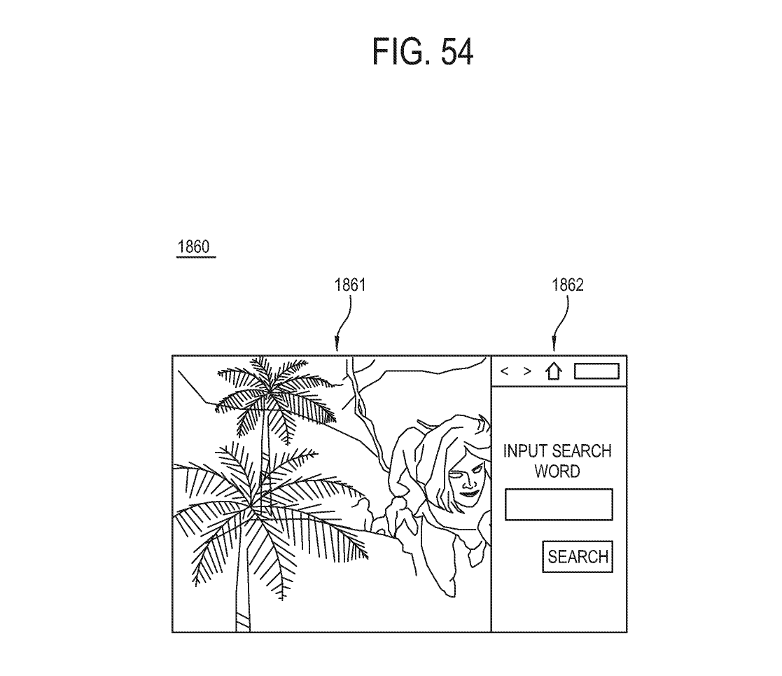

FIG. 54 illustrates that a display apparatus according to a twenty fourth exemplary embodiment displays an image on a screen 1860 thereof by a multi-link screen (MLS) mode;

As shown in FIG. 54, the display apparatus according to the twenty fourth exemplary embodiment may display an image on the screen 1860 thereof by a multi-link screen (MLS) mode. For example, the display apparatus may divide the screen 1860 into two left and right divisional screens, and display a first image 1861 on the left divisional screen and a second image 1862 on the right divisional screen. For example, the first image 1861 may be a broadcast image, and the second image 1862 may be a web page.

With this state, suppose that a user makes an instruction for changing the image input source, i.e., switching over from the first image 1861 displayed on the left divisional screen to a channel of a virtual channel service. If the channel of the virtual channel service supports the MLS function, the display apparatus may display an image of the corresponding channel instead of the first image 1861 on the left divisional screen.

However, the channel of the virtual channel service may not support the MLS function.

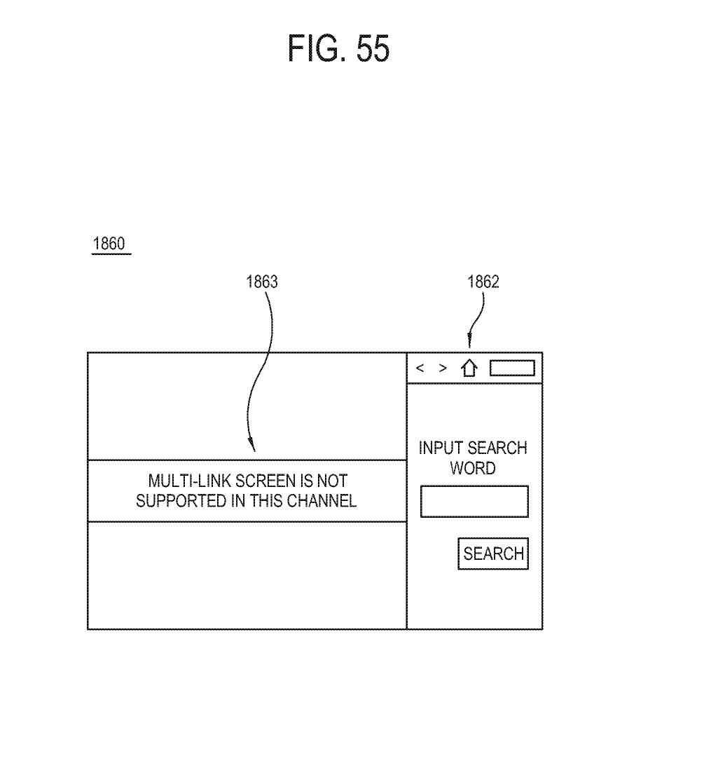

FIG. 55 illustrates an example of a banner 1863 displayed when the display apparatus according to the twenty fourth exemplary embodiment switches over to a channel in which the MLS mode is not supported. FIG. 55 follows FIG. 54.

As shown in FIG. 55, if the channel selected by a user to be displayed on the left divisional screen of the screen 1860 does not support the MLS function, the display apparatus displays a banner 1863 informing that the selected channel does not support the MLS function on the left divisional screen. At this time, the display apparatus keeps displaying the second image 1862 on the right divisional screen.

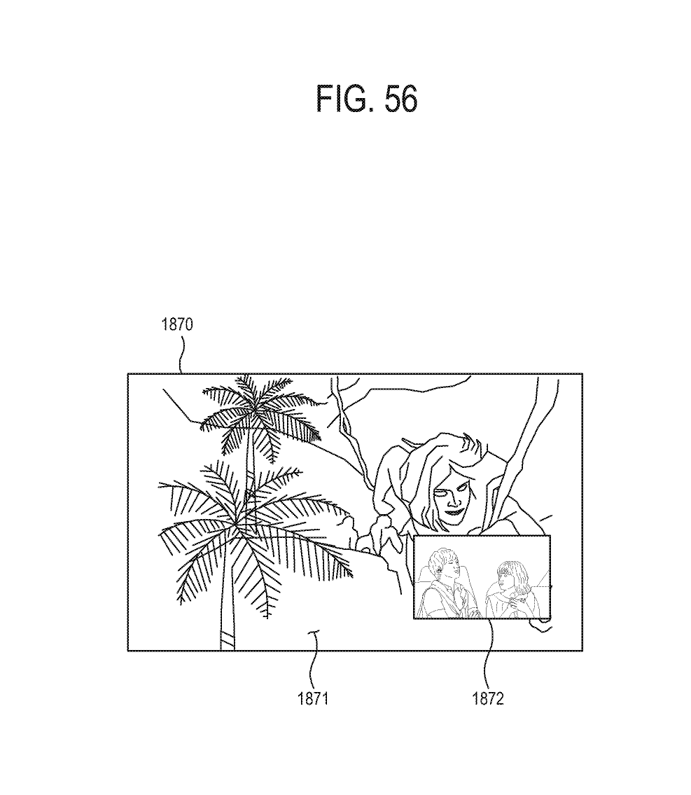

FIG. 56 illustrates that a display apparatus according to a twenty fifth exemplary embodiment displays an image on a screen 1870 thereof by a picture-in-picture (PIP) mode.

As shown in FIG. 56, the display apparatus according to the twenty fifth exemplary embodiment displays a first image 1871 as a main image fully on the screen 1870 and a second image 1872 as a smaller sub image within the first image 1871 when it operates in the PIP mode.

With this state, suppose that a user makes an instruction for changing the image input source on the sub image, i.e., switching over to a channel of a virtual channel service. If the channel of the virtual channel service supports the PIP function, the display apparatus may display an image of the corresponding channel as the sub image instead of the second image 1872.

However, the channel of the virtual channel service may not support the PIP function.

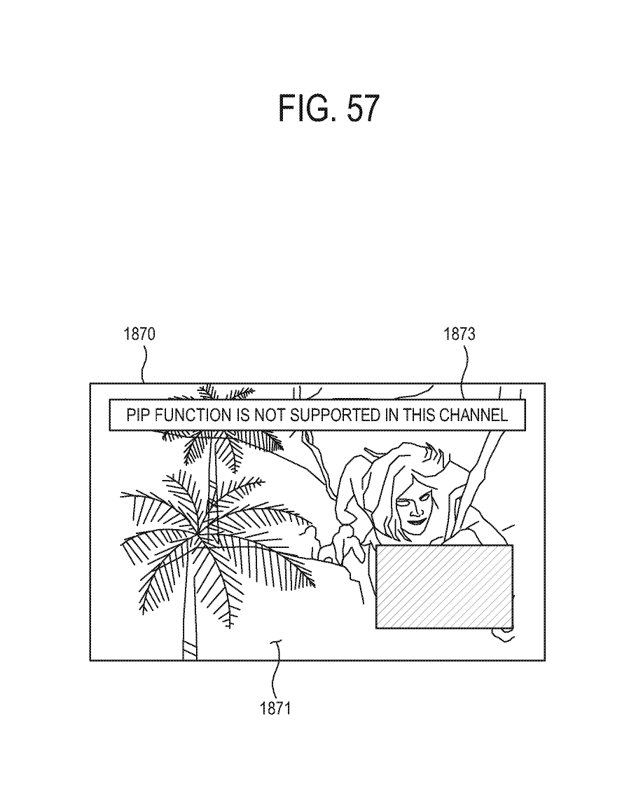

FIG. 57 illustrates an example of a banner 1873 displayed when the display apparatus according to the twenty fifth exemplary embodiment switches over to a channel in which the PIP mode is not supported. FIG. 57 follows FIG. 56.

As shown in FIG. 57, if the channel selected by a user to be displayed as the sub image in the PIP mode does not support the PIP function, the display apparatus displays a banner 1873 informing that the selected channel does not support the PIP function on the main image. At this time, the display apparatus keeps displaying the first image 1871 as the main image, and does not display any image as the sub image.

In connection with the foregoing exemplary embodiments of displaying the entering point UI on the display apparatus, the display apparatus may receive no content data from the currently selected image input source. Below, an exemplary embodiment in this case will be described.

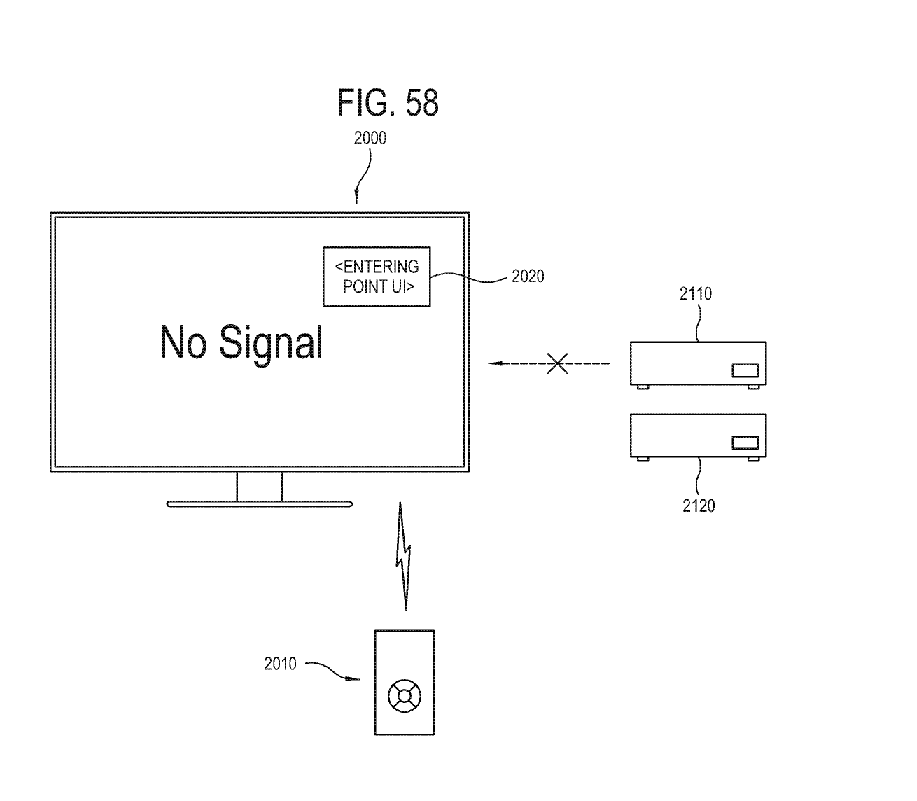

FIG. 58 illustrates a state that a display apparatus 2000 according to a twenty sixth exemplary embodiment receives no signals from a first image input source 2110.

As shown in FIG. 58, the display apparatus 2000 according to the twenty sixth exemplary embodiment may receive a video signal from one among a plurality of image input sources 2110 and 2120. For example, the display apparatus 2000 receives a video signal from the first image input source 2110 if it is set to receive the video signal from the first image input source 2110.

By the way, the first image input source 2110 may be turned off or the display apparatus 2000 may be disconnected from the first image input source 2110 in the state that the display apparatus 2000 is set to receive a video signal from the first image input source 2110. In this case, the display apparatus 2000 does not receive any signal from the first image input source 2110 even though it is set to receive a video signal from the first image input source 2110.

In this state, the display apparatus 2000 may receive an instruction for changing channels from a remote controller 2010. In response to the instruction for the channel change from the remote controller 2010, the display apparatus 2000 displays an entering point UI 2020 for switching over from the currently connected first image input source 2110 to another input source such as a second image input source 2120.

If a user selects the entering point UI 2020, the display apparatus 2000 switches over to the second image input source 2120 directed by the entering point UI 2020.

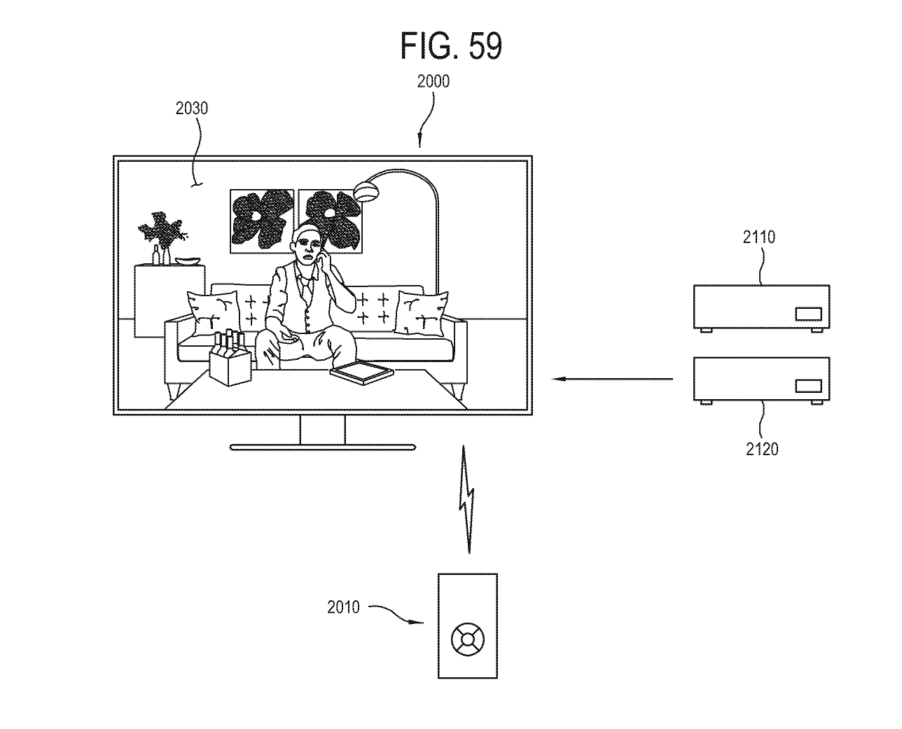

FIG. 59 illustrates that the display apparatus 2000 according to the twenty sixth exemplary embodiment switches over to the second image input source 2120.

As shown in FIG. 59, the display apparatus 2000 is changed in setting for receiving a video signal and thus switches over from the first image input source 2110 to the second image input source 2120 in response to the selection of the entering point UI 2020 (see FIG. 58).

In result, the display apparatus 2000 receives content data from the second image input source 2120 and processes the received content data, thereby displaying a content image 2030.

Through the entering point UI 2020, it is possible to switch over to the second image input source 2120 activated to provide a video signal when the first image input source 2110 is inactivated to provide no video signal.

In the foregoing exemplary embodiments, the display apparatus has the MBR function for transmitting the code set to the universal remote controller. In the state that the MBR function is activated, there are various methods of transmitting the code set to the remote controller in the state that the MBR function is activated. Among them, one method will be described below.

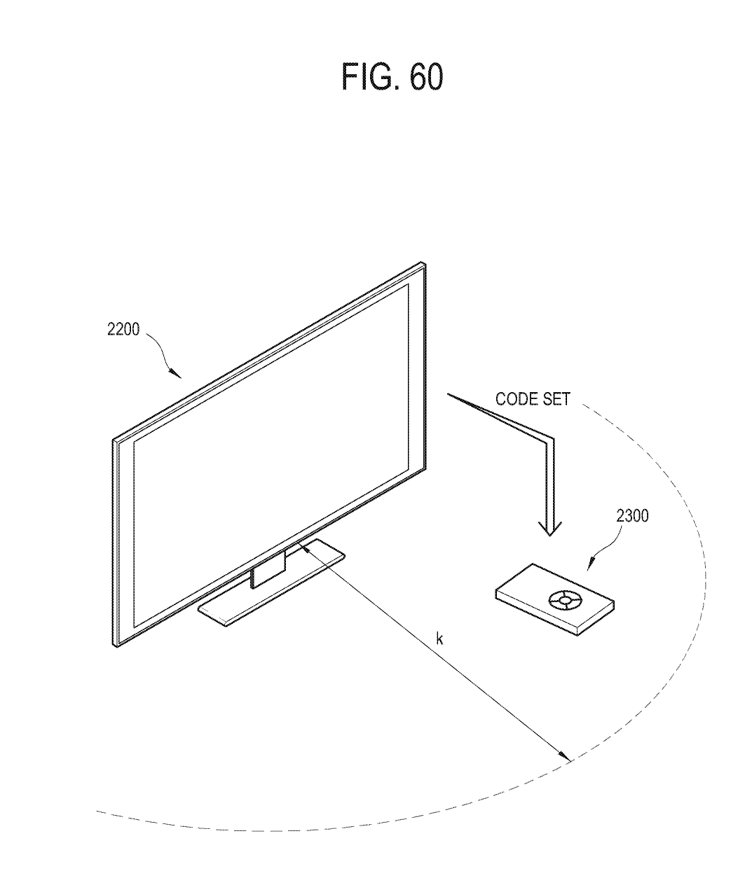

FIG. 60 illustrates that a display apparatus 2200 according to a twenty seventh exemplary embodiment transmits a code set to a remote controller 2300.

As shown in FIG. 60, the display apparatus 2200 according to the twenty seventh exemplary embodiment transmits electromagnetic waves in all directions or a direction, and monitors whether a communicable device is detected within a preset distance range of k. The display apparatus 2200 may include a sensor for transmitting the electromagnetic waves and performing such a monitoring operation. Here, there are no limits to the kind of electromagnetic waves or the transmitting method, and various wireless communication standards are applicable.

For example, if it is sensed that the remote controller 2300 comes within the distance range of k, the display apparatus 2200 automatically performs pairing for wireless communication with the remote controller 2300. If the display apparatus 2200 and the remote controller 2300 are paired to enable wireless communication for data, the display apparatus 2200 transmits a code set for controlling an apparatus to the remote controller 2300.

Thus, the remote controller 2300 easily receives the code set from the display apparatus 2200. However, this embodiment is applicable to not only the remote controller 2300 but also various input devices such as a mobile phone or the like capable of communicating with the display apparatus 2200.

In addition, the exemplary embodiments may also be implemented through computer-readable code and/or instructions on a medium, e.g., a computer-readable medium, to control at least one processing element to implement any above-described embodiments. The medium may correspond to any medium or media that may serve as a storage and/or perform transmission of the computer-readable code.

The computer-readable code may be recorded and/or transferred on a medium in a variety of ways, and examples of the medium include recording media, such as magnetic storage media (e.g., ROM, floppy disks, hard disks, etc.) and optical recording media (e.g., compact disc read only memories (CD-ROMs) or digital versatile discs (DVDs)), and transmission media such as Internet transmission media. Thus, the medium may have a structure suitable for storing or carrying a signal or information, such as a device carrying a bitstream according to one or more exemplary embodiments. The medium may also be on a distributed network, so that the computer-readable code is stored and/or transferred on the medium and executed in a distributed fashion. Furthermore, the processing element may include a processor or a computer processor, and the processing element may be distributed and/or included in a single device.

The foregoing exemplary embodiments are examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A display apparatus comprising:
a communicator configured to receive a video signal;
a display configured to display a first image based on the received video signal;
an input interface configured to receive a first instruction for switching content; and
a processor configured to control the display to display a second image based on the received first instruction, and display, on the second image, a first user interface (UI) for switching content, in response to the input interface receiving the first instruction while the display displays the first image.

2. The display apparatus according to claim 1, wherein the input interface is further configured to receive a second instruction for selecting the first UI, and
the processor is further configured to control the display to display a third image in response to the input interface receiving the second instruction while the display displays the first UI.

3. The display apparatus according to claim 2, wherein the processor is further configured to control the display to display, on the third image, a second UI for returning to the second image,
the input interface is further configured to receive a third instruction for selecting the second UI, and
the processor is further configured to control the display to display the first image in response to the input interface receiving the third instruction while the display displays the second UI.

4. The display apparatus according to claim 2, wherein the processor is further configured to:
determine content of the third image, based on a content view history of a user; and
display, on the second image, the first UI for switching to the determined content, in response to the input interface receiving the first instruction while the display displays the first image.

5. The display apparatus according to claim 4, wherein the processor is further configured to determine, as the content of the third image, content that is highest ranked in order of a view frequency of the user for a preset period of time, among contents.

6. The display apparatus according to claim 4, wherein the processor is further configured to determine, as the content of the third image, content that is displayed at a time closest to a time when the second image is displayed, among contents.

7. The display apparatus according to claim 1, wherein the first UI is for switching an input source for providing content to the display apparatus.

8. The display apparatus according to claim 1, wherein the input interface comprises a remote controller configured to control an input source for providing content to the display apparatus, based on a code set corresponding to the input source, and
the processor is further configured to:
selectively activate a function for transmitting the code set that is stored in the display apparatus; and
control the communicator to transmit the stored code set to the remote controller in response to the input interface receiving the first instruction from the remote controller while the processor activates the function.

9. The display apparatus according to claim 8, wherein the processor is further configured to control the display to display the second image based on the received first instruction, and display, on the second image, the first UI, in response to the input interface receiving the first instruction from the remote controller while the function is inactivated.

10. The display apparatus according to claim 1, wherein the input interface comprises a mobile input device configured to control an input source for providing content to the display apparatus, based on a code set corresponding to the input source, and
the processor is further configured to pair with the mobile input device to transmit data to the mobile input device, and control the communicator to transmit the code set to the mobile input device, in response to the mobile input device being within a preset range for wireless communication with the communicator.

11. A method of controlling a display apparatus, the method comprising:
receiving a video signal;
displaying a first image based on the received video signal;
receiving a first instruction for switching content; and
displaying a second image based on the received first instruction, and displaying, on the second image, a first user interface (UI) for switching content, in response to the receiving of the first instruction during the displaying of the first image.

12. The method according to claim 11, further comprising:
receiving a second instruction for selecting the first UI; and
displaying a third image in response to the receiving of the second instruction during the displaying of the first UI.

13. The method according to claim 12, further comprising:
displaying, on the third image, a second UI for returning to the second image;
receiving a third instruction for selecting the second UI; and
displaying the first image in response to the receiving of the third instruction during the displaying of the second UI.

14. The method according to claim 12, further comprising determining content of the third image, based on a content view history of a user,
wherein the displaying the first UI comprises displaying, on the second image, the first UI for switching to the determined content, in response to the receiving of the first instruction during the displaying of the first image.

15. The method according to claim 14, wherein the determining comprises determining, as the content of the third image, content that is highest ranked in order of a view frequency of the user for a preset period of time, among contents.

16. The method according to claim 14, wherein the determining comprises determining, as the content of the third image, content that is displayed at a time closest to a time when the second image is displayed, among contents.

17. The method according to claim 11, wherein the first UI is for switching an input source for providing content to the display apparatus.

18. The method according to claim 11, further comprising:
communicating with a remote controller configured to control an input source for providing content to the display apparatus, based on a code set corresponding to the input source;
selectively activating a function for transmitting the code set that is stored in the display apparatus; and
transmitting the stored code set to the remote controller in response to the receiving of the first instruction from the remote controller during the activating of the function.

19. The method according to claim 18, further comprising displaying the second image based on the received first instruction, and displaying, on the second image, the first UI, in response to the receiving of the first instruction from the remote controller while the function is inactivated.

20. The method according to claim 11, further comprising:
communicating with a mobile input device configured to control an input source for providing content to the display apparatus, based on a code set corresponding to the input source; and
pairing with the mobile input device to transmit data to the mobile input device, and transmitting the code set to the mobile input device, in response to the mobile input device being within a preset range for wireless communication with the communicator.
